(19) United States
(12) Patent Application Publication
(10) Pub. No.: US 2022/0002469 A1
(43) Pub. Date: Jan. 6, 2022

(54) POLYOL COMPOSITIONS AND METHODS

(71) Applicant: Saudi Aramco Technologies Company, Dhahran (SA)

(72) Inventors: Chin-Chang Shen, Missouri City, TX (US); Scott D. Allen, Fairport, NY (US); Peter Metelski, Penfield, NY (US)

(21) Appl. No.: 17/355,307

(22) Filed: Jun. 23, 2021

Related U.S. Application Data
(60) Provisional application No. 63/043,566, filed on Jun. 24, 2020.

(51) Int. Cl. C08G 18/75; C08G 18/48; C08G 18/34; C08G 18/12; C08G 18/44; C08G 18/40; C08G 18/42; C08G 18/66; C09D 175/08; C09J 175/08

(52) U.S. Cl. CPC C08G 18/755; C08G 18/4854; C08G 18/348; C08G 18/12; C09J 175/08; C08G 18/4018; C08G 18/4238; C08G 18/6692; C09D 175/08; C08G 18/44

(57) ABSTRACT

In one aspect, the present invention encompasses blends of polyols comprising a polycarbonate polyol and an additional polyol selected from a polyether or polyester polyol, resulting polyurethanes derived from such blends of polyols, methods of making such polyurethane compositions, and coatings and adhesives derived from such polyurethane compositions.

### CROSS-REFERENCE TO RELATED APPLICATIONS

This application claims priority to U.S. Provisional Patent Application No. 63/043,566, filed Jun. 24, 2020, the entire of which is hereby incorporated by reference.

### FIELD OF INVENTION

This invention pertains to the field of polyurethane compositions. More particularly, the invention pertains to polyurethane compositions that incorporate a polycarbonate polyol and an additional polyol selected from a polyether or polyester polyol.

### BACKGROUND

Polyurethane compositions, which are derived from the reaction between isocyanates and reactive polymers, are widely used, e.g., in adhesive and coating applications. There remains a need for polyurethane compositions with improved performance characteristics, e.g., strength, flexibility, elongation, etc. However, solutions to improve one such characteristic, e.g., increase strength of a polyurethane composition, usually result in a proportional decrease in flexibility or elongation, and vice versa. Thus, there remains a need for polyurethane compositions with one or more improved performance characteristics that do not sacrifice other performance characteristics.

### SUMMARY OF INVENTION

In some aspects, the present invention provides compositions comprising i) a polycarbonate or polyether carbonate polyol derived from copolymerization of carbon dioxide and one or more epoxides, and ii) an additional polyol selected from a polyether or polyester polyol. In some embodiments, such compositions are useful, e.g., when incorporated into polyurethane compositions.

As noted above, polyurethane compositions have been described. Many different combinations of polyols and isocyanates have been used in polyurethane compositions. For example, in certain applications, polyether polyols, such as poly(propylene glycol) (PPG) and poly(tetramethylene glycol) (PTMEG), and polyester polyols, such as butane diol/adipic acid copolymer (BD-AA) and copolymers of adipic acid and diethylene glycol, ethylene glycol, hexane diol, propylene glycol, and neopentyl glycol, have been disclosed as preferred polyols in polyurethane compositions. Nonetheless, in certain aspects, there is a need to provide polyurethane compositions with improved performance characteristics, in particular for adhesive, elastomer, and coating applications.

The present invention encompasses the recognition that incorporating a polycarbonate polyol into the polyol component of a polyurethane composition can improve the performance properties (e.g., mechanical properties or shelf-life) of the polyurethane composition. Accordingly, in some aspects, the present invention encompasses polyurethane compositions comprising the reaction product of a polyol component and a polyisocyanate composition. In particular, the polyol component comprises i) a polycarbonate or polyether carbonate polyol derived from copolymerization of carbon dioxide and one or more epoxides, and ii) an additional polyol selected from a polyether or polyester polyol.

Polycarbonate polyols derived from copolymerization of carbon dioxide and one or more epoxides include polyether carbonate polyols and substantially alternating polycarbonate polyols. Such polyols, as a result of being derived from copolymerization of carbon dioxide and one or more epoxides, comprise a repeating unit having a structure:

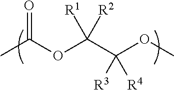

wherein R¹, R², R³, and R⁴ are as described herein.

As shown by the above structure, polycarbonate polyols derived from copolymerization of carbon dioxide and one or more epoxides comprise repeating carbonate units separated by two carbons.

Polyurethane compositions that incorporate a polycarbonate polyol and a polyether or polyester polyol have been previously described, for example, in J. Mater. Civ. Eng., 2017, 29(10): 06017009 and U.S. Pat. Nos. 6,642,303 and 9,669,610. However, these previously disclosed polyurethane compounds (for example as disclosed in Mater. Civ. Eng., 2017, 29(10): 06017009) and PUD compositions derived from both a polycarbonate polyol and a polyether or polyester polyol (for example, as disclosed in U.S. Pat. Nos. 6,642,303 and 9,669,610) are directed towards polycarbonate polymers of materially different structure. In particular, these polycarbonate polyols are obtained from the reaction of diols with phosgene or a carbonic acid ester compound, for example, diphenyl carbonate or dimethyl carbonate (hereafter, such reactions are collectively referred to as “phosgene-diol condensation copolymerization”). However, polycarbonates derived from phosgene-diol condensation copolymerization reactions typically utilize longer chain diols, such as 1,6-hexanediol. For example, both U.S. Pat. Nos. 6,642,303 and 9,669,610 exemplify polycarbonates derived from 1,6-hexanediol and phosgene or a carbonic acid ester, which results in a polycarbonate comprising repeating carbonate units separated by six carbons:

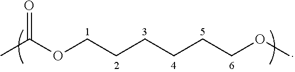

In order to arrive at polycarbonates with repeating carbonate units separated by two carbons (characteristic of epoxide-CO₂ copolymerization chemistry) via phosgene-diol condensation copolymerization, a two-carbon diol (such as ethylene glycol or 1,2-propylene glycol) would have to be reacted with phosgene or a carbonic acid ester. Such two-carbon diols are often listed as prophetic diols, within a long list of other diols, for use with phosgene or a carbonic acid ester to arrive at such polycarbonates (see, for example, U.S. Pat. Nos. 6,642,303 and 9,669,610).

However, in phosgene-diol condensation copolymerization chemistry, two-carbon diols (such as ethylene glycol or 1,2-propylene glycol) suffer from challenges and limitations that do not affect longer chain diols, such as 1,6-hexanediol. As disclosed in, for example, U.S. Pat. No. 3,334,128, two-carbon diols, when combined with phosgene, produce a significant amount of cyclic carbonate compounds. Consequently, phosgene-diol condensation copolymerization reactions using two carbon diols will be significantly hindered due to the alternative production of cyclic carbonate compounds.

Because of these limitations, there is doubt as to whether two carbon diols could be used in phosgene-diol condensation copolymerization reactions to arrive at polymer chains with repeating units separated by two carbons and also demonstrate desirable properties. Even though references, such as U.S. Pat. Nos. 6,642,303 and 9,669,610, contemplate prophetic polycarbonates derived from two-carbon diols, these references do not exemplify them, and there is significant doubt whether they could be achieved in practice.

In addition, phosgene-diol condensation copolymerization reactions, by nature of being repeating condensation reactions, produce a significant amount of by-products not present when utilizing epoxide-CO₂ copolymerization.

Furthermore, polyurethane compositions that comprise a polycarbonate polyol derived from copolymerization of carbon dioxide and one or more epoxides, and thus comprising repeating carbonate units separated by two carbons, have been described in, for example, PCT Publication Nos. WO 2010/028362, WO 2013/016331, and WO 2014/074706.

While PCT Publication No. WO 2010/028362 discloses polycarbonate polyols derived from copolymerization of carbon dioxide and one or more epoxides and their incorporation into polyurethane compositions, it is silent with respect to particular blends of polycarbonate polyols with one or more additional polyols such as polyether or polyester polyols.

PCT Publication No. WO 2013/016331 discloses B-side mixtures for the formulation of polyurethane compositions that incorporate a polycarbonate polyol and one or more additional polyols (e.g., a polyether or polyester polyol). In addition, PCT Publication No. WO 2014/074706 discloses polyurethane foams derived from a polycarbonate polyol and a polyether or polyester polyol. However, neither of these disclosures recognizes that a particular blend of polyols (a polycarbonate polyol and an additional polyether or polyester polyol) within a polyurethane composition provides a superior performing material in certain applications, e.g., coatings and adhesives.

In some aspects, the present invention provides the recognition that, for a particular polyurethane composition, the combination of i) a polycarbonate or polyether carbonate polyol derived from CO₂ and one or more epoxides; and ii) an additional polyol selected from a polyether or polyester polyol, e.g, wherein the polyether or polyester polyol comprises a repeating tetramethylene unit, provides a polyurethane composition with superior performance properties.

When blending two or more polyols to provide a polyurethane composition, it is expected that the performance properties of the resulting polyurethane composition will be an average of the corresponding polyurethane compositions derived solely from each polyol. However, the present invention recognizes that the polyurethane compositions described herein (derived from a blend of polyols) display an unexpected synergistic improvement in performance properties (e.g., tensile strength, tensile elongation, and modulus), compared to the corresponding polyurethane compositions derived solely from each polyol. Additionally or alternatively, the present invention recognizes that the polyurethane compositions described herein (derived from a blend of polyols as described here) display one or more improved performance properties without sacrificing a proportional decrease in another performance property (e.g., improved tensile strength without proportional decrease in tensile elongation).

In some aspects, the present invention encompasses compositions comprising: polyol subcomponent (i), which comprises one or more polycarbonate or polyether carbonate
polyols derived from copolymerization of carbon dioxide and one or more epoxides; and polyol subcomponent (ii), which comprises one or more polyether or polyester polyols.

In some aspects, the present invention encompasses polyurethane compositions derived from the reaction product of compositions described herein, e.g., comprising polyol subcomponent (i) and polyol subcomponent (ii). The polyurethane compositions of the present invention are particularly useful in adhesive and coating applications. In one aspect, polyurethane compositions of the present invention unexpectedly demonstrate improved performance properties (e.g., strength, flexibility, or both), as compared to a reference polyurethane composition.

In some aspects, the present invention encompasses isocyanate-terminated prepolymers derived from a composition described here, e.g., comprising polyol subcomponent (i) and polyol subcomponent (ii).

In some aspects, the present invention encompasses methods of producing a polyurethane compositions, comprising the steps of:
(a) providing a composition comprising one or more isocyanate reagents;
(b) providing a composition described here, e.g., comprising:
polyol subcomponent (i), which comprises one or more polycarbonate or polyether carbonate polyols derived from copolymerization of carbon dioxide and one or more epoxides; and
polyol subcomponent (ii), which comprises one or more polyether or polyester polyols; and
(c) mixing the (a) and (b) compositions and allowing the mixture to cure into the polyurethane composition.

In some embodiments, the present invention encompasses methods of producing a polyurethane composition comprising the steps of:
(a) providing an isocyanate-terminate prepolymer derived from a composition described here, e.g., comprising polyol subcomponent (i) and polyol subcomponent (ii); and
(b) allowing the mixture to cure into the polyurethane composition.

In some aspects, the present invention encompasses methods of improving a performance property of a polyurethane compositions comprising the reaction product of a polyol component and an isocyanate component, the method comprising the step of incorporating into the polyol component:
polyol subcomponent (i), which comprises one or more polycarbonate or polyether carbonate polyols derived from copolymerization of carbon dioxide and one or more epoxides; and
polyol subcomponent (ii), which comprises one or more additional polyether or polyester polyols.

### BRIEF DESCRIPTION OF THE DRAWINGS

FIG. 1 depicts the INVISTA process for producing poly(tetramethylene glycol).

FIG. 2 depicts a general process for preparing polyurethane compositions (e.g., PUD composition) of the present invention.

FIG. 3 depicts a process for preparing PUD compositions 1-24.

FIG. 4 depicts a process for preparing PUD coatings/films.

FIG. 5 depicts PUD compositions 1-5.

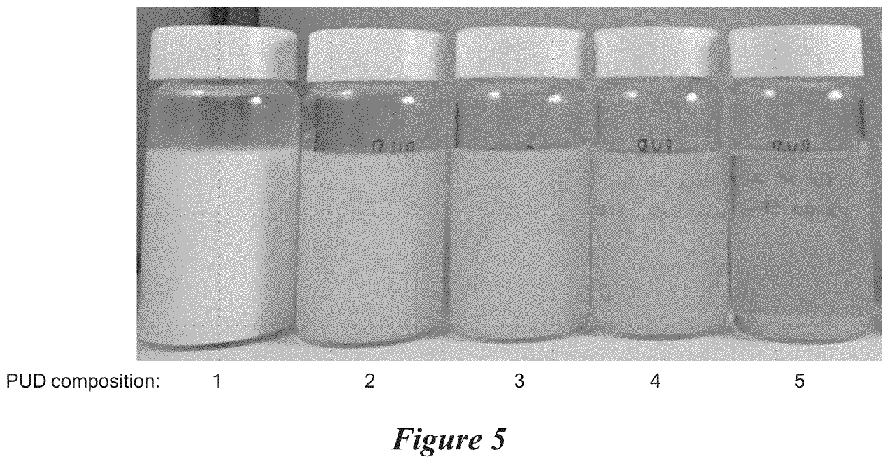

FIG. 6 depicts a representation of the relative weight fractions of each polyol component of PUs 1-14 from Example 8.

FIG. 7 depicts a representation of the relative weight fractions of each polyol component of PUs 1-14 from Example 8, where black open circles represent particularly improved PUs, and “X” representing the largest observed improvements.

FIG. 8 depicts a representation of the relative weight fractions of each polyol component of PUs 15-21 from Example 8, where open circulates represent particularly improved PUs, where black open circles represent particularly improved PUs, and “X” representing the largest observed improvements.

### DEFINITIONS

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain molecules (e.g., polymers, epoxides, etc.) of the present invention can comprise one or more asymmetric centers, and thus can exist in various stereoisomeric forms, e.g., enantiomers and/or diastereomers. Thus, inventive molecules and compositions thereof may be in the form of an individual enantiomer, diastereomer or geometric isomer, or may be in the form of a mixture of stereoisomers. In certain embodiments, the molecules of the invention are enantiopure molecules. In certain embodiments, mixtures of enantiomers or diastereomers are provided.

Certain molecules described herein may have one or more double bonds that can exist as either the Z or E isomer, unless otherwise indicated. The invention additionally encompasses the molecules as individual isomers substantially free of other isomers and alternatively, as mixtures of various isomers, e.g., racemic mixtures of enantiomers. In addition to the above-mentioned molecules per se, this invention also encompasses compositions comprising one or more molecules.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a stereoisomer may, in some embodiments, be provided substantially free of one or more corresponding stereoisomers, and may also be referred to as “stereochemically enriched.”

The term “epoxide”, as used herein, refers to a substituted or unsubstituted oxirane. Such substituted oxiranes include monosubstituted oxiranes, disubstituted oxiranes, trisubstituted oxiranes, and tetrasubstituted oxiranes. Such epoxides may be further optionally substituted as defined herein. In certain embodiments, epoxides comprise a single oxirane moiety. In certain embodiments, epoxides comprise two or more oxirane moieties.

The term “polymer”, as used herein, refers to a molecule of high relative molecular mass, the structure of which comprises the multiple repetitions of units derived, actually or conceptually, from molecules of low relative molecular mass. In certain embodiments, a polymer is comprised of substantially alternating units derived from CO₂ and an epoxide (e.g., poly(ethylene carbonate). In certain embodiments, a polymer of the present invention is a copolymer, terpolymer, heteropolymer, block copolymer, or tapered heteropolymer incorporating two or more different epoxide monomers. With respect to the structural depiction of such higher polymers, the convention of showing enchainment of different monomer units separated by a slash may be used as depicted herein, e.g.,

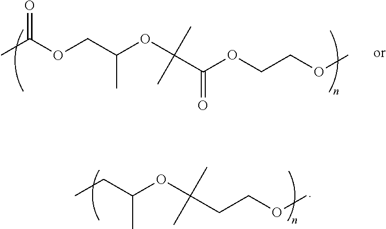

These structures are to be interpreted to encompass copolymers incorporating any ratio of the different monomer units depicted unless otherwise specified. This depiction is also meant to represent random, tapered, block copolymers, and combinations of any two or more of these and all of these are implied unless otherwise specified.

The terms “halo” and “halogen” as used herein refer to an atom selected from fluorine (fluoro, —F), chlorine (chloro, —Cl), bromine (bromo, —Br), and iodine (iodo, —I).

The terms “waterborne polyurethane dispersion” or “PUD” as used herein, refer to a polyurethane composition that uses water as the primary solvent.

The term “reference” as used herein, described a standard or control relative to which a comparison is performed. For example, in some embodiments, a polymer, composition, sample, or value of interest is compared with a reference or control polymer, composition, sample, or value. In some embodiments, a reference or control is tested and/or determined substantially simultaneously with the testing or determination of interest. In some embodiments, a reference or control is a historical reference or control, optionally embodied in a tangible medium. Typically, as would be understood by those skilled in the art, a reference or control is determined or characterized under comparable conditions or circumstances to those under assessment. Those skilled in the art will appreciate when sufficient similarities are present to justify reliance on and/or comparison to a particular possible reference or control.

### DETAILED DESCRIPTION OF CERTAIN EMBODIMENTS

### I. Polyol and Polyurethane Compositions

In some embodiments, the present inventions encompasses polyol compositions that, when incorporated into a polyurethane composition, result in one or more improved performance characteristics, e.g., strength, flexibility, elongation, etc. In certain embodiments, the present invention encompasses such polyurethane compositions. It will be appreciated that within the present disclosure, a reference to a polyurethane composition also refers to a waterborne polyurethane dispersion (PUD) composition, a solvent borne polyurethane composition, a one component polyurethane composition, a two component polyurethane composition, or a hot melt polyurethane composition.

In certain embodiments, polyurethane compositions of the present invention are derived by combining two components: a first component comprising one or more isocyanate reagents, optionally containing diluents, solvents, coreactants and the like, and a second component comprising one or more polyol reagents optionally with additional reactants, solvents, catalysts, or additives. These components may be formulated separately and then combined or all components of the finished polyurethane composition may be combined in a single step.

In certain embodiments, polyurethane compositions of the present invention were prepared from a one component formulation comprising one or more polyurethane prepolymers. In some embodiments, a polyurethane prepolymer is synthesized from one or more polyols.

In some embodiments, polyurethane compositions of the present invention were prepared from a two component formulation, wherein the first component comprises one or more isocyanates; and the second component comprises one or more polyols.

In some aspects, the present invention encompasses compositions comprising:
polyol subcomponent (i), which comprises one or more polycarbonate or polyether carbonate polyols derived from copolymerization of carbon dioxide and one or more epoxides; and
polyol subcomponent (ii), which comprises one or more polyether or polyester polyols.

In some aspects, the present invention encompasses polyurethane compositions derived from provided compositions. Polyurethane compositions of the present invention unexpectedly demonstrate improved performance properties (e.g., strength, flexibility, elongation or a combination thereof, in particular, tensile strength, tensile elongation, or modulus), as compared to a reference polyurethane composition.

Before describing these polyurethane and polyol compositions in more detail, the polyols and isocyanates from which they are formulated will be more fully described.

A. Aliphatic Polycarbonate Polyols

In certain embodiments, compositions of the present invention comprise a polyol component, wherein the polyol component comprises a polycarbonate polyol. In certain embodiments, polyurethane compositions (e.g., PUD compositions) of the present invention comprise the reaction product of a polyol component and a polyisocyanate component, wherein the polyol component comprises a polycarbonate polyol. Herein, a polycarbonate polyol refers to a substantially alternating aliphatic polycarbonate polyol. Examples of suitable aliphatic polycarbonate polyols, as well as methods of making them are disclosed in PCT publication WO 2010/028362, the entirety of which is incorporated herein by reference.

It will be appreciated that within the present disclosure, “aliphatic polycarbonate polyols” refers to a composition comprising a mixture of aliphatic polycarbonate polyol chains.

It is advantageous for many of the embodiments described herein that the aliphatic polycarbonate polyols used have a high percentage of reactive end groups. Such reactive end-groups are typically hydroxyl groups, but other reactive functional groups may be present if the polyols are treated to modify the chemistry of the end groups, such modified materials may terminate in amino groups, thiol groups, alkene groups, carboxylate groups, isocyanate groups, silyl groups, epoxy groups and the like. For purposes of this invention, the terms “aliphatic polycarbonate polyol” and “polyether carbonate” include both traditional hydroxy-terminated materials as well as these end-group modified compositions (e.g., isocyanate terminated prepolymers).

In certain embodiments, at least 90% of the end groups of the aliphatic polycarbonate polyol composition are reactive end groups. In certain embodiments, at least 95%, at least 96%, at least 97% or at least 98% of the end groups of the aliphatic polycarbonate polyol composition are reactive end groups. In certain embodiments, more than 99%, more than 99.5%, more than 99.7%, or more than 99.8% of the end groups of the aliphatic polycarbonate polyol composition used are reactive end groups. In certain embodiments, more than 99.9% of the end groups of the aliphatic polycarbonate polyol composition used are reactive end groups.

In certain embodiments, at least 90% of the end groups of the aliphatic polycarbonate polyol composition are —OH groups. In certain embodiments, at least 95%, at least 96%, at least 97% or at least 98% of the end groups of the aliphatic polycarbonate polyol composition are —OH groups. In certain embodiments, more than 99%, more than 99.5%, more than 99.7%, or more than 99.8% of the end groups of the aliphatic polycarbonate polyol composition are —OH groups. In certain embodiments, more than 99.9% of the end groups of the aliphatic polycarbonate polyol composition used are —OH groups.

Another way of expressing the —OH end-group content of a polyol composition is by reporting its OH #, which is measured using methods well known in the art. For example, OH # may be measured according to ASTM D4274 or ASTM E1899. In some embodiments, OH # is measured according to ASTM D4274. In some embodiments, OH # is measured according to ASTM E1899.

In certain embodiments, aliphatic polycarbonate polyol compositions used in the present invention have an OH # greater than about 20. In certain embodiments, aliphatic polycarbonate polyol compositions utilized in the present invention have an OH # greater than about 40. In certain embodiments, aliphatic polycarbonate polyol compositions have an OH #greater than about 50, greater than about 75, greater than about 100, or greater than about 120.

In some embodiments, aliphatic polycarbonate polyol compositions have an OH # of between about 40 and about 120. In some embodiments, aliphatic polycarbonate polyol compositions have an OH # of between about 40 and about 100. In some embodiments, aliphatic polycarbonate polyol compositions have an OH # of between about 40 and about 80. In some embodiments, aliphatic polycarbonate polyol compositions have an OH # of between about 40 and about 70. In some embodiments, aliphatic polycarbonate polyol compositions have an OH # of between about 50 and about 60. In some embodiments, aliphatic polycarbonate polyol compositions have an OH # of about 50. In some embodiments, aliphatic polycarbonate polyol compositions have an OH # of about 56.

In some embodiments, aliphatic polycarbonate polyol compositions have an OH # of between about 80 and about 120. In some embodiments, aliphatic polycarbonate polyol compositions have an OH # of between about 100 and about 120. In some embodiments, aliphatic polycarbonate polyol compositions have an OH # of between about 105 and about 115. In some embodiments, aliphatic polycarbonate polyol compositions have an OH # of about 112.

In certain embodiments, it is advantageous if aliphatic polycarbonate polyol compositions have a substantial proportion of primary hydroxyl end groups. These are the norm for compositions comprising poly(ethylene carbonate), but for polyols derived from copolymerization of substituted epoxides with CO₂, it is common for some or most of the chain ends to consist of secondary hydroxyl groups. In certain embodiments, such polyol compositions are treated to increase the proportion of primary —OH end groups. This may be accomplished by reacting the secondary hydroxyl groups with reagents such as ethylene oxide, reactive lactones, and the like. In certain embodiments, aliphatic polycarbonate polyol compositions are treated with beta lactones, caprolactone and the like to introduce primary hydroxyl end groups. In certain embodiments, aliphatic polycarbonate polyol compositions are treated with ethylene oxide to introduce primary hydroxyl end groups.

In certain embodiments, aliphatic polycarbonate polyols comprise a copolymer of carbon dioxide and one or more epoxides. In certain embodiments, aliphatic polycarbonate polyols comprise a copolymer of carbon dioxide and ethylene oxide. In certain embodiments, aliphatic polycarbonate polyols comprise a copolymer of carbon dioxide and propylene oxide. In certain embodiments, aliphatic polycarbonate polyols comprise a copolymer of carbon dioxide and 1,2-butene oxide and/or 1,2-hexene oxide. In certain embodiments, aliphatic polycarbonate polyols comprise a copolymer of carbon dioxide and cyclohexene oxide. In certain embodiments, aliphatic polycarbonate polyols comprise a copolymer of carbon dioxide and cyclopentene oxide. In certain embodiments, aliphatic polycarbonate polyols comprise a copolymer of carbon dioxide and 3-vinyl cyclohexene oxide. In certain embodiments, aliphatic polycarbonate polyols comprise a copolymer of carbon dioxide and 3-ethyl cyclohexene oxide.

In certain embodiments, aliphatic polycarbonate polyols comprise a terpolymer of carbon dioxide and ethylene oxide along with one or more additional epoxides selected from the group consisting of propylene oxide, 1,2-butene oxide, 2,3-butene oxide, cyclohexene oxide, 3-vinyl cyclohexene oxide, 3-ethyl cyclohexene oxide, cyclopentene oxide, epichlorohydrin, glicydyl esters, glycidyl ethers, styrene oxides, and epoxides of higher alpha olefins. In certain embodiments, such terpolymers contain a majority of repeat units derived from ethylene oxide with lesser amounts of repeat units derived from one or more additional epoxides. In certain embodiments, terpolymers contain about 50% to about 99.5% ethylene oxide-derived repeat units. In certain embodiments, terpolymers contain greater than about 60% ethylene oxide-derived repeat units. In certain embodiments, terpolymers contain greater than 75% ethylene oxide-derived repeat units. In certain embodiments, terpolymers contain greater than 80% ethylene oxide-derived repeat units. In certain embodiments, terpolymers contain greater than 85% ethylene oxide-derived repeat units. In certain embodiments, terpolymers contain greater than 90% ethylene oxide-derived repeat units. In certain embodiments, terpolymers contain greater than 95% ethylene oxide-derived repeat units.

In some embodiments, aliphatic polycarbonate polyols comprise a copolymer of carbon dioxide and propylene oxide along with one or more additional epoxides selected from the group consisting of ethylene oxide, 1,2-butene oxide, 2,3-butene oxide, cyclohexene oxide, 3-vinyl cyclohexene oxide, cyclopentene oxide, epichlorohydrin, glicydyl esters, glycidyl ethers, styrene oxides, and epoxides of higher alpha olefins. In certain embodiments, such terpolymers contain a majority of repeat units derived from propylene oxide with lesser amounts of repeat units derived from one or more additional epoxides. In certain embodiments, terpolymers contain about 50% to about 99.5% propylene oxide-derived repeat units. In certain embodiments, terpolymers contain greater than 60% propylene oxide-derived repeat units. In certain embodiments, terpolymers contain greater than 75% propylene oxide-derived repeat units. In certain embodiments, terpolymers contain greater than 80% propylene oxide-derived repeat units. In certain embodiments, terpolymers contain greater than 85% propylene oxide-derived repeat units. In certain embodiments, terpolymers contain greater than 90% propylene oxide-derived repeat units. In certain embodiments, terpolymers contain greater than 95% propylene oxide-derived repeat units.

In certain embodiments, aliphatic polycarbonate polyol compositions have a Mₙ in the range of 500 g/mol to about 50,000 g/mol. In some embodiments, Mn is measured by size-exclusion chromatography. In some embodiments, Mn is measured by gel permeation chromatography. In some embodiments, gel permeation chromatography comprises a polystyrene standard.

In certain embodiments, aliphatic polycarbonate polyol compositions have a Mn between about 500 g/mol and about 40,000 g/mol. In certain embodiments, aliphatic polycarbonate polyol compositions have a Mn less than about 25,000 g/mol. In certain embodiments, aliphatic polycarbonate polyol compositions have a Mn between about 500 g/mol and about 20,000 g/mol. In certain embodiments, aliphatic polycarbonate polyol compositions have a Mn between about 500 g/mol and about 10,000 g/mol. In certain embodiments, aliphatic polycarbonate polyol compositions have a Mn between about 500 g/mol and about 5,000 g/mol. In certain embodiments, aliphatic polycarbonate polyol compositions have a Mn between about 1,000 g/mol and about 5,000 g/mol. In certain embodiments, aliphatic polycarbonate polyol compositions have a Mn between about 5,000 g/mol and about 10,000 g/mol. In certain embodiments, aliphatic polycarbonate polyol compositions have a Mn between about 500 g/mol and about 1,000 g/mol. In certain embodiments, aliphatic polycarbonate polyol compositions have a Mn between about 500 g/mol and about 2,000 g/mol. In certain embodiments, aliphatic polycarbonate polyol compositions have a Mn between about 1,000 g/mol and about 3,000 g/mol. In certain embodiments, aliphatic polycarbonate polyol compositions have a Mn of about 5,000 g/mol. In certain embodiments, aliphatic polycarbonate polyol compositions have a Mn of about 4,000 g/mol. In certain embodiments, aliphatic polycarbonate polyol compositions have a Mn of about 3,000 g/mol. In certain embodiments, aliphatic polycarbonate polyol compositions have a Mn of about 2,500 g/mol. In certain embodiments, aliphatic polycarbonate polyol compositions have a Mn of about 2,000 g/mol. In certain embodiments, aliphatic polycarbonate polyol compositions have a Mn of about 1,500 g/mol. In certain embodiments, aliphatic polycarbonate polyol compositions have a Mn of about 1,000 g/mol. In certain embodiments, aliphatic polycarbonate polyol compositions have a Mn of about 750 g/mol. In certain embodiments, aliphatic polycarbonate polyol compositions have a Mn of about 500 g/mol.

In certain embodiments, aliphatic polycarbonate polyols used are characterized in that they have a narrow molecular weight distribution. This can be indicated by the polydispersity indices (PDI) of the polycarbonate polyols. In certain embodiments, aliphatic polycarbonate polyol compositions (or a subcomponent thereof) have a PDI less than 3. In certain embodiments, aliphatic polycarbonate polyol compositions (or a subcomponent thereof) have a PDI less than 2. In certain embodiments, aliphatic polycarbonate polyol compositions (or a subcomponent thereof) have a PDI less than 1.8. In certain embodiments, aliphatic polycarbonate polyol compositions (or a subcomponent thereof) have a PDI less than 1.5. In certain embodiments, aliphatic polycarbonate polyol compositions (or a subcomponent thereof) have a PDI less than 1.4. In certain embodiments, aliphatic polycarbonate polyol compositions (or a subcomponent thereof) have a PDI between about 1.0 and 1.2. In certain embodiments, aliphatic polycarbonate polyol compositions (or a subcomponent thereof) have a PDI between about 1.0 and 1.1.

In certain embodiments, aliphatic polycarbonate polyol compositions used do not have a narrow PDI. This can be the case if, for example, a polydisperse chain transfer agent is used to initiate an epoxide CO₂ copolymerization, or if a plurality of polycarbonate polyol compositions with different molecular weights are blended. In certain embodiments, aliphatic polycarbonate polyol compositions (or a subcomponent thereof) have a PDI greater than 3. In certain embodiments, aliphatic polycarbonate polyol compositions (or a subcomponent thereof) have a PDI greater than 2. In certain embodiments, aliphatic polycarbonate polyol compositions (or a subcomponent thereof) have a PDI greater than 1.8. In certain embodiments, aliphatic polycarbonate polyol compositions (or a subcomponent thereof) have a PDI greater than 1.5. In certain embodiments, aliphatic polycarbonate polyol compositions (or a subcomponent thereof) have a PDI greater than 1.4.

In some embodiments, PDI is measured by size-exclusion chromatography. In some embodiments, PDI is measured by gel permeation chromatography. In some embodiments, gel permeation chromatography comprises a polystyrene standard.

In certain embodiments, aliphatic polycarbonate polyols contain a high percentage of carbonate linkages and a low content of ether linkages. In some embodiments, the percentage of carbonate linkages may be determined by ¹H or ¹³C NMR spectroscopy. In some embodiments, the percentage of carbonate linkages may be determined by infrared (IR) or Raman spectroscopy.

In certain embodiments, aliphatic polycarbonate polyol compositions of the present invention comprise substantially alternating polymers containing a high percentage of carbonate linkages and a low content of ether linkages. In certain embodiments, aliphatic polycarbonate polyol compositions of the present invention are characterized in that, on average in the composition, the percentage of carbonate linkages is 85% or greater. In certain embodiments, aliphatic polycarbonate polyol compositions of the present invention are characterized in that, on average in the composition, the percentage of carbonate linkages is 90% or greater. In certain embodiments, aliphatic polycarbonate polyol compositions of the present invention are characterized in that, on average in the composition, the percentage of carbonate linkages is 91% or greater. In certain embodiments, aliphatic polycarbonate polyol compositions of the present invention are characterized in that, on average in the composition, the percentage of carbonate linkages is 92% or greater. In certain embodiments, aliphatic polycarbonate polyol compositions of the present invention are characterized in that, on average in the composition, the percentage of carbonate linkages is 93% or greater. In certain embodiments, aliphatic polycarbonate polyol compositions of the present invention are characterized in that, on average in the composition, the percentage of carbonate linkages is 94% or greater. In certain embodiments, aliphatic polycarbonate polyol compositions of the present invention are characterized in that, on average in the composition, the percentage of carbonate linkages is 95% or greater. In certain embodiments, aliphatic polycarbonate polyol compositions of the present invention are characterized in that, on average in the composition, the percentage of carbonate linkages is 96% or greater. In certain embodiments, aliphatic polycarbonate polyol compositions of the present invention are characterized in that, on average in the composition, the percentage of carbonate linkages is 97% or greater. In certain embodiments, aliphatic polycarbonate polyol compositions of the present invention are characterized in that, on average in the composition, the percentage of carbonate linkages is 98% or greater. In certain embodiments, aliphatic polycarbonate polyol compositions of the present invention are characterized in that, on average in the composition, the percentage of carbonate linkages is 99% or greater. In certain embodiments, aliphatic polycarbonate polyol compositions of the present invention are characterized in that, on average in the composition, the percentage of carbonate linkages is 99.5% or greater. Unless otherwise stated, the percentages above exclude ether linkages present in polymerization initiators or chain transfer agents and refer only to the linkages formed during epoxide CO₂ copolymerization.

In certain embodiments, aliphatic polycarbonate polyol compositions are characterized in that they contain essentially no ether linkages either within the polymer chains derived from epoxide CO₂ copolymerization or within any polymerization initiators, chain transfer agents, or end groups that may be present in the polymer. In certain embodiments, aliphatic polycarbonate polyol compositions are characterized in that they contain, on average, less than one ether linkage per polymer chain within the composition. In certain embodiments, aliphatic polycarbonate polyol compositions are characterized in that they contain essentially no ether linkages.

In certain embodiments, where an aliphatic polycarbonate polyol is derived from mono-substituted epoxides (e.g. such as propylene oxide, 1,2-butylene oxide, epichlorohydrin, epoxidized alpha olefins, or a glycidol derivative), the aliphatic polycarbonate polyol is characterized in that it is regioregular. Regioregularity may be expressed as the percentage of adjacent monomer units that are oriented in a head-to-tail arrangement within the polymer chain. In certain embodiments, aliphatic polycarbonate polyols have a head-to-tail content higher than about 80%. In certain embodiments, the head-to-tail content is higher than about 85%. In certain embodiments, the head-to-tail content is higher than about 90%. In certain embodiments, the head-to-tail content is greater than about 91%, greater than about 92%, greater than about 93%, greater than about 94%, or greater than about 95%. In certain embodiments, the head-to-tail content of the polymer is as determined by proton or carbon-13 NMR spectroscopy.

In certain embodiments, aliphatic polycarbonate polyols have a structure P1:

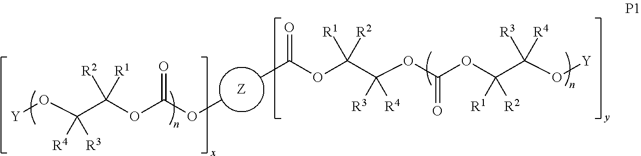

wherein,
R¹, R², R³, and R⁴ are, at each occurrence in the polymer chain, independently selected from the group consisting of —H, fluorine, an optionally substituted C₁₋₃₀ aliphatic group, and an optionally substituted C₁₋₄₀ heteroaliphatic group, and an optionally substituted aryl group, where any two or more of R¹, R², R³, and R⁴ may optionally be taken together with intervening atoms to form one or more optionally substituted rings optionally containing one or more heteroatoms;
Y is, at each occurrence, independently —H, a reactive group (as defined hereinabove), or a site of attachment to any of the chain-extending moieties or isocyanates described in the classes and subclasses herein;
n is at each occurrence, independently an integer from about 2 to about 50;

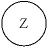

is a covalent bond or a multivalent moiety; and
x and y are each independently an integer from 0 to 6, where the sum of x and y is between 2 and 6.

In some embodiments, R¹, R², R³, and R⁴ are, independently at each occurrence in the polymer chain, selected from the group consisting of hydrogen and optionally substituted C₁-C₆ aliphatic. In some embodiments, R¹, R², R³, and R⁴ are, independently at each occurrence in the polymer chain, selected from the group consisting of hydrogen and methyl.

In some embodiments, Y is, at each occurrence, —H or the site of attachment to a chain-extending moiety. In some embodiments Y is —H.

It will be understood that when a composition comprises an aliphatic polycarbonate polyol has a structure of formulae P1 through P2r-a, the composition may also comprise other polymer species, e.g., those with occurrences where n is 0 or 1.

In certain embodiments, the multivalent moiety

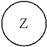

embedded within the aliphatic polycarbonate chain is derived from a polyfunctional chain transfer agent having two or more sites from which epoxide/CO₂ copolymerization can occur. In certain embodiments, such copolymerizations are performed in the presence of polyfunctional chain transfer agents as exemplified in published PCT application WO 2010/028362. In certain embodiments, such copolymerizations are performed as exemplified in US 2011/0245424. In certain embodiments, such copolymerizations are performed as exemplified in Green Chem. 2011, 13, 3469-3475.

In certain embodiments, a polyfunctional chain transfer agent has a formula:

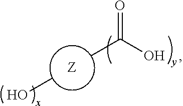

wherein each of

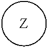

x, and y is as defined above and described in classes and subclasses herein.

In certain embodiments, aliphatic polycarbonate polyols are derived from the copolymerization of one or more epoxides with carbon dioxide in the presence of such polyfunctional chain transfer agents as shown in Scheme 1:

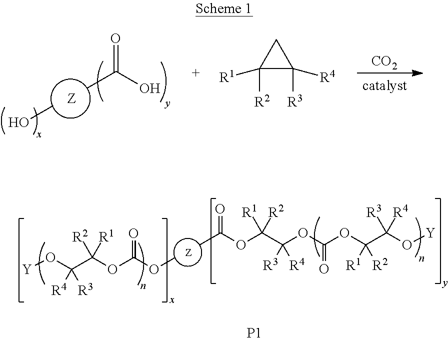

In certain embodiments, aliphatic polycarbonate polyols have a structure of Formula P2:

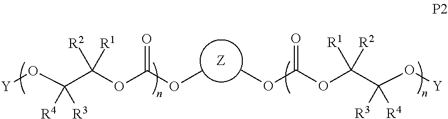

wherein each of R¹, R², R³, R⁴, Y,

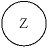

and n is as defined above and described in the classes and subclasses herein.

In certain embodiments where aliphatic polycarbonate polyol chains have a structure P2,

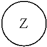

is derived from a dihydric alcohol. In such instances

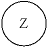

represents the carbon-containing backbone of the dihydric alcohol, while the two oxygen atoms adjacent to

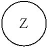

are derived from the —OH groups of the diol. For example, if the polyfunctional chain transfer agent were ethylene glycol, then

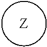

would be —CH₂CH₂— and P2 would have the following structure:

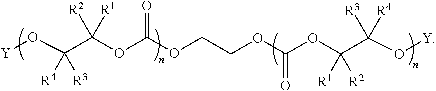

In certain embodiments where

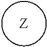

is derived from a dihydric alcohol, the dihydric alcohol comprises a C₂₋₄₀ diol. In certain embodiments, the dihydric alcohol is selected from the group consisting of: 1,2-ethanediol, 1,2-propanediol, 1,3-propanediol, 1,2-butanediol, 1,3-butanediol, 1,4-butanediol, 1,5-pentanediol, 2,2-dimethylpropane-1,3-diol, 2-butyl-2-ethylpropane-1,3-diol, 2-methyl-2,4-pentane diol, 2-ethyl-1,3-hexane diol, 2-methyl-1,3-propane diol, 1,5-hexanediol, 1,6-hexanediol, 1,8-octanediol, 1,10-decanediol, 1,12-dodecanediol, 2,2,4,4-tetramethylcyclobutane-1,3-diol, 1,3-cyclopentanediol, 1,2-cyclohexanediol, 1,3-cyclohexanediol, 1,4-cyclohexanediol, 1,2-cyclohexanedimethanol, 1,3-cyclohexanedimethanol, 1,4-cyclohexanedimethanol, 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these.

In certain embodiments, where

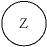

is derived from a dihydric alcohol, the dihydric alcohol is selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycol), such as those having number average molecular weights of from 234 to about 2000 g/mol. In some embodiments,

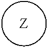

is derived from dipropylene glycol.

In certain embodiments, where

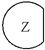

is derived from a dihydric alcohol, the dihydric alcohol comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments, where

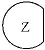

is derived from a dihydric alcohol, the dihydric alcohol comprises a polymeric diol. In certain embodiments, a polymeric diol is selected from the group consisting of polyethers, polyesters, hydroxy-terminated polyolefins, polyether-copolyesters, polyether polycarbonates, polycarbonate-copolyesters, polyoxymethylene polymers, and alkoxylated analogs of any of these. In certain embodiments, a polymeric diol has an average molecular weight less than about 2000 g/mol. In some embodiments, a polymeric diol has an average molecular weight of between about 500 g/mol and about 1,500 g/mol. In some embodiments, a polymeric diol has an average molecular weight of between about 750 g/mol and about 1,250 g/mol. In some embodiments, a polymeric diol has an average molecular weight of between about 900 g/mol and about 1,100 g/mol. In some embodiments, a polymeric diol has an average molecular weight of about 1,000 g/mol.

In some embodiments, a polymeric diol is a polyether. In some embodiments, a polymeric diol is polyethylene glycol. In some embodiments, a polymeric diol is polypropylene glycol. In some embodiments, a polymeric diol is a polyester.

In certain embodiments,

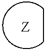

is derived from a polyhydric alcohol with more than two hydroxy groups. In embodiments in which

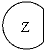

is derived from a polyhydric alcohol with more than two hydroxyl groups, these >2 functional polyols are a component of a polyol mixture containing predominantly polyols with two hydroxyl groups. In certain embodiments, these >2 functional polyols are less than 20% of the total polyol mixture by weight. In certain embodiments, these >2 functional polyols are less than 10% of the total polyol mixture. In certain embodiments, these >2 functional polyols are less than 5% of the total polyol mixture. In certain embodiments, these >2 functional polyols are less than 2% of the total polyol mixture.

In certain embodiments, aliphatic polycarbonate polyol compositions comprise polycarbonate polyols where the moiety

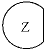

is derived from a triol. In certain embodiments, such polycarbonate polyols have the structure P3:

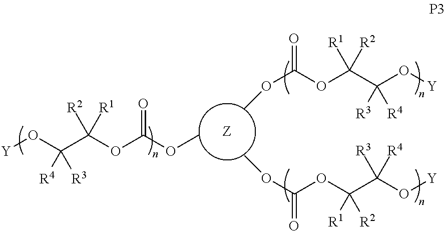

wherein each of R¹, R², R³, R⁴, Y,

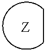

and n is as defined above and described in classes and subclasses herein.

In certain embodiments where

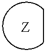

is derived from a triol, the triol is selected from the group consisting of: glycerol, 1,2,4-butanetriol, 2-(hydroxymethyl)-1,3-propanediol; hexane triols, trimethylol propane, trimethylol ethane, trimethylhexane, 1,2,4-cyclohexanetrimethanol, pentaerythritol mono esters, pentaerythritol mono ethers, and alkoxylated analogs of any of these. In certain embodiments, such alkoxylated derivatives comprise ethoxylated or propoxylated compounds.

In certain embodiments,

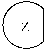

is derived from an alkoxylated derivative of a trifunctional carboxylic acid or trifunctional hydroxy acid. In certain embodiments, alkoxylated derivatives comprise ethoxylated or propoxylated compounds.

In certain embodiments, where

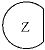

is derived from a polymeric triol, the polymeric triol is selected from the group consisting of polyethers, polyesters, hydroxy-terminated polyolefins, polyether-copolyesters, polyether polycarbonates, polyoxymethylene polymers, polycarbonate-copolyesters, and alkoxylated analogs of any of these. In certain embodiments, the alkoxylated polymeric triols comprise ethoxylated or propoxylated compounds.

In certain embodiments,

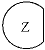

is derived from a polyhydric alcohol with four hydroxy groups.

In certain embodiments, aliphatic polycarbonate polyol compositions comprise polycarbonate polyols where the moiety

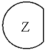

is derived from a tetraol. In certain embodiments, polycarbonate polyols have the structure P4:

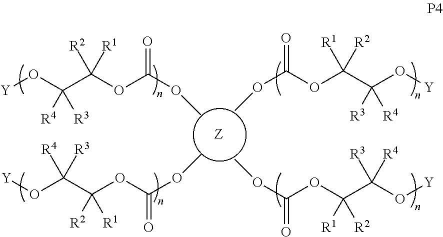

wherein each of R¹, R², R³, R⁴, Y,

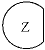

and n is as defined above and described in classes and subclasses herein.

In certain embodiments,

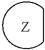

is derived from a polyhydric alcohol with more than four hydroxy groups. In certain embodiments,

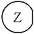

is derived from a polyhydric alcohol with six hydroxy groups. In certain embodiments, a polyhydric alcohol is dipentaerythritol or an alkoxylated analog or other derivative thereof. In certain embodiments, a polyhydric alcohol is sorbitol or an alkoxylated analog thereof.

In certain embodiments, aliphatic polycarbonate polyols have the structure P5:

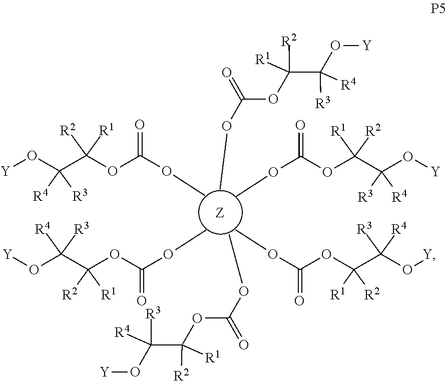

wherein each of R¹, R², R³, R⁴, Y,

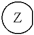

and n is as defined above and described in classes and subclasses herein.

In certain embodiments, aliphatic polycarbonate polyols comprise a combination of bifunctional chains (e.g. aliphatic polycarbonates of formula P2) in combination with higher functional chains (e.g. one or more aliphatic polycarbonates of formulae P3 to P5).

In certain embodiments,

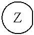

is derived from a hydroxy acid. In certain embodiments, aliphatic polycarbonate polyols have the structure P6:

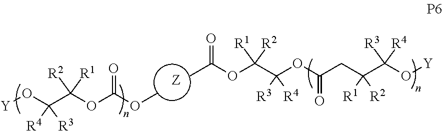

wherein each of R¹, R², R³, R⁴, Y,

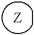

and n is as defined above and described in classes and subclasses herein.

In such instances,

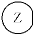

represents the carbon-containing backbone of the hydroxy acid, while ester and carbonate linkages adjacent to

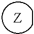

are derived from the —CO₂H group and the hydroxy group of the hydroxy acid. For example, if

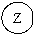

were derived from 3-hydroxypropanoic acid, then

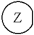

would be —CH₂CH₂— and P6 would have the following structure:

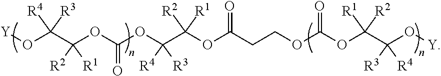

In certain embodiments,

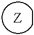

is derived from an optionally substituted C₂₋₄₀ hydroxy acid. In certain embodiments,

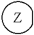

is derived from a polyester. In certain embodiments, such polyesters have a molecular weight less than about 2000 g/mol.

In certain embodiments, a hydroxy acid is an alpha-hydroxy acid. In certain embodiments, a hydroxy acid is selected from the group consisting of: glycolic acid, DL-lactic acid, D-lactic acid, L-lactic, citric acid, and mandelic acid.

In certain embodiments, a hydroxy acid is a beta-hydroxy acid. In certain embodiments, a hydroxy acid is selected from the group consisting of: 3-hydroxypropionic acid, DL 3-hydroxybutryic acid, D-3 hydroxybutryic acid, L-3-hydroxybutyric acid, DL-3-hydroxy valeric acid, D-3-hydroxy valeric acid, L-3-hydroxy valeric acid, salicylic acid, and derivatives of salicylic acid.

In certain embodiments, a hydroxy acid is a α-ω hydroxy acid. In certain embodiments, a hydroxy acid is selected from the group consisting of: of optionally substituted C₃₋₂₀ aliphatic α-ω hydroxy acids and oligomeric esters.

In certain embodiments, a hydroxy acid is selected from the group consisting of:

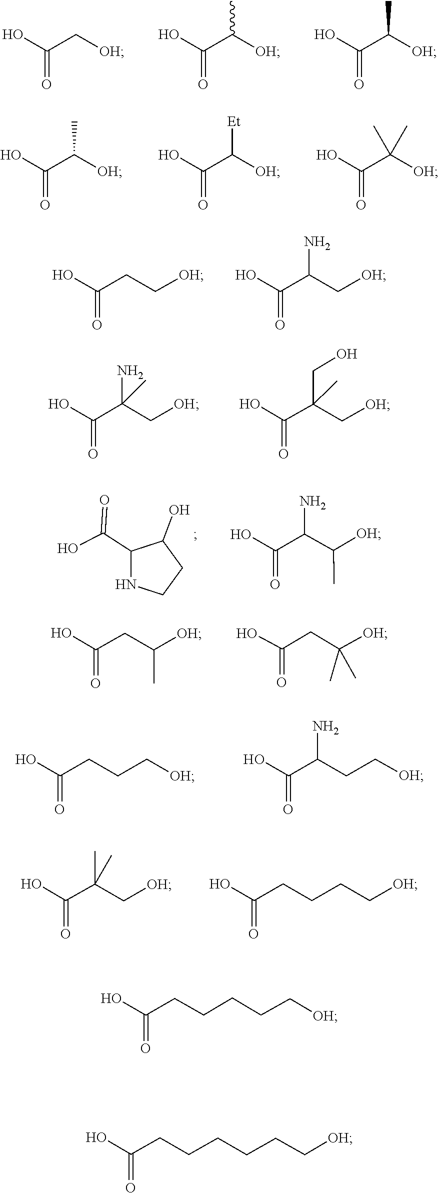

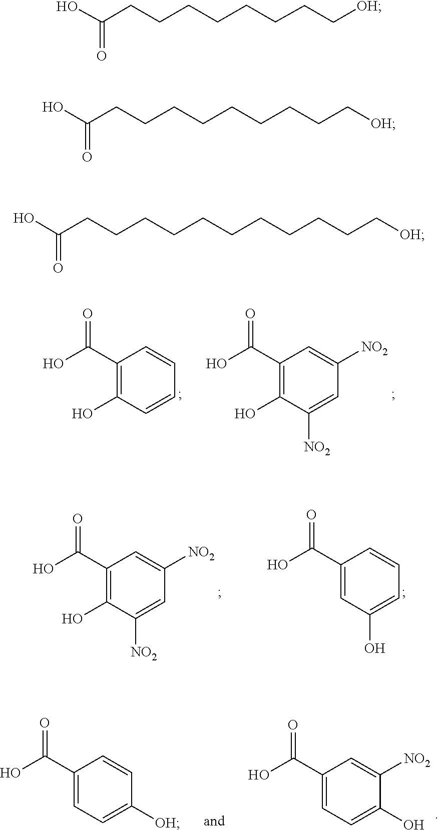

In certain embodiments,

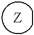

is derived from a polycarboxylic acid. In certain embodiments, aliphatic polycarbonate polyols have the structure P7:

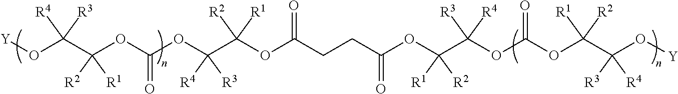

wherein each of R¹, R², R³, R⁴, Y,

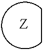

and n is as defined above and described in classes and subclasses herein, and y′ is an integer from 1 to 5 inclusive.

In embodiments, where the aliphatic polycarbonate polyols have a structure P7,

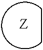

represents the carbon-containing backbone (or a bond in the case of oxalic acid) of a polycarboxylic acid, while ester groups adjacent to

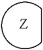

are derived from —CO₂H groups of the polycarboxylic acid. For example, if

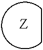

were derived from succinic acid (HO₂CCH₂CH₂CO₂H), then

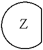

would be —CH₂CH₂— and P7 would have the following structure:

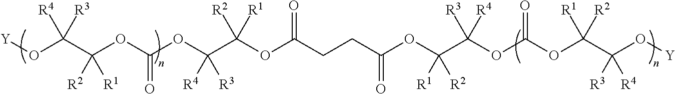

wherein each of R¹, R², R³, R⁴, Y, and n is as defined above and described in classes and subclasses herein.

In certain embodiments,

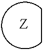

is derived from a dicarboxylic acid. In certain embodiments, aliphatic polycarbonate polyols have the structure P8:

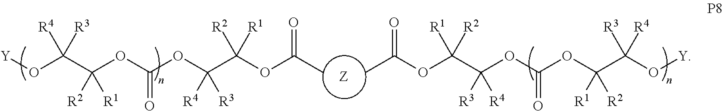

In certain embodiments,

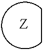

is selected from the group consisting of: phthalic acid, isophthalic acid, terephthalic acid, maleic acid, succinic acid, malonic acid, glutaric acid, adipic acid, pimelic acid, suberic acid, and azelaic acid.

In certain embodiments,

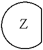

is derived from a diacid selected from the group consisting of:

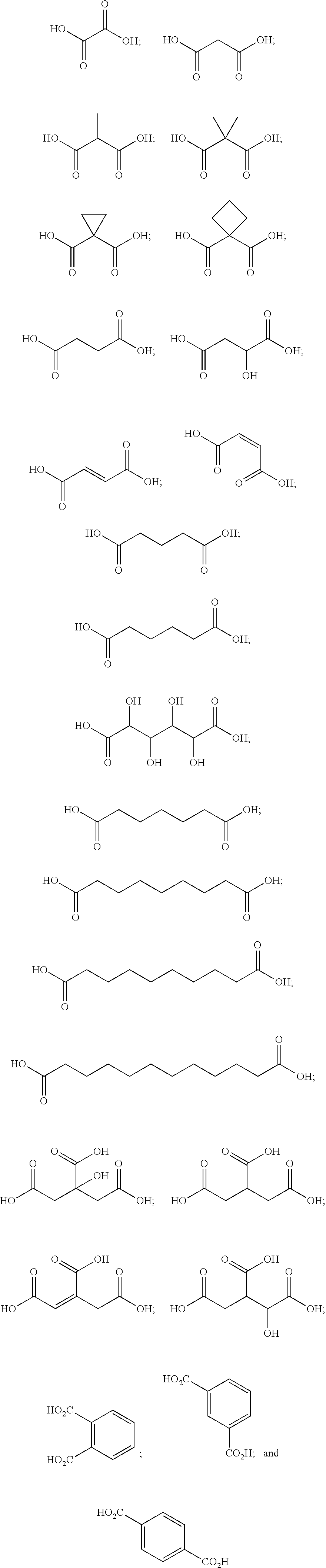

In certain embodiments,

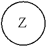

is derived from a phosphorous-containing molecule. In certain embodiments,

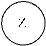

has a formula —P(O)(OR)ₖ— where each R is independently an optionally substituted C₁₋₂₀ aliphatic group or an optionally substituted aryl group and k is 0, 1, or 2.

For example, if

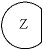

were derived from PhO—P(O)(OH)₂, then

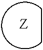

would be —P(O)(OPh)— and P7 would have the following structure:

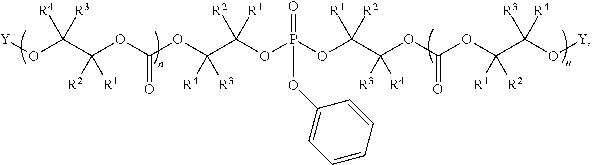

wherein each of R¹, R², R³, R⁴, Y, and n is as defined above and described in classes and subclasses herein.

In certain embodiments,

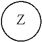

is derived from a phosphorous-containing molecule selected from the group consisting of:

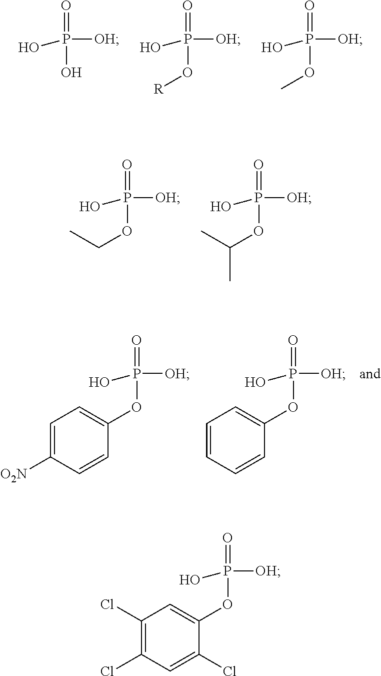

In certain embodiments,

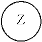

has a formula —P(O)(R)— where R is an optionally substituted C₁₋₂₀ aliphatic group or an optionally substituted aryl group and k is 0, 1, or 2. In certain embodiments,

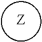

is derived from a phosphorous-containing molecule selected from the group consisting of:

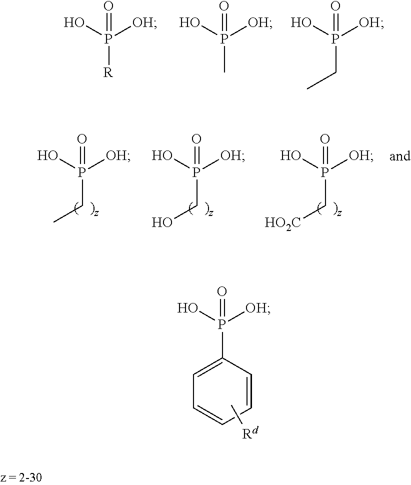

where each of R is as defined above and in the classes and subclasses herein; and R^{d} is optionally substituted C₁₋₆ aliphatic.

In certain embodiments,

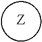

has a formula —PR— where R is an optionally substituted C₁₋₂₀ aliphatic group or an optionally substituted aryl group.

In certain embodiments, each

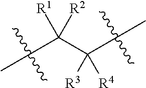

in the structures herein is independently selected from the group consisting of:

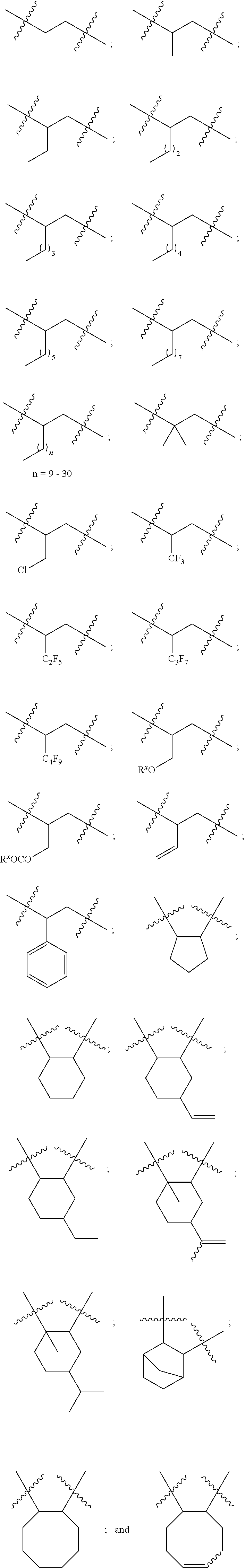

wherein each R^{x} is independently an optionally substituted moiety selected from the group consisting of C₂₋₂₀ aliphatic, C₂₋₂₀ heteroaliphatic, 3- to 14-membered carbocyclic, 6- to 10-membered aryl, 5- to 10-membered heteroaryl, and 3- to 12-membered heterocyclic.

In certain embodiments, each

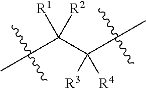

in the structures herein is independently selected from the group consisting of:

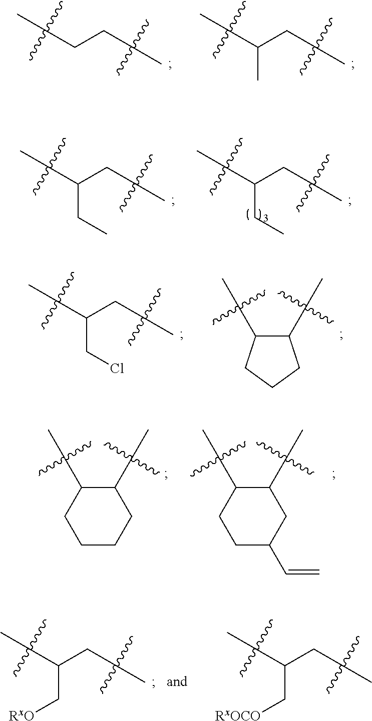

wherein R^{x} is as defined above and described in classes and subclasses herein.

In certain embodiments, the moiety —Y in the structures herein is —H.

In certain embodiments, —Y comprises an ester linkage to an optionally substituted C₂₋₄₀ linker comprising (e.g., terminated with) an —OH group. In certain embodiments, —Y is selected from the group consisting of:

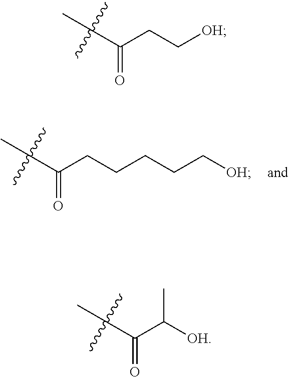

In certain embodiments, —Y comprises an ester linkage to an optionally substituted C₂₋₄₀ linker comprising (e.g., terminated with) an —CO₂H group. In certain embodiments, —Y is selected from the group consisting of:

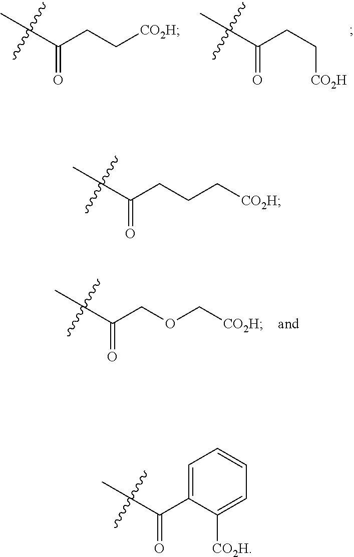 [SMILES: *C(=O)CCC(=O)O ; *C(=O)CCC(=O)O ; *C(=O)CCCC(=O)O ; *C(=O)COCC(=O)O ; "and" ; *C(=O)c1ccccc1C(=O)O]

In certain embodiments, the moiety —Y in the structures herein comprises a hydroxy-terminated polymer. In certain embodiments, —Y comprises a hydroxy-terminated polyether. In certain embodiments, —Y comprises

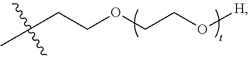

where t is an integer from 1 to 20.

In certain embodiments, —Y comprises a hydroxy-terminated polyester. In certain embodiments, —Y is selected from the group consisting of:

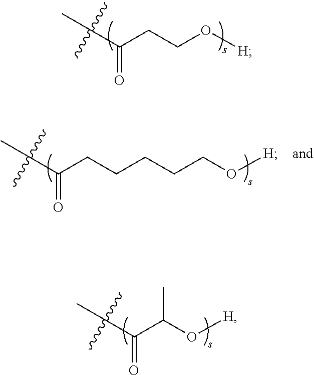

where s is an integer from 2 to 20.

In certain embodiments, aliphatic polycarbonate polyols comprise:

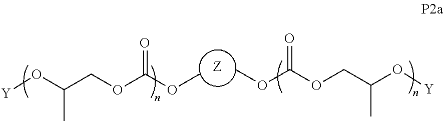

wherein each of

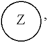

—Y, and n is as defined above and described in classes and subclasses herein.

In certain embodiments, aliphatic polycarbonate polyols comprise:

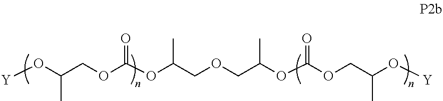

wherein each of —Y and n is as defined above and described in classes and subclasses herein.

In certain embodiments, aliphatic polycarbonate polyols comprise:

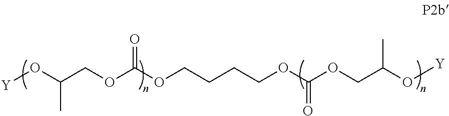

wherein each of —Y and n is as defined above and described in classes and subclasses herein.

In certain embodiments, aliphatic polycarbonate polyols comprise:

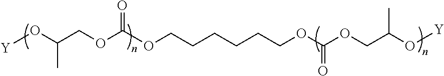

wherein each of —Y and n is as defined above and described in classes and subclasses herein.

In certain embodiments, aliphatic polycarbonate polyols comprise:

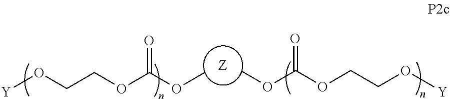

wherein each of

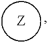

—Y, and n is as defined above and described in classes and subclasses herein.

In certain embodiments, aliphatic polycarbonate polyols comprise:

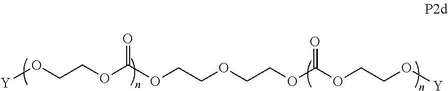

wherein each of —Y and n is as defined above and described in classes and subclasses herein.

In certain embodiments, aliphatic polycarbonate polyols comprise:

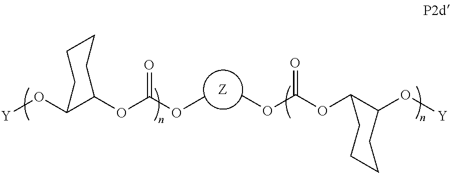

wherein each of

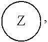

—Y, and n is as defined above and described in classes and subclasses herein.

In certain embodiments, aliphatic polycarbonate polyols comprise:

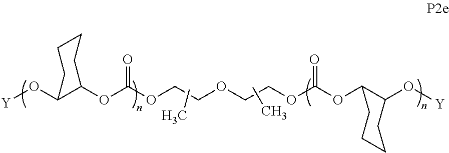

wherein each of —Y and n are is as defined above and described in classes and subclasses herein.

In certain embodiments, aliphatic polycarbonate polyols comprise:

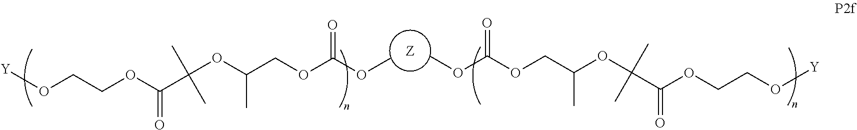

wherein each of

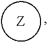

—Y, and n is as defined above and described in classes and subclasses herein.

In certain embodiments, aliphatic polycarbonate polyols comprise:

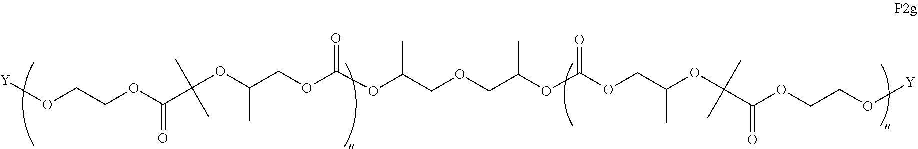

wherein each of —Y and n is as defined above and described in classes and subclasses herein.

In certain embodiments, aliphatic polycarbonate polyols comprise:

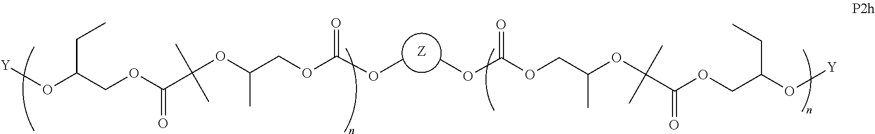

wherein each of

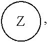

—Y, and n is as defined above and described in classes and subclasses herein.

In certain embodiments, aliphatic polycarbonate polyols comprise:

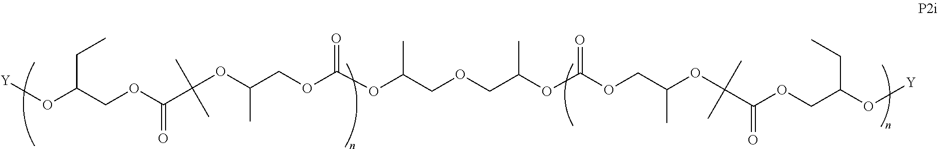

wherein each of —Y and n is as defined above and described in classes and subclasses herein.

In certain embodiments, aliphatic polycarbonate polyols comprise:

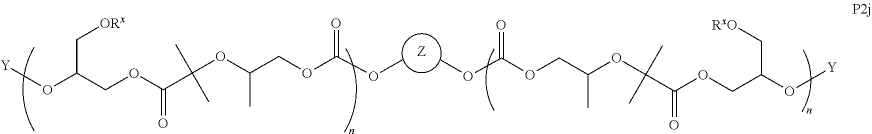

wherein each of

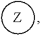

—Y, R^{x}, and n is as defined above and described in classes and subclasses herein.

In certain embodiments, aliphatic polycarbonate polyols comprise:

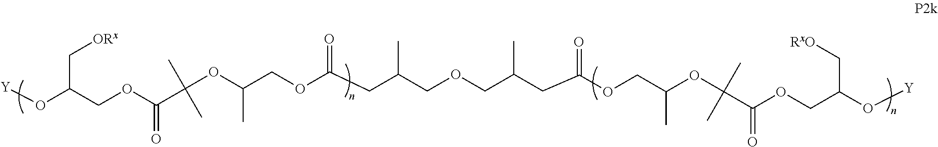

wherein each of —Y, R^{x}, and n is as defined above and described in classes and subclasses herein.

In certain embodiments, aliphatic polycarbonate polyols comprise:

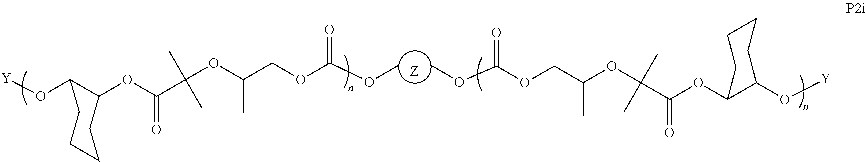

wherein each of

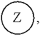

—Y, and n is as defined above and described in classes and subclasses herein.

In certain embodiments, aliphatic polycarbonate polyols comprise:

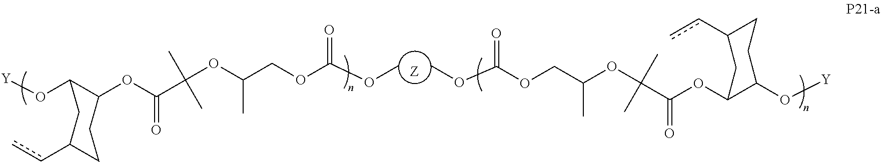

wherein each of

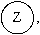

—Y, and n are is as defined above and described in classes and subclasses herein; and each [symbol] independently represents a single or double bond.

In certain embodiments, aliphatic polycarbonate polyols comprise:

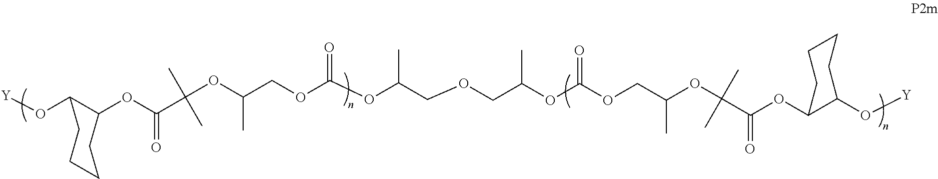

wherein each of —Y and n is as defined above and described in classes and subclasses herein.

In certain embodiments, aliphatic polycarbonate polyols comprise:

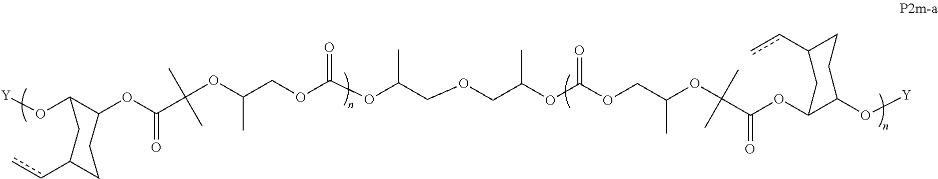

wherein each of —Y, [symbol] , and n is as defined above and described in classes and subclasses herein.

In certain embodiments, aliphatic polycarbonate polyols comprise:

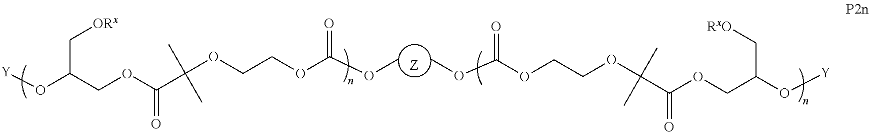

wherein each of

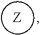

—Y, R^{x}, —Y and n is as defined above and described in classes and subclasses herein.

In certain embodiments, aliphatic polycarbonate polyols comprise:

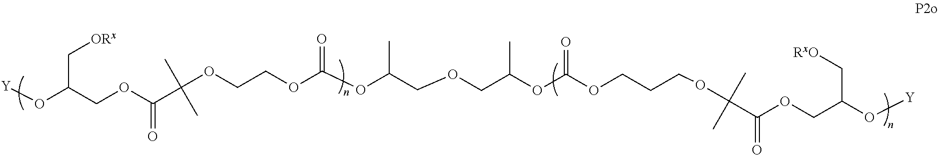

wherein each of —Y, R^{x}, and n is as defined above and described in classes and subclasses herein.

In certain embodiments, aliphatic polycarbonate polyols comprise:

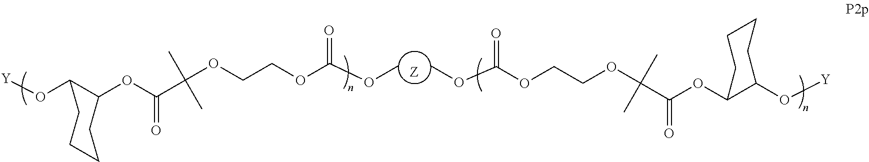

wherein each of

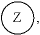

—Y, and n is as defined above and described in classes and subclasses herein.

In certain embodiments, aliphatic polycarbonate polyols comprise:

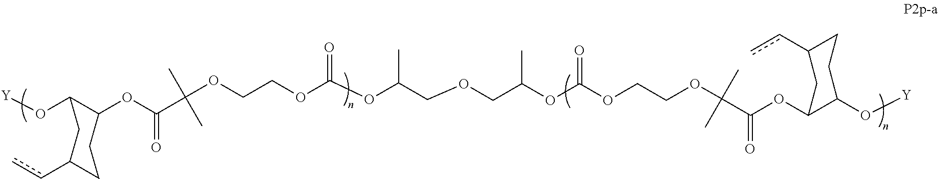

wherein each of —Y, [symbol] and n is as defined above and described in classes and subclasses herein.

In certain embodiments, aliphatic polycarbonate polyols comprise:

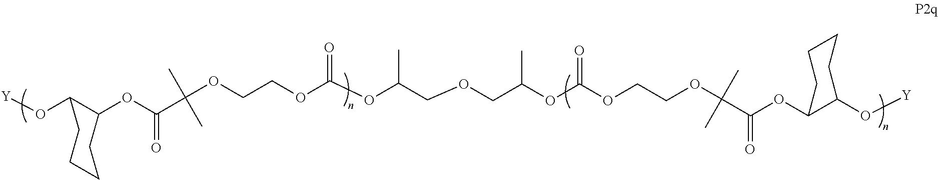

wherein each of —Y and n is as defined above and described in classes and subclasses herein.

In certain embodiments, aliphatic polycarbonate polyols comprise:

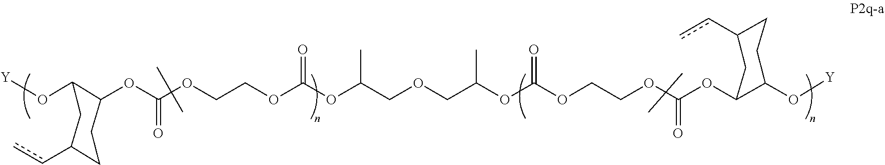

wherein each of —Y, [symbol] and n is as defined above and described in classes and subclasses herein.

In certain embodiments, aliphatic polycarbonate polyols comprise:

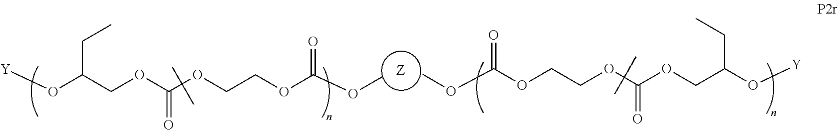

wherein each of

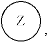

—Y, and n is as defined above and described in classes and subclasses herein.

In certain embodiments, aliphatic polycarbonate polyols comprise:

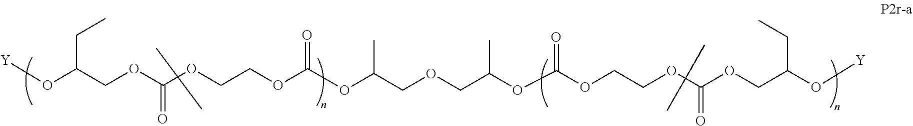

wherein each of —Y and n is as defined above and described in classes and subclasses herein.

In certain embodiments, in aliphatic polycarbonate polyols of structures P2a, P2c, P2d, P2f, P2h, P2j, P2l, P21-a, P2n, P2p, and P2r,

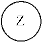

is selected from the group consisting of: ethylene glycol; diethylene glycol, triethylene glycol, 1,3 propane diol; 1,4 butane diol, hexylene glycol, 1,6 hexane diol, neopentyl glycol, propylene glycol, dipropylene glycol, tripropylene glycol, and alkoxylated derivatives of any of these.

In certain embodiments, in aliphatic polycarbonates of structures P2a, through P2r-a, —Y is —H.

For polycarbonates comprising repeat units derived from two or more epoxides, such as those represented by structures P2f through P2r-a, depicted above, it is to be understood that the structures drawn may represent mixtures of positional isomers or regioisomers that are not explicitly depicted. For example, the polymer repeat unit adjacent to either end group of the polycarbonate chains can be derived from either one of the two epoxides comprising the copolymers. Thus, while the polymers may be drawn with a particular repeat unit attached to an end group, the terminal repeat units might be derived from either of the two epoxides and a given polymer composition might comprise a mixture of all of the possibilities in varying ratios. The ratio of these end-groups can be influenced by several factors including the ratio of the different epoxides used in the polymerization, the structure of the catalyst used, the reaction conditions used (i.e temperature pressure, etc.) as well as by the timing of addition of reaction components. Similarly, while the drawings above may show a defined regiochemistry for repeat units derived from substituted epoxides, the polymer compositions will, in some cases, contain mixtures of regioisomers. The regioselectivity of a given polymerization can be influenced by numerous factors including the structure of the catalyst used and the reaction conditions employed. To clarify, this means that the composition represented by structure P2r above, may contain a mixture of several compounds as shown in the diagram below. This diagram shows the isomers graphically for polymer P2r, where the structures below the depiction of the chain show each regio- and positional isomer possible for the monomer unit adjacent to the chain transfer agent and the end groups on each side of the main polymer chain. Each end group on the polymer may be independently selected from the groups shown on the left or right while the central portion of the polymer including the chain transfer agent and its two adjacent monomer units may be independently selected from the groups shown. In certain embodiments, the polycarbonate polyol composition comprises a mixture of all possible combinations of these. In other embodiments, the polycarbonate polyol composition is enriched in one or more of these.

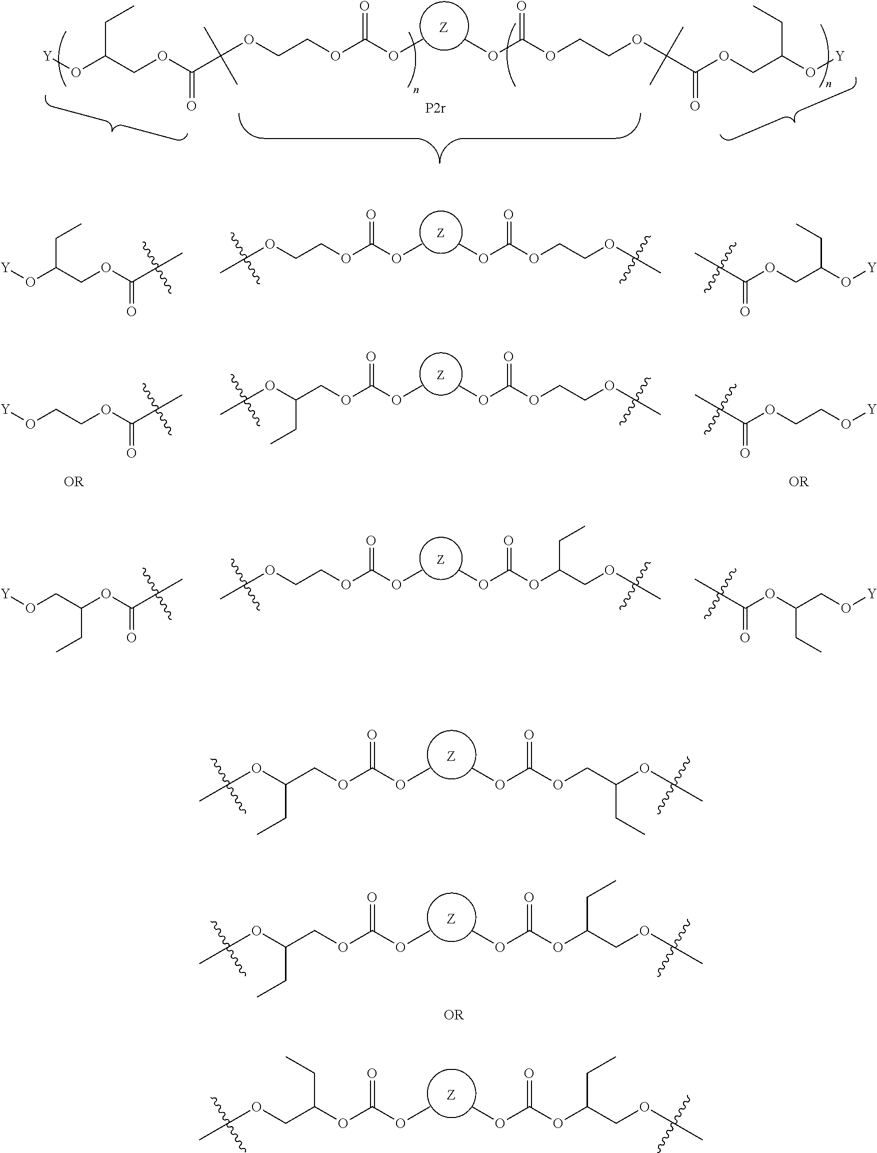

In certain embodiments, aliphatic polycarbonate polyols are selected from the group consisting of Q1, Q2, Q3, Q4, Q5, Q6, and mixtures of any two or more of these.

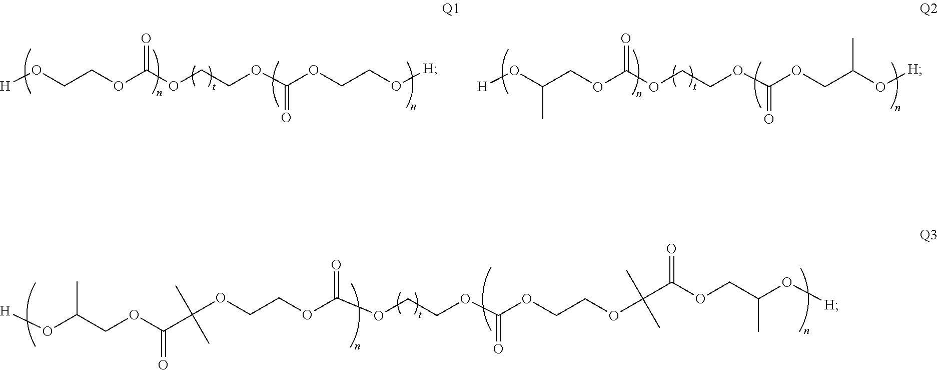

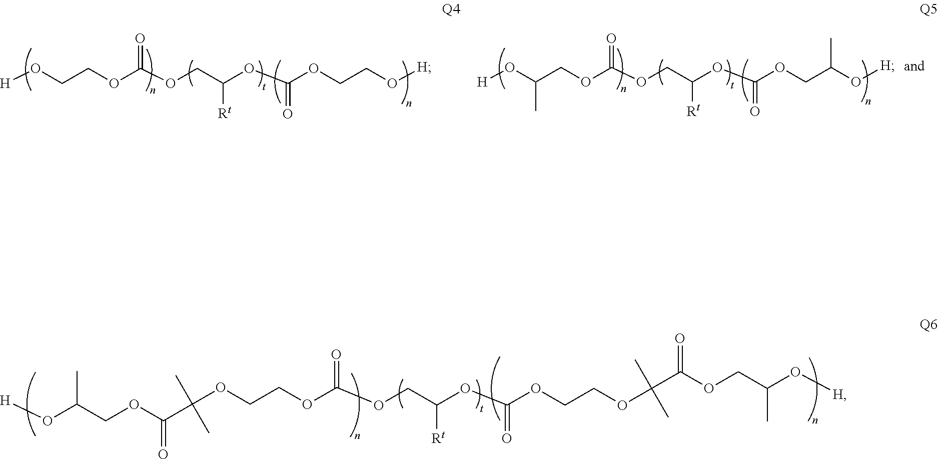

wherein, t is an integer from 1 to 12 inclusive, and R^{t} is independently at each occurrence —H, or —CH₃.

In certain embodiments, an aliphatic polycarbonate polyol is selected from the group consisting of:
Poly(ethylene carbonate) of formula Q1 having an average molecular weight number of between about 500 g/mol and about 3,000 g/mol, a polydispersity index less than about 1.25, at least 8500 carbonate linkages, and at least 98% —OH end groups;
Poly(ethylene carbonate) of formula Q1 having an average molecular weight number of about 500 g/mol, a polydispersity index less than about 1.25, at least 85%0 carbonate linkages, and at least 98% —OH end groups;
Poly(ethylene carbonate) of formula Q1 having an average molecular weight number of about 1,000 g/mol, a polydispersity index less than about 1.25, at least 85% carbonate linkages, and at least 98% —OH end groups;
Poly(ethylene carbonate) of formula Q1 having an average molecular weight number of about 2,000 g/mol, a polydispersity index less than about 1.25, at least 85% carbonate linkages, and at least 98% —OH end groups;
Poly(ethylene carbonate) of formula Q1 having an average molecular weight number of about 3,000 g/mol, a polydispersity index less than about 1.25, at least 85% carbonate linkages, and at least 98% —OH end groups;
Poly(propylene carbonate) of formula Q2 having an average molecular weight number of between about 500 g/mol and about 3,000 g/mol, a polydispersity index less than about 1.25, at least 95% carbonate linkages, and at least 98% —OH end groups;
Poly(propylene carbonate) of formula Q2 having an average molecular weight number of about 500 g/mol, a polydispersity index less than about 1.25, at least 95% carbonate linkages, and at least 98% —OH end groups;
Poly(propylene carbonate) of formula Q2 having an average molecular weight number of about 1,000 g/mol, a polydispersity index less than about 1.25, at least 95% carbonate linkages, and at least 98% —OH end groups;
Poly(propylene carbonate) of formula Q2 having an average molecular weight number of about 2,000 g/mol, a polydispersity index less than about 1.25, at least 95% carbonate linkages, and at least 98% —OH end groups;
Poly(propylene carbonate) of formula Q2 having an average molecular weight number of about 3,000 g/mol, a polydispersity index less than about 1.25, at least 95% carbonate linkages, and at least 98% —OH end groups;
Poly(ethylene-co-propylene carbonate) of formula Q3 having an average molecular weight number of between about 500 g/mol and about 3,000 g/mol, a polydispersity index less than about 1.25, at least 90% carbonate linkages, and at least 98% —OH end groups;
Poly(ethylene-co-propylene carbonate) of formula Q3 having an average molecular weight number of about 500 g/mol, a polydispersity index less than about 1.25, at least 90% carbonate linkages, and at least 98% —OH end groups;
Poly(ethylene-co-propylene carbonate) of formula Q3 having an average molecular weight number of about 1,000 g/mol, a polydispersity index less than about 1.25, at least 90% carbonate linkages, and at least 98% —OH end groups;
Poly(ethylene-co-propylene carbonate) of formula Q3 having an average molecular weight number of about 2,000 g/mol (e.g. n is on average between about 10 and about 11), a polydispersity index less than about 1.25, at least 90% carbonate linkages, and at least 98% —OH end groups;
Poly(ethylene-co-propylene carbonate) of formula Q3 having an average molecular weight number of about 3,000 g/mol, a polydispersity index less than about 1.25, at least 95% carbonate linkages, and at least 98% —OH end groups;
Poly(ethylene carbonate) of formula Q4 having an average molecular weight number of between about 500 g/mol and about 3,000 g/mol (e.g. each n is between about 4 and about 16), a polydispersity index less than about 1.25, at least 95% carbonate linkages, and at least 98% —OH end groups;
Poly(ethylene carbonate) of formula Q4 having an average molecular weight number of about 500 g/mol, a polydispersity index less than about 1.25, at least 85% carbonate linkages, and at least 98% —OH end groups;
Poly(ethylene carbonate) of formula Q4 having an average molecular weight number of about 1,000 g/mol, a polydispersity index less than about 1.25, at least 85% carbonate linkages, and at least 98% —OH end groups;
Poly(ethylene carbonate) of formula Q4 having an average molecular weight number of about 2,000 g/mol, a polydispersity index less than about 1.25, at least 85% carbonate linkages, and at least 98% —OH end groups;
Poly(ethylene carbonate) of formula Q4 having an average molecular weight number of about 3,000 g/mol, a polydispersity index less than about 1.25, at least 85% carbonate linkages, and at least 98% —OH end groups.
Poly(propylene carbonate) of formula Q5 having an average molecular weight number of between about 500 g/mol and about 3,000 g/mol, a polydispersity index less than about 1.25, at least 95% carbonate linkages, and at least 98% —OH end groups;
Poly(propylene carbonate) of formula Q5 having an average molecular weight number of about 500 g/mol, a polydispersity index less than about 1.25, at least 95% carbonate linkages, and at least 98% —OH end groups;
Poly(propylene carbonate) of formula Q5 having an average molecular weight number of about 1,000 g/mol, a polydispersity index less than about 1.25, at least 95% carbonate linkages, and at least 98% —OH end groups;
Poly(propylene carbonate) of formula Q5 having an average molecular weight number of about 2,000 g/mol, a polydispersity index less than about 1.25, at least 95% carbonate linkages, and at least 98% —OH end groups;
Poly(propylene carbonate) of formula Q5 having an average molecular weight number of about 3,000 g/mol, a polydispersity index less than about 1.25, at least 95% carbonate linkages, and at least 98% —OH end groups;
Poly(ethylene-co-propylene carbonate) of formula Q6 having an average molecular weight number of between about 500 g/mol and about 3,000 g/mol, a polydispersity index less than about 1.25, at least 90% carbonate linkages, and at least 98% —OH end groups;
Poly(ethylene-co-propylene carbonate) of formula Q6 having an average molecular weight number of about 500 g/mol, a polydispersity index less than about 1.25, at least 90% carbonate linkages, and at least 98% —OH end groups;
Poly(ethylene-co-propylene carbonate) of formula Q6 having an average molecular weight number of about 1,000 g/mol, a polydispersity index less than about 1.25, at least 90% carbonate linkages, and at least 98% —OH end groups;
Poly(ethylene-co-propylene carbonate) of formula Q6 having an average molecular weight number of about 2,000 g/mol (e.g. n is on average between about 10 and about 11), a polydispersity index less than about 1.25, at least 90% carbonate linkages, and at least 98% —OH end groups;
Poly(ethylene-co-propylene carbonate) of formula Q6 having an average molecular weight number of about 3,000 g/mol, a polydispersity index less than about 1.25, at least 95% carbonate linkages, and at least 98% —OH end groups; and
Mixtures of any two or more of these.

In certain embodiments, the

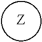

in the embedded chain transfer agent is a moiety derived from a polymeric diol or higher polyhydric alcohol. In certain embodiments, such polymeric alcohols are polyether or polyester polyols. In certain embodiments

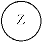

is a polyether polyol comprising ethylene glycol or propylene glycol repeating units (—OCH₂CH₂O—, or —OCH₂CH(CH₃)O—) or combinations of these. In certain embodiments,

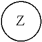

is a polyester polyol comprising the reaction product of a diol and a diacid, or a material derived from ring-opening polymerization of one or more lactones.

In certain embodiments where

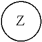

comprises a polyether diol, an aliphatic polycarbonate polyol has a structure Q7:

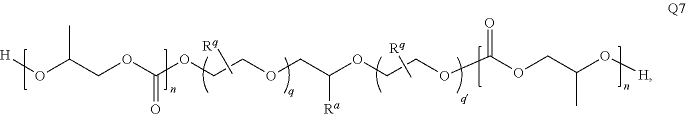

wherein,
R^{q} is at each occurrence in the polymer chain independently —H or —CH₃;
R^{a} is —H, or —CH₃;
q and q′ are independently an integer from about 0 to about 40; and
and n is as defined above and in the examples and embodiments herein.

In certain embodiments, an aliphatic polycarbonate polyol is selected from the group consisting of:

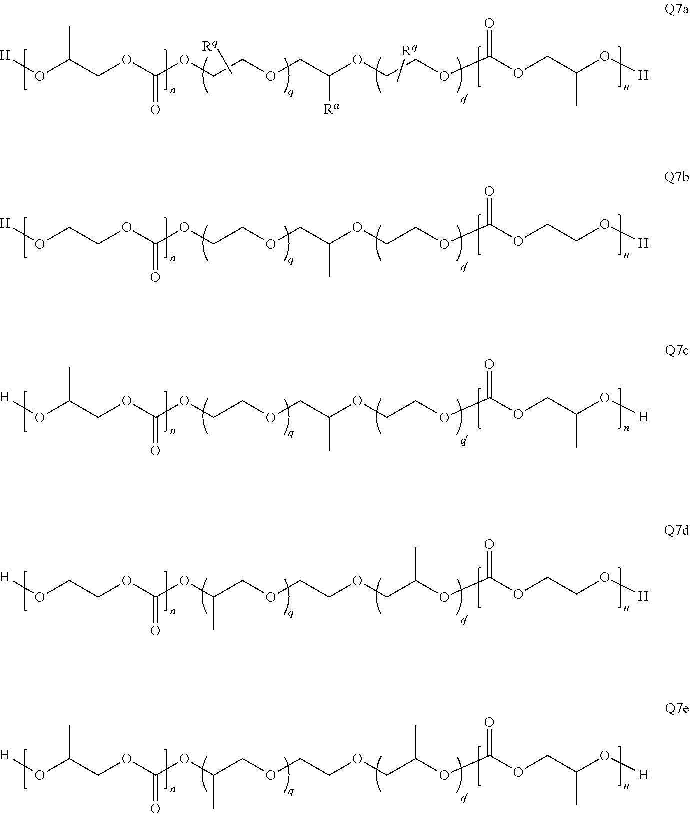

In certain embodiments, where aliphatic polycarbonate polyols comprise polymer chains conforming to structure Q7, the moiety

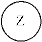

is derived from a commercially available polyether polyol such as those typically used in the formulation of polyurethane compositions.

In certain embodiments, where

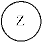

comprises a polyester diol, an aliphatic polycarbonate polyol has a structure Q8:

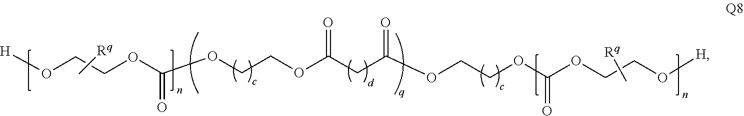

wherein,
c at each occurrence in the polymer chain independently is an integer from 0 to 6;
d at each occurrence in the polymer chain independently is an integer from 1 to 11; and
each of R^{q}, n, and q is as defined above and in the examples and embodiments herein.

In certain embodiments, an aliphatic polycarbonate polyol is selected from the group consisting of:

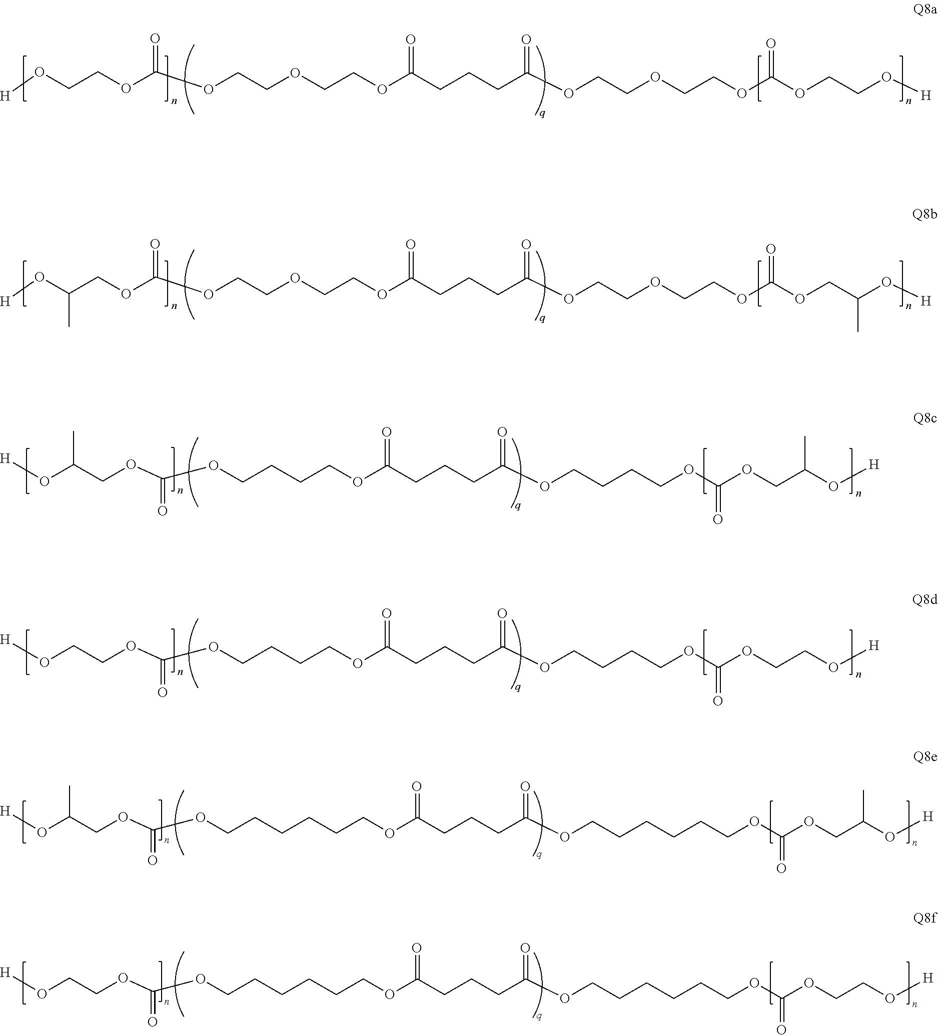

In certain embodiments, where aliphatic polycarbonate polyols comprise polymer chains conforming to structure Q8, the moiety

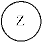

is derived from a commercially available polyester polyol such as those typically used in the formulation of polyurethane compositions.

In certain embodiments, an aliphatic polycarbonate polyol has a structure of formula

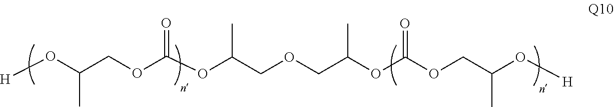

wherein each n′ is, at each occurrence, independently an integer from about 2 to about 50.

In some embodiments, each n′ is, at each occurrence, independently an integer from about 2 to about 20, from about 2 to about 15, from about 2 to about 10, from about 3 to about 7, or from about 4 to about 5. In some embodiments, the sum of the n′ moieties within each polymer chain is between about 6 to about 12, between about 7 to about 11, between about 8 to about 10, or about 9.

It will be understood that when a composition comprising an aliphatic polycarbonate polyol has a structure of formula Q10, the composition may also comprise other polymer species, e.g., those with occurrences where n′ is 0 or 1.

In some embodiments, an aliphatic polycarbonate polyol has a structure of formula Q10 and an OH # of between about 105 and about 120, or an OH # of about 112.

In certain embodiments, an aliphatic polycarbonate polyol has a structure of formula

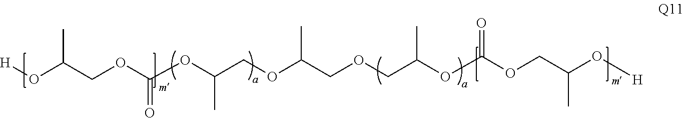

wherein each a is, at each occurrence, independently an integer from about 2 to about 50; and each m′ is, at each occurrence, independently an integer from about 2 to about 50.

In certain embodiments, each a is, at each occurrence, independently an integer from about 2 to about 20, from about 2 to about 15, from about 5 to about 12, from about 6 to about 10, from about 7 to about 9, or about 8. In some embodiments, the sum of the a moieties within each polymer chain is between about 12 and about 20, between about 14 and about 18, between about 15 and about 17, or about 16.

In certain embodiments, each m′ is, at each occurrence, independently an integer from about 2 to about 20, from about 2 to about 10, from about 3 to about 7, from about 4 to about 6, or about 5. In certain embodiments, the sum of the m′ moieties within each polymer chain is between about 5 and about 15, between about 5 and about 10, between about 10 and about 15, between about 8 and about 12, between about 9 and about 11, or about 10.

It will be understood that when a composition comprising an aliphatic polycarbonate polyol has a structure of formula Q11, the composition may also comprise other polymer species, e.g., those with occurrences where m′ is 0 or 1.

In some embodiments, an aliphatic polycarbonate polyol has a structure of formula Q11 and an OH # of between about 50 and about 60, or an OH # of about 56.

B. Polyether Carbonate Polyols

In some embodiments, compositions of the present invention comprise polyether carbonate polyols derived from copolymerization of carbon dioxide and one or more epoxides (i.e., polymer chains containing carbonate linkages as described above, and ether linkages).

In some embodiments, polyurethane compositions (e.g., PUD compositions) of the present invention comprise the reaction product of a polyol component and a polyisocyanate component, wherein the polyol component comprises a polyether carbonate polyols derived from copolymerization of carbon dioxide and one or more epoxides (i.e., polymer chains containing carbonate linkages as described above, and ether linkages).

It will be appreciated that within the present disclosure, “polyether carbonate polyols” refers to a composition comprising a mixture of polyether carbonate polyol chains.

In certain embodiments, polyether carbonate polyols of the present invention comprise polymers containing both carbonate linkages and ether linkages (i.e., where such ether linkages are other than those found in a polyether initiator or chain transfer agent). In some embodiments, the percentage of carbonate linkages (or ether linkages) may be determined by ¹H or ¹³C NMR spectroscopy. In some embodiments, the percentage of carbonate linkages (or ether linkages) may be determined by infrared (IR) or Raman spectroscopy.

In some embodiments, polyether carbonates are characterized in that, on average in the composition, the percentage of carbonate linkages is between about 5% and about 50%. In some embodiments, polyether carbonates are characterized in that, on average in the composition, the percentage of carbonate linkages is between about 10% and about 50%. In some embodiments, polyether carbonates are characterized in that, on average in the composition, the percentage of carbonate linkages is between about 15% and about 50%. In some embodiments, polyether carbonates are characterized in that, on average in the composition, the percentage of carbonate linkages is between about 20% and about 50%. In some embodiments, polyether carbonates are characterized in that, on average in the composition, the percentage of carbonate linkages is between about 25% and about 50%. In some embodiments, polyether carbonates are characterized in that, on average in the composition, the percentage of carbonate linkages is between about 30% and about 50%. In some embodiments, polyether carbonates are characterized in that, on average in the composition, the percentage of carbonate linkages is between about 35% and about 50%. In some embodiments, polyether carbonates are characterized in that, on average in the composition, the percentage of carbonate linkages is between about 40% and about 50%. In some embodiments, polyether carbonates are characterized in that, on average in the composition, the percentage of carbonate linkages is between about 45% and about 50%. In some embodiments, polyether carbonates are characterized in that, on average in the composition, the percentage of carbonate linkages is between about 5% and about 40%. In some embodiments, polyether carbonates are characterized in that, on average in the composition, the percentage of carbonate linkages is between about 5% and about 30%. In some embodiments, polyether carbonates are characterized in that, on average in the composition, the percentage of carbonate linkages is between about 5% and about 20%. In some embodiments, polyether carbonates are characterized in that, on average in the composition, the percentage of carbonate linkages is between about 5% and about 10%. In some embodiments, polyether carbonates are characterized in that, on average in the composition, the percentage of carbonate linkages is between about 20% and about 50%. In some embodiments, polyether carbonates are characterized in that, on average in the composition, the percentage of carbonate linkages is between about 20% and about 40%.

In some embodiments, polyether carbonates are characterized in that, on average in the composition, the percentage of carbonate linkages is between about 5% and about 85%. In some embodiments, polyether carbonates are characterized in that, on average in the composition, the percentage of carbonate linkages is between about 20% and about 85%. In some embodiments, polyether carbonates are characterized in that, on average in the composition, the percentage of carbonate linkages is between about 20% and about 70%. In some embodiments, polyether carbonates are characterized in that, on average in the composition, the percentage of carbonate linkages is between about 30% and about 60%. In some embodiments, polyether carbonates are characterized in that, on average in the composition, the percentage of carbonate linkages is between about 50% and about 85%. In some embodiments, polyether carbonates are characterized in that, on average in the composition, the percentage of carbonate linkages is between about 60% and about 85%. In some embodiments, polyether carbonates are characterized in that, on average in the composition, the percentage of carbonate linkages is between about 70% and about 85%.

In certain embodiments, polyether carbonate polyols comprise a structure described in section I-A above, and a percentage of carbonate linkages described in section I-B above. For example, in some embodiments, polyether carbonate polyols have a structure:

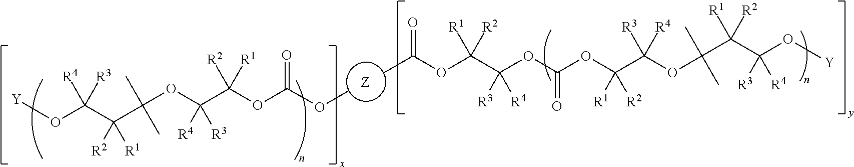

wherein each R¹, R², R³, R⁴,

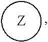

n, x, and y is as described above and defined herein.

C. Polyether Polyols

In some embodiments, compositions of the present invention comprise polyether polyols.

In some embodiments, polyurethane compositions (PUD compositions) of the present invention comprise the reaction product of a polyol component and a polyisocyanate component, wherein the polyol component comprises a polyether polyol comprising a repeating tetramethylene unit.

It will be appreciated that within the present disclosure, “polyether polyols” or “a polyether polyol” refers to a composition comprising a mixture of polyether polyol chains.

In some embodiments, a polyether polyol comprises a repeating ethylene unit. In some embodiments, a polyether polyol comprises a repeating propylene unit. In some embodiments, a polyether polyol comprises a repeating tetramethylene unit. In some embodiments, a polyether polyol comprises a repeating pentamethylene unit. In some embodiments, a polyether polyol comprises a repeating hexamethylene unit.

In some embodiments, a polyether polyol comprises a repeating unit of formula:

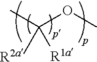

wherein
p is 1-8;
p′ is 1-6; and
each R^{1a′} and R^{2a′} is, independently at each occurrence in the polymer chain, selected from the group consisting of hydrogen and optionally substituted C₁-C₆ aliphatic.

In some embodiments, p is 1-6. In some embodiments, p is 1-4. In some embodiments, p is 1. In some embodiments, p is 2. In some embodiments, p is 3. In some embodiments, p is 4. In some embodiments, p is 5. In some embodiments, p is 6. In some embodiments, p is 7. In some embodiments, p is 8.

In some embodiments, p′ is 1-4. In some embodiments, p′ is 1. In some embodiments, p′ is 2. In some embodiments, p′ is 3. In some embodiments, p′ is 4. In some embodiments, p′ is 5. In some embodiments, p′ is 6.

In some embodiments, R^{1a′} and R^{2a′} are, independently at each occurrence in the polymer chain, selected from the group consisting of hydrogen and optionally substituted C₁-C₃ aliphatic. In some embodiments, R^{1a′} and R^{2a′} are, independently at each occurrence in the polymer chain, selected from the group consisting of hydrogen and C₁-C₆ aliphatic. In some embodiments, R^{1a′} and R^{2a′} are, independently at each occurrence in the polymer chain, selected from the group consisting of hydrogen and C₁-C₃ aliphatic. In some embodiments, R^{1a′} and R^{2a′} are, independently at each occurrence in the polymer chain, selected from the group consisting of hydrogen and methyl. In some embodiments, R^{1a′} and R^{2a′} are hydrogen.

In some embodiments, a polyether polyol comprises a repeating unit of formula:

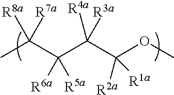

wherein
R^{1a}, R^{2a}, R^{3a}, R^{4a}, R^{5a}, R^{6a}, R^{7a}, and R^{8a} are, independently at each occurrence in the polymer chain, selected from the group consisting of hydrogen and optionally substituted C₁-C₆ aliphatic.

In some embodiments, R^{1a}, R^{2a}, R^{3a}, R^{4a}, R^{5a}, R^{6a}, R^{7a}, and R^{8a} are, independently at each occurrence in the polymer chain, selected from the group consisting of hydrogen and optionally substituted C₁-C₃ aliphatic. In some embodiments, R^{1a}, R^{2a}, R^{3a}, R^{4a}, R^{5a}, R^{6a}, R^{7a}, and R^{8a} are, independently at each occurrence in the polymer chain, selected from the group consisting of hydrogen and C₁-C₆ aliphatic. In some embodiments, R^{1a}, R^{2a}, R^{3a}, R^{4a}, R^{5a}, R^{6a}, R^{7a}, and R^{8a} are, independently at each occurrence in the polymer chain, selected from the group consisting of hydrogen and C₁-C₃ aliphatic. In some embodiments, R^{1a}, R^{2a}, R^{3a}, R^{4a}, R^{5a}, R^{6a}, R^{7a}, and R^{8a} are, independently at each occurrence in the polymer chain, selected from the group consisting of hydrogen and methyl.

In some embodiments, R^{1a}, R^{2a}, R^{3a}, R^{4a}, R^{5a}, R^{6a}, R^{7a}, and R^{8a} are hydrogen.

In some embodiments, polyether polyols comprises a repeating unit of formula:

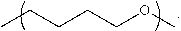

In some embodiments, a polyether polyol is or comprises poly(ethylene glycol). In some embodiments, a polyether polyol is or comprises poly(propylene glycol). In some embodiments, a polyether polyol is poly(tetramethylene glycol). In some embodiments, the polyether polyol is or comprises poly(1,2-butylene glycol). In some embodiments, the polyether polyol is or comprises poly(ethylene-co-propylene glycol).

In certain embodiments, polyether polyols are characterized in that they have a Mn between about 200 and about 10,000 g/mol. In certain embodiments, such polyether polyols have a Mn between about 200 and about 5,000 g/mol.

In some embodiments, a polyether polyol is a poly(tetramethylene glycol) characterized in that it has an Mn between about 200 g/mol and about 3,000 g/mol. In some embodiments, a polyether polyol is a poly(tetramethylene glycol) characterized in that it has an Mn between about 200 g/mol and about 2,000 g/mol. In some embodiments, a polyether polyol is a poly(tetramethylene glycol) characterized in that it has an Mn between about 200 g/mol and about 1,500 g/mol. In some embodiments, a polyether polyol is a poly(tetramethylene glycol) characterized in that it has an Mn between about 200 g/mol and about 1,000 g/mol. In some embodiments, a polyether polyol is a poly(tetramethylene glycol) characterized in that it has an Mn between about 500 g/mol and about 3,000 g/mol. In some embodiments, a polyether polyol is a poly(tetramethylene glycol) characterized in that it has an Mn between about 1,000 g/mol and about 3,000 g/mol. In some embodiments, a polyether polyol is a poly(tetramethylene glycol) characterized in that it has an Mn between about 1,500 g/mol and about 3,000 g/mol. In some embodiments, a polyether polyol is a poly(tetramethylene glycol) characterized in that it has an Mn between about 2,000 g/mol and about 3,000 g/mol.

In some embodiments, a polyether polyol is a poly(tetramethylene glycol) characterized in that it has an Mn of about 250, 650, 1,000, 1,400, 1,800, 2,000, or 3,000.

In some embodiments, a polyether polyol is a poly(tetramethylene glycol) characterized in that it has an OH # between about 40 and about 500. In some embodiments, a polyether polyol is a poly(tetramethylene glycol) characterized in that it has an OH # between about 40 and about 200. In some embodiments, a polyether polyol is a poly(tetramethylene glycol) characterized in that it has an OH # between about 40 and about 150. In some embodiments, a polyether polyol is a poly(tetramethylene glycol) characterized in that it has an OH # between about 40 and about 100. In some embodiments, a polyether polyol is a poly(tetramethylene glycol) characterized in that it has an OH # between about 40 and about 70. In some embodiments, a polyether polyol is a poly(tetramethylene glycol) characterized in that it has an OH # between about 100 and about 500. In some embodiments, a polyether polyol is a poly(tetramethylene glycol) characterized in that it has an OH # between about 250 and about 500.

In some embodiments, a polyether polyol is a commercially available polyether. Commercially available polyethers include, for example, Jeffol produced by Huntsman, Voranol produced by Dow, Lupranol produced by BASF, Carpol produced by Carpenter, Poly-G produced by Monument Chemical, Arcol produced by Covestro, Caradol produced by Shell, terathane (INVISTA process, now LYRCA), PTMG produced by Mitsubishi Chemical Corp., PTG produced by Dairen, and PTMEG produced by Korea PTG.

In some embodiments, a polyether polyol is a commercially available poly(tetramethylene glycol). Commercially available poly(tetramethylene glycol) includes, for example, poly(tetramethylene glycol) produced by BASF (e.g., PolyTHF), Dairen, LYCRA, or Korea PTG.

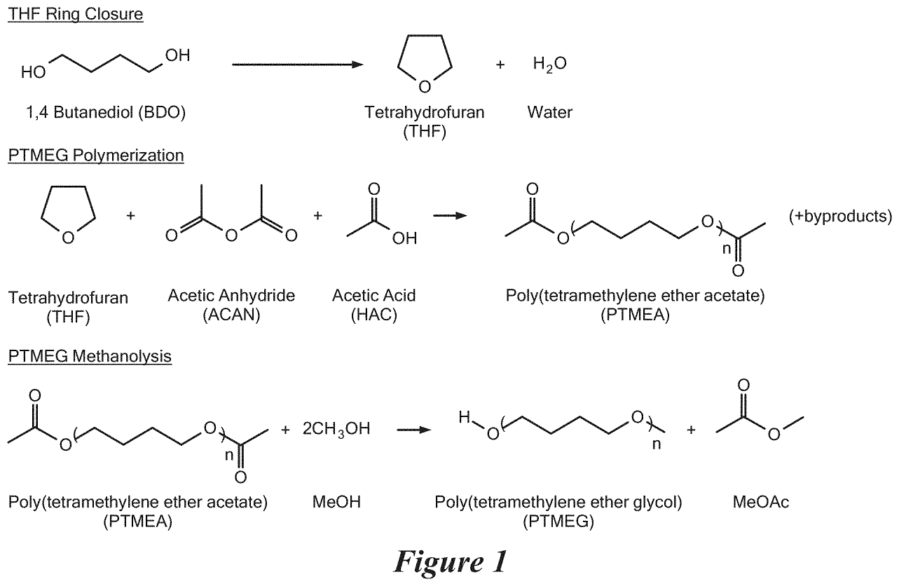

In some aspects, poly(tetramethylene glycol) can be produced by the INVISTA process, for example, as depicted in FIG. 1.

D. Polyester Polyols

In some embodiments, compositions of the present invention comprise polyester polyols.

In some embodiments, polyurethane compositions (e.g., PUD compositions) of the present invention comprise the reaction product of a polyol component and a polyisocyanate component, wherein the polyol component comprises a polyester polyol having a repeating tetramethylene unit.

It will be appreciated that within the present disclosure, “polyester polyols” refers to a composition comprising a mixture of polyester polyol chains.

In some embodiments, a polyester polyol comprises a repeating ethylene unit. In some embodiments, a polyester polyol comprises a repeating propylene unit. In some embodiments, a polyester polyol comprises a repeating tetramethylene unit. In some embodiments, a polyester polyol comprises a repeating pentamethylene unit. In some embodiments, a polyester polyol comprises a repeating hexamethylene unit.

In some embodiments, a polyester polyol comprises a repeating unit of formula:

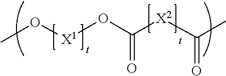

wherein
X¹ and X² are, independently at each occurrence in the polymer chain, selected from —C(R^{9b})(R^{10b})— or —(C(R^{9b})(R^{10b}))_{n″}—O—(C(R^{9b})(R^{10b}))_{n″}—;
R^{9b} and R^{10b}, are, independently at each occurrence in the polymer chain, selected from the group consisting of hydrogen and optionally substituted C₁-C₆ aliphatic; or
   two of R^{9b} and R^{10b}, when present on adjacent atoms, together with their intervening atoms, may form a 4- to 8-membered carbocyclic ring;
   each n″ is, at each occurrence in the polymer chain, an integer from 1 to 4; and each t, independently at each occurrence in the polymer chain, an integer from 1 to 8.

In some embodiments, a polyester polyol is derived from a diol comprising two hydroxyl groups that are separated by four carbons, and a diacid.

In some embodiments, a polyester polyol comprises a repeating unit of formula:

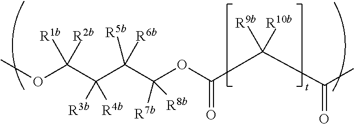

wherein
R^{1b}, R^{2b}, R^{3b}, R^{4b}, R^{5b}, R^{6b}, R^{7b}, R^{8b}, R^{9b}, and R^{10b}, are, independently at each occurrence in the polymer chain, selected from the group consisting of hydrogen and optionally substituted C₁-C₆ aliphatic; and
   each t is, at each occurrence within a polymer chain, an integer from 1 and 8.

In some embodiments, a polyester polyol comprises a repeating unit of formula:

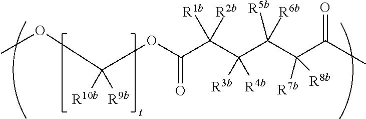

wherein
R^{1b}, R^{2b}, R^{3b}, R^{4b}, R^{5b}, R^{6b}, R^{7b}, R^{8b}, R^{9b}, R^{10b}, and t is as defined above and described herein.

In some embodiments, a polyester polyol comprises a repeating unit of formula:

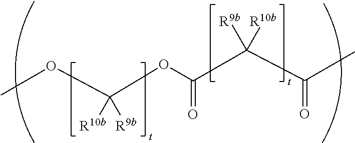

wherein
R^{1b}, R^{2b}, R^{3b}, R^{4b}, R^{5b}, R^{6b}, R^{7b}, R^{8b}, R^{9b}, R^{10b}, and t is as defined above and described herein.

In some embodiments, a polyester polyol comprises a repeating unit of formula:

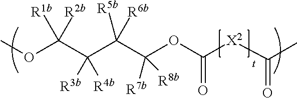

wherein
R^{1b}, R^{2b}, R^{3b}, R^{4b}, R^{5b}, R^{6b}, R^{7b}, R^{8b}, X² and t are as defined above and described herein.

In some embodiments, a polyester polyol comprises a repeating unit of formula:

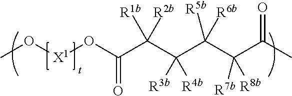

wherein
R^{1b}, R^{2b}, R^{3b}, R^{4b}, R^{8b}, R^{6b}, R^{7b}, R^{8b}, X¹ and t are as defined above and described herein.

In some embodiments, n″ is an integer from 1-3. In some embodiments, n″ is an integer from 1 to 2. In some embodiments, n″ is 1. In some embodiments, n″ is 2. In some embodiments, n″ is 3. In some embodiments, n″ is 4.

In some embodiments, X¹ and X² are, independently at each occurrence in the polymer chain, selected from —C(R^{9b})(R^{10b})—. In some embodiments, X¹ and X² are, independently at each occurrence in the polymer chain, selected from —(C(R^{9b})(R^{10b}))_{n″}—O—(C(R^{9b})(R^{10b}))_{n″}—.

In some embodiments, each X¹ unit within a polymer chain is —C(R^{9b})(R^{10b})—. In some embodiments, each X¹ unit within a polymer chain is —(C(R^{9b})(R^{10b}))_{n″}—O—(C(R^{9b})(R^{10b}))_{n″}—. In some embodiments, each X² unit within a polymer chain is —C(R^{9b})(R^{10b})—. In some embodiments, each X² unit within a polymer chain is —(C(R^{9b})(R^{10b}))_{n″}—O—(C(R^{9b})(R^{10b}))_{n″}—.

In some embodiments, R^{1b}, R^{2b}, R^{3b}, R^{4b}, R^{5b}, R^{6b}, R^{7b}, R^{8b}, R^{9b}, and R^{10b}, are, independently at each occurrence in the polymer chain, selected from the group consisting of hydrogen and optionally substituted C₁-C₆ aliphatic.

In some embodiments, R^{1b}, R^{2b}, R^{3b}, R^{4b}, R^{5b}, R^{6b}, R^{7b}, and R^{8b} are, independently at each occurrence in the polymer chain, selected from the group consisting of hydrogen and optionally substituted C₁-C₃ aliphatic. In some embodiments, R^{1b}, R^{2b}, R^{3b}, R^{4b}, R^{5b}, R^{6b}, R^{7b}, and R^{8b} are, independently at each occurrence in the polymer chain, selected from the group consisting of hydrogen and C₁-C₆ aliphatic. In some embodiments, R^{1b}, R^{2b}, R^{3b}, R^{4b}, R^{5b}, R^{6b}, R^{7b}, and R^{8b} are, independently at each occurrence in the polymer chain, selected from the group consisting of hydrogen and C₁-C₃ aliphatic. In some embodiments, R^{1b}, R^{2b}, R^{3b}, R^{4b}, R^{5b}, R^{6b}, R^{7b}, and R^{8b} are, independently at each occurrence in the polymer chain, selected from the group consisting of hydrogen and methyl. In some embodiments, R^{1b}, R^{2b}, R^{3b}, R^{4b}, R^{5b}, R^{6b}, R^{7b}, and R^{8b} are hydrogen.

In some embodiments, R^{9b} and R^{10b} are, independently at each occurrence in the polymer chain, selected from the group consisting of hydrogen and optionally substituted C₁-C₃ aliphatic. In some embodiments, R^{9b} and R^{10b} are, independently at each occurrence in the polymer chain, selected from the group consisting of hydrogen and C₁-C₆ aliphatic. In some embodiments, R^{9b} and R^{10b} are, independently at each occurrence in the polymer chain, selected from the group consisting of hydrogen and C₁-C₃ aliphatic. In some embodiments, R^{9b} and R^{10b} are, independently at each occurrence in the polymer chain, selected from the group consisting of hydrogen and methyl. In some embodiments, R^{9b} and R^{10b} are hydrogen.

In some embodiments, each t is, at each occurrence within a polymer chain, an integer from 1 and 6. In some embodiments, each t is, at each occurrence within a polymer chain, an integer from 1 and 4. In some embodiments, each t is, at each occurrence within a polymer chain, an integer from 1 and 3. In some embodiments, each t is, at each occurrence within a polymer chain, an integer from 1 and 2. In some embodiments, each t is, at each occurrence within a polymer chain, an integer from 3 and 6. In some embodiments, each t is, at each occurrence within a polymer chain, an integer from 4 and 6. In some embodiments, each t is, at each occurrence within a polymer chain, an integer from 4 and 5.

In some embodiments, each t is, at each occurrence within a polymer chain, is 1. In some embodiments, each t is, at each occurrence within a polymer chain, is 2. In some embodiments, each t is, at each occurrence within a polymer chain, is 3. In some embodiments, each t is, at each occurrence within a polymer chain, is 4. In some embodiments, each t is, at each occurrence within a polymer chain, is 5. In some embodiments, each t is, at each occurrence within a polymer chain, is 6. In some embodiments, each t is, at each occurrence within a polymer chain, is 7. In some embodiments, each t is, at each occurrence within a polymer chain, is 8.

In some embodiments, a polyester polyol comprises a repeating unit of formula:

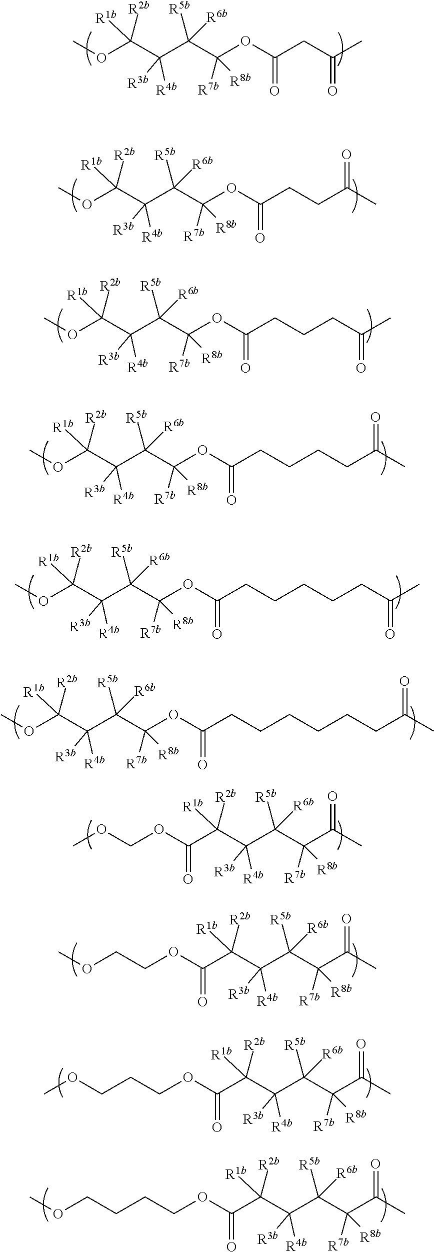

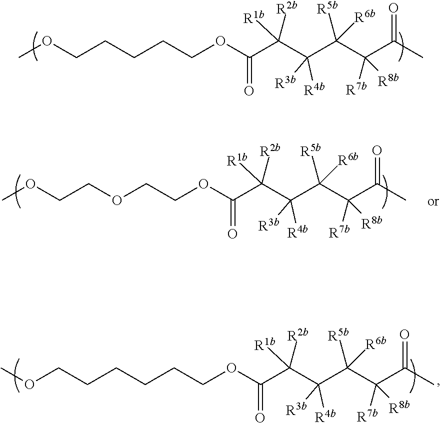

wherein R^{1b}, R^{2b}, R^{3b}, R^{4b}, R^{5b}, R^{6b}, R^{7b}, and R^{8b}, are as described above and herein.

In some embodiments, a polyester polyol comprises a repeating unit of formula:

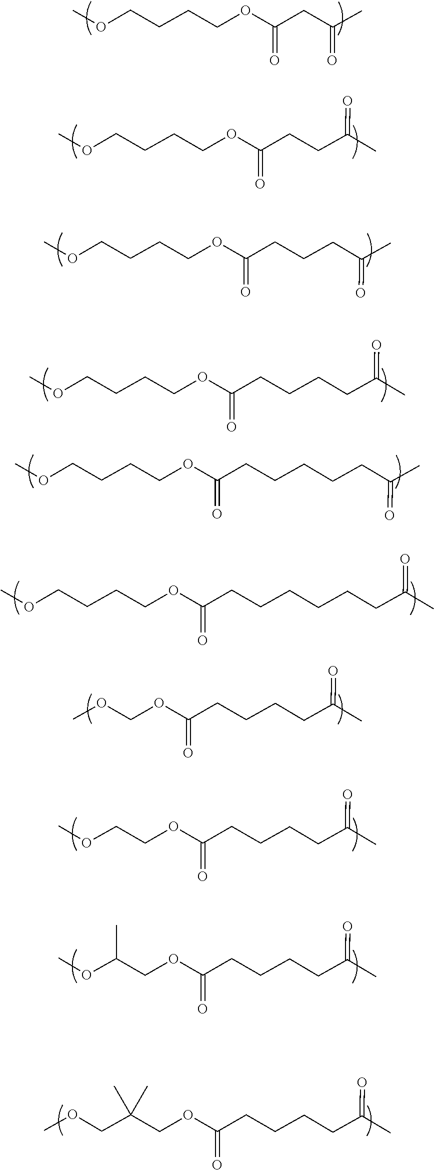

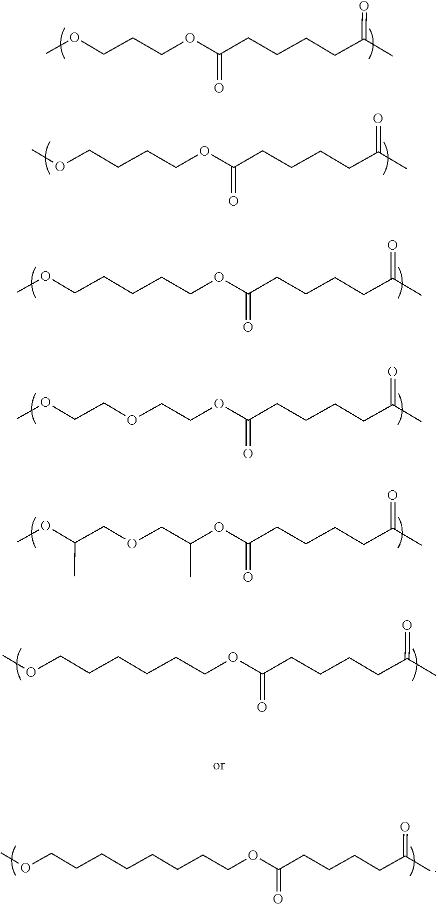

In some embodiments, a polyester polyol comprises a repeating unit of formula:

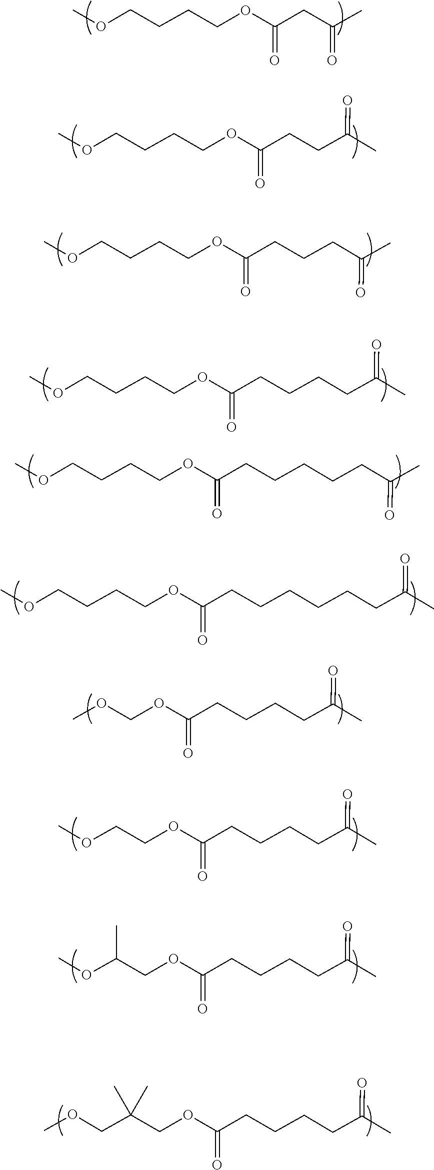

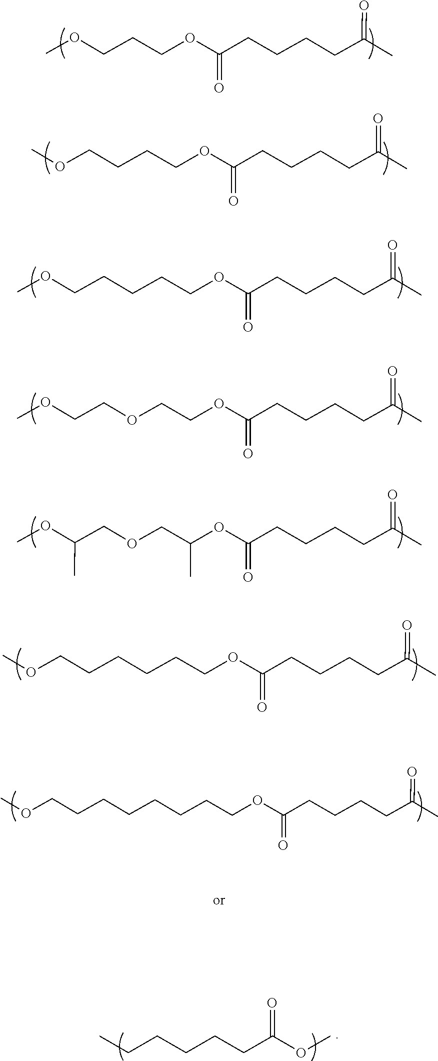

Polyester polyols that may be present include those which can be obtained by known methods, for example, polyester polyols can be based on the reaction of adipic acid or succinic acid (or their corresponding reactive derivatives or anhydrides) with various diols including, butanediol (BDO).

In some embodiments, a polyester polyol is a copolymer of a diol and a diacid, wherein:
the diol is selected from the group consisting of 1,3 propanediol, 1,2-ethanediol, 1,4-butanediol (BDO), 1,5-pentanediol, 1,6-hexanediol, dipropylene glycol, propylene glycol, neopentyl glycol, octane diol, dipropylene glycol, and cyclohexanedimethanol; and
the diacid is selected from the group consisting of adipic acid (AA), sebacic acid (SBA), succinic acid (SA), dodecanedioic acid (DDA), isophthalic acid (iPA), azelaic acid (Az), phthalic acid, and terephthalic acid.

In some embodiments, a polyester polyol is a copolymer of a diol comprising two hydroxyl groups separated by four carbons, and a diacid. In some embodiments, a polyester polyol is a copolymer of a diol comprising two hydroxyl groups separated by four carbons, and a diacid selected from the group consisting of adipic acid (AA), sebacic acid (SBA), succinic acid (SA), dodecanedioic acid (DDA), isophthalic acid (iPA), and azelaic acid (Az). In some embodiments, the diol is 1,4-butanediol (BDO). In some embodiments, the diol is 1,3 propanediol. In some embodiments, the diol is 1,2-ethanediol. In some embodiments, the diol is 1,5-pentanediol. In some embodiments, the diol is 1,6-hexanediol. In some embodiments, the diol is diethylene glycol. In some embodiments, the diol is dipropylene glycol. In some embodiments, the diol is propylene glycol. In some embodiments, the diol is neopentyl glycol. In some embodiments, the diol is octane diol. In some embodiments, the diol is cyclohexanedimethanol.

In certain embodiments, a polyester polyol comprises a material based on a diol comprising two hydroxyl groups are separated by four carbons and a diacid (e.g. a polymer based on Adipic acid (AA); Sebacic acid (SBA); Succinic Acid (SA); Dodecanedioic acid (DDA); Isophthalic acid (iPA); Azelaic acid (Az); 1,4-Butanediol (BDO). Examples of these include, but are not limited to:

AA-EG/BDO polyester polyols with molecular weights of 500, 1,000, 2,000 or 3,000 g/mol;
AA-BDO polyester polyols with molecular weights of 500, 1,000, 2,000 or 3,000 g/mol;
AA-BDO/HID polyester polyols with molecular weights of 500, 1,000, 2,000 or 3,000 g/mol;

In certain embodiments, a polyester polyol is an AA-BDO polyester. In some embodiments, polyester polyol is an AA-SBA polyester. In some embodiments, a polyester polyol is a diethylene glycol/adipic acid copolymer (DEG-AA).

In certain embodiments, polyester polyols are characterized in that they have a Mn between about 200 and about 10,000 g/mol. In certain embodiments, such polyester polyols have a Mn between about 200 and about 5,000 g/mol.

In some embodiments, polyester polyols are characterized in that they have an Mn between about 200 g/mol and about 2,500 g/mol. In some embodiments, polyester polyols are characterized in that they have an Mn between about 200 g/mol and about 2,000 g/mol. In some embodiments, polyester polyols are characterized in that they have an Mn between about 200 g/mol and about 1,500 g/mol. In some embodiments, polyester polyols are characterized in that they have an Mn between about 200 g/mol and about 1,000 g/mol. In some embodiments, polyester polyols are characterized in that they have an Mn between about 500 g/mol and about 2,500 g/mol. In some embodiments, polyester polyols are characterized in that they have an Mn between about 1,000 g/mol and about 2,500 g/mol. In some embodiments, polyester polyols are characterized in that they have an Mn between about 1,500 g/mol and about 2,500 g/mol. In some embodiments, polyester polyols are characterized in that they have an Mn between about 2,000 g/mol and about 2,500 g/mol.

In some embodiments, polyester polyols are characterized in that they have an Mn of about 250, 650, 1,000, 1,400, 1,800, or about 2,000.

In some embodiments, polyester polyols are characterized in that they have an OH # between about 5 and about 500. In some embodiments, polyester polyols are characterized in that they have an OH # between about 5 and about 200. In some embodiments, polyester polyols are characterized in that they have an OH # between about 5 and about 150. In some embodiments, polyester polyols are characterized in that they have an OH # between about 5 and about 100. In some embodiments, polyester polyols are characterized in that they have an OH # between about 5 and about 70. In some embodiments, polyester polyols are characterized in that they have an OH # between about 5 and about 25. In some embodiments, polyester polyols are characterized in that they have an OH # between about 100 and about 500. In some embodiments, polyester polyols are characterized in that they have an OH # between about 250 and about 500.

In some embodiments, a polyester polyol is a commercially available polyester polyol. Commercially available polyester polyols include, for example, polyester polyols produced by DSM (e.g., NeoRez), Stepan (e.g., Stepanpol), or Evonik (e.g., Dynacoll). Commercially available polyester polyols also include, for example, polyester polyols produced by Polyurethane Specialties (e.g., Millester), COIM Group (e.g., Diexter), Covestro (e.g., Desmophen or Baycoll), BASF (e.g., Lupraphen), Huntsman (e.g., Terol), or Tosoh (e.g., Nippolan).

In certain embodiments, a polyester polyol is formed by ring-opening-polymerization of δ-valerolactone or ε-caprolactone (e.g., δ-valerolactone or caprolactone with molecular weights of 500, 1,000, 2,000 or 3,000 g/mol). In some embodiments, a polyester polyol is or comprises polycaprolactone. In some embodiments, a polycaprolactone is commercially available. Commercially available polycaprolactones include, for examples, those produced by Ingevity (e.g., Capa).

E. Isocyanate Reagents

As described above, compositions useful in the present invention may be combined with isocyanate reagents to form polyurethane compositions. The purpose of these isocyanate reagents is to react with the reactive end groups on the polyols to form isocyanate-terminated prepolymers or higher molecular weight structures through chain extension and/or cross-linking.

The art of polyurethane synthesis is well advanced and a very large number of isocyanates and related polyurethane precursors are known in the art. While this section of the specification describes isocyanates suitable for use in certain embodiments of the present invention, it is to be understood that it is within the capabilities of one skilled in the art of polyurethane formulation to use alternative isocyanates along with the teachings of this disclosure to formulate additional compositions of matter within the scope of the present invention. Descriptions of suitable isocyanate compounds and related methods can be found in: Chemistry and Technology of Polyols for Polyurethanes Ionescu, Mihail 2005 (ISBN 978-1-84735-035-0), and H. Ulrich, “Urethane Polymers,” Kirk-Othmer Encyclopedia of Chemical Technology, 1997 the entirety of each of which is incorporated herein by reference.

In certain embodiments, isocyanate reagents comprise two or more isocyanate groups per molecule. In certain embodiments, isocyanate reagents are diisocyanates. In other embodiments, isocyanate reagents are higher polyisocyanates such as triisocyanates, tetraisocyanates, isocyanate polymers or oligomers, and the like, which are typically a minority component of a mix of predominantly diisocyanates. In certain embodiments, isocyanate reagents are aliphatic polyisocyanates or derivatives or oligomers of aliphatic polyisocyanates. In other embodiments, isocyanates are aromatic polyisocyanates or derivatives or oligomers of aromatic polyisocyanates. In certain embodiments, compositions may comprise mixtures of any two or more of the above types of isocyanates.

In certain embodiments, isocyanate reagents usable for the production of the polyurethane adhesive include aliphatic, cycloaliphatic and aromatic diisocyanate compounds.

Suitable aliphatic and cycloaliphatic isocyanate compounds include, for example, 1,3-trimethylene diisocyanate, 1,4-tetramethylene diisocyanate, 1,6-hexamethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate, 1,4-cyclohexane diisocyanate, isophorone diisocyanate (IPDI), 4,4,′-dicyclohexylmethane diisocyanate, 2,2′-diethylether diisocyanate, hydrogenated xylylene diisocyanate, and hexamethylene diisocyanate-biuret.

The aromatic isocyanate compounds include, for example, p-phenylene diisocyanate, tolylene diisocyanate, xylylene diisocyanate, 4,4′-diphenyl diisocyanate, 2,4′-diphenylmethane diisocyanate, 1,5-naphthalene diisocyanate, 4,4′-diphenylmethane diisocyanate (MDI), 3,3′-methyleneditolylene-4,4′-diisocyanate, tolylenediisocyanate-trimethylolpropane adduct, triphenylmethane triisocyanate, 4,4′-diphenylether diisocyanate, tetrachlorophenylene diisocyanate, 3,3′-dichloro-4,4′-diphenylmethane diisocyanate, and triisocyanate phenylthiophosphate.

In certain embodiments, an isocyanate compound employed comprises one or more of: 4,4′-diphenylmethane diisocyanate, 1,6-hexamethylene hexamethylene diisocyanate and isophorone diisocyanate (IPDI). In certain embodiments, an isocyanate compound employed is 4,4′-diphenylmethane diisocyanate. In certain embodiments, an isocyanate compound employed is IPDI. The above-mentioned diisocyanate compounds may be employed alone or in mixtures of two or more thereof.

In certain embodiments, an isocyanate reagent is selected from the group consisting of: 1,6-hexamethylaminediisocyanate (HDI), isophorone diisocyanate (IPDI), 4,4′ methylene-bis(cyclohexyl isocyanate) (HM₁₂DI), 2,4-toluene diisocyanate (TDI), 2,6-toluene diisocyanate (TDI), diphenylmethane-4,4′-diisocyanate (MDI), diphenylmethane-2,4′-diisocyanate (MDI), xylylene diisocyanate (XDI), 1,3-Bis(isocyanatomethyl)cyclohexane (H6-XDI), 2,2,4-trimethylhexamethylene diisocyanate, 2,4,4-trimethylhexamethylene diisocyanate (TMDI), m-tetramethylxylylene diisocyanate (TMXDI), p-tetramethylxylylene diisocyanate (TMXDI), isocyanatomethyl-1,8-ictane diisocyanate (TIN), triphenylmethane-4,4′,4″triisocyanate, Tris(p-isocyanatomethyl)thiosulfate, 1,3-Bis(isocyanatomethyl)benzene, 1,4-tetramethylene diisocyanate, trimethylhexane diisocyanate, 1,6-hexamethylene diisocyanate, 1,4-cyclohexyl diisocyanate, lysine diisocyanate, HDI allophanate trimer, HDI uretdione and HDI-trimer and mixtures of any two or more of these.

In certain embodiments, an isocyanate reagent is selected from the group consisting of 4,4′-diphenylmethane diisocyanate, 1,6-hexamethylene diisocyanate and isophorone diisocyanate. In certain embodiments, an isocyanate reagent is 4,4′-diphenylmethane diisocyanate. certain embodiments, an isocyanate reagent is 1,6-hexamethylene diisocyanate. In certain embodiments, an isocyanate reagent is isophorone diisocyanate (IPDI).

Isocyanates suitable for certain embodiments of the present invention are available commercially under various trade names. Examples of suitable commercially available isocyanates include materials sold under trade names: Desmodur® (Bayer Material Science), Tolonate® (Perstorp), Takenate® (Takeda), Vestanat® (Evonik), Desmotherm® (Bayer Material Science), Bayhydur® (Bayer Material Science), Mondur (Bayer Material Science), Suprasec (Huntsman Inc.), Lupranate® (BASF), Trixene (Baxenden), Hartben® (Benasedo), Ucopol® (Sapici), and Basonat® (BASF). Each of these trade names encompasses a variety of isocyanate materials available in various grades and formulations. The selection of suitable commercially available isocyanate materials as reagents to produce polyurethane compositions for a particular application is within the capability of one skilled in the art of polyurethane coating technology using the teachings and disclosure of this patent application along with the information provided in the product data sheets supplied by the above-mentioned suppliers.

Additional isocyanates suitable for certain embodiments of the present invention are sold under the trade name Lupranate® (BASF). In certain embodiments, isocyanates are selected from the group consisting of the materials shown in Table 1, and typically from the subset of isocyanates from this list with the functionality between 1.95 and 2.1.

TABLE 1

| | | % | Nominal |
|---|---|---|---|
| Products | Description | NCO | Funct. |
| Lupranate ® M | 4,4′ MDI | 33.5 | 2 |
| Lupranate ® MS | 4,4′ MDI | 33.5 | 2 |
| Lupranate ® MI | 2,4′ and 4,4′ MDI Blend | 33.5 | 2 |
| Lupranate ® LP30 | Liquid Pure 4,4′ MDI | 33.1 | 2 |
| Lupranate ® 227 | Monomeric/Modified MDI Blend | 32.1 | 2 |

Carbodiimide Modified MDI

| | | | |
|---|---|---|---|
| Lupranate ® 5143 | Carbodiimide Modified 4,4′ MDI | 29.2 | 2.2 |
| Lupranate ® MM103 | Carbodiimide Modified 4,4′ MDI | 29.5 | 2.2 |
| Lupranate ® 219 | Carbodiimide Modified 4,4′ MDI | 29.2 | 2.2 |
| Lupranate ® 81 | Carbodiimide Modified MDI | 29.5 | 2.2 |
| Lupranate ® 218 | Carbodiimide Modified MDI | 29.5 | 2.2 |

Polymeric MDI (PMDI)

| | | | |
|---|---|---|---|
| Lupranate ® 241 | Low Functionality Polymeric | 32.6 | 2.3 |
| Lupranate ® 230 | Low Viscosity Polymeric | 32.5 | 2.3 |
| Lupranate ® 245 | Low Viscosity Polymeric | 32.3 | 2.3 |
| Lupranate ® TF2115 | Mid Functionality Polymeric | 32.3 | 2.4 |
| Lupranate ® 78 | Mid Functionality Polymeric | 32 | 2.3 |
| Lupranate ® 234 | Low Functionality Polymeric | 32 | 2.4 |
| Lupranate ® 273 | Low Viscosity Polymeric | 32 | 2.5 |
| Lupranate ® 266 | Low Viscosity Polymeric | 32 | 2.5 |
| Lupranate ® 261 | Low Viscosity Polymeric | 32 | 2.5 |
| Lupranate ® 255 | Low Viscosity Polymeric | 31.9 | 2.5 |
| Lupranate ® 268 | Low Viscosity Polymeric | 30.6 | 2.4 |

Select MDI Prepolymers

| | | | |
|---|---|---|---|
| Lupranate ® 5010 | Higher Functional Prepolymer | 28.6 | 2.3 |
| Lupranate ® 223 | Low Visc. Derivative of Pure MDI | 27.5 | 2.2 |
| Lupranate ® 5040 | Mid Functional, Low Viscosity | 26.3 | 2.1 |
| Lupranate ® 5110 | Polymeric MDI Prepolymer | 25.4 | 2.3 |
| Lupranate ® MP102 | 4,4′ MDI Prepolymer | 23 | 2 |
| Lupranate ® 5090 | Special 4,4′ MDI Prepolymer | 23 | 2.1 |
| Lupranate ® 5050 | Mid Functional, Mid NCO Prepol | 21.5 | 2.1 |
| Lupranate ® 5030 | Special MDI Prepolymer | 18.9 | NA |
| Lupranate ® 5080 | 2,4′-MDI Enhanced Prepolymer | 15.9 | 2 |
| Lupranate ® 5060 | Low Funct, Higher MW Prepol | 15.5 | 2 |
| Lupranate ® 279 | Low Funct, Special Prepolymer | 14 | 2 |
| Lupranate ® 5070 | Special MDI Prepolymer | 13 | 2 |
| Lupranate ® 5020 | Low Functionality, Low NCO | 9.5 | 2 |

Toluene Diisocyanate (TDI)

| | | | |
|---|---|---|---|
| Lupranate ® T80- | 80/20: 2,4/2,6 TDI | 48.3 | 2 |
| Lupranate ® T80- | High Acidity TDI | 48.3 | 2 |
| Lupranate ® 8020 | 80/20: TDI/Polymeric MDI | 44.6 | 2.1 |

Other isocyanates suitable for certain embodiments of the present invention are sold under the trade name Desmodur® available from Bayer Material Science. In certain embodiments, isocyanates are selected from the group consisting of the materials shown in Table 2, and typically from the subset of isocyanates with functionality between 1.95 and 2.1.

TABLE 2

| Trade Name | Description |
|---|---|
| Desmodur ® 2460 M | Monomeric diphenylmethane diisocyanate with high 2,4′- |
| | isomer content |
| Desmodur ® 44 M | A monomeric diphenylmethane-4,4′-diisocyanate (MDI). |
| Desmodur ® 44 MC | Desmodur 44 MC Flakes is a monomeric diphenylmethane- |
| | 4,4′-diisocyanate (MDI). |
| Desmodur ® BL 1100/1 | Blocked aromatic polyisocyanate based on TDI |
| Desmodur ® BL 1265 MPA/X | Blocked aromatic polyisocyanate based on TDI |
| Desmodur ® BL 3175 SN | Blocked, aliphatic polyisocyanate based on HDI |
| Desmodur ® BL 3272 MPA | Blocked aliphatic polyisocyanate based on HDI |
| Desmodur ® BL 3370 MPA | Blocked aliphatic polyisocyanate based on HDI |
| Desmodur ® BL 3475 BA/SN | Aliphatic crosslinking stoving urethane resin based on HDI/IPDI |
| Desmodur ® BL 3575/1 MPA/SN | Blocked aliphatic polyisocyanate based on HDI |
| Desmodur ® BL 4265 SN | Blocked, aliphatic polyisocyanate based on IPDI |
| Desmodur ® BL 5375 | Blocked aliphatic polyisocyanate based on H 12 MDI |
| Desmodur ® CD-L | Desmodur CD-L is a modified isocyanate based on |
| | diphenylmethane-4,4′-diisocyanate. |
| Desmodur ® CD-S | Desmodur CD-S is a modified isocyanate based on |
| | diphenylmethane-4,4′-diisocyanate. |
| Desmodur ® D XP 2725 | Hydrophilically modified polyisocyanate |
| Desmodur ® DA-L | Hydrophilic aliphatic polyisocyanate based on |
| | hexamethylene diisocyanate |
| Desmodur ® DN | Aliphatic polyisocyanate of low volatility |
| Desmodur ® E 1160 | Aromatic polyisocyanate prepolymer based on toluene |
| | diisocyanate |
| Desmodur ® E 1361 BA | Aromatic polyisocyanate prepolymer based on toluylene |
| | diisocyanate |
| Desmodur ® E 1361 MPA/X | Aromatic polyisocyanate prepolymer based on toluene |
| | diisocyanate |
| Desmodur ® E 14 | Aromatic polyisocyanate prepolymer based on toluene |
| | diisocyanate |
| Desmodur ® E 15 | Aromatic polyisocyanate prepolymer based on toluene |
| | diisocyanate. |
| Desmodur ® E 1660 | Aromatic polyisocyanate prepolymer based on toluene |
| | diisocyanate. |
| Desmodur ® E 1750 PR | Polyisocyanate prepolymer based on toluene diisocyanate |
| Desmodur ® E 20100 | Modified polyisocyanate prepolymer based on |
| | diphenylmethane diisocyanate. |
| Desmodur ® E 21 | Aromatic polyisocyanate prepolymer based on |
| | diphenylmethane diisocyanate (MDI). |
| Desmodur ® E 2190 X | Aromatic polyisocyanate prepolymer based on |
| | diphenylmethane diisocyanate (MDI) |
| Desmodur ® E 22 | Aromatic polyisocyanate prepolymer based on |
| | diphenylmethane diisocyanate. |
| Desmodur ® E 2200/76 | Desmodur E 2200/76 is a prepolymer based on (MDI) with |
| | isomers. |
| Desmodur ® E 23 | Aromatic polyisocyanate prepolymer based on |
| | diphenylmethane diisocyanate (MDI). |
| Desmodur ® E 29 | Polyisocyanate prepolymer based on diphenylmethane |
| | diisocyanate. |
| Desmodur ® E 305 | Desmodur E 305 is a largely linear aliphatic NCO prepolymer |
| | based on hexamethylene diisocyanate. |
| Desmodur ® E 3265 MPA/SN | Aliphatic polyisocyanate prepolymer based on |
| | hexamethylene diisocyanate (HDI) |
| Desmodur ® E 3370 | Aliphatic polyisocyanate prepolymer based on |
| | hexamethylene diisocyanate |
| Desmodur ® E XP 2605 | Polyisocyanate prepolymer based on toluene diisocyanate |
| | and diphenylmethan diisocyanate |
| Desmodur ® E XP 2605 | Polyisocyanate prepolymer based on toluene diisocyanate |
| | and diphenylmethan diisocyanate |
| Desmodur ® E XP 2715 | Aromatic polyisocyanate prepolymer based on 2,4′- |
| | diphenylmethane diisocyanate (2,4′-MDI) and a hexanediol |
| Desmodur ® E XP 2723 | Aromatic polyisocyanate prepolymer based on |
| | diphenylmethane diisocyanate (MDI). |
| Desmodur ® E XP 2726 | Aromatic polyisocyanate prepolymer based on 2,4′- |
| | diphenylmethane diisocyanate (2,4′-MDI) |
| Desmodur ® E XP 2727 | Aromatic polyisocyanate prepolymer based on |
| | diphenylmethane diisocyanate. |
| Desmodur ® E XP 2762 | Aromatic polyisocyanate prepolymer based on |
| | diphenylmethane diisocyanate (MDI). |
| Desmodur ® H | Monomeric aliphatic diisocyanate |
| Desmodur ® HL | Aromatic/aliphatic polyisocyanate based on toluylene |
| | diisocyanate/hexamethylene diisocyanate |
| Desmodur ® I | Monomeric cycloaliphatic diisocyanate. |
| Desmodur ® IL 1351 | Aromatic polyisocyanate based on toluene diisocyanate |
| Desmodur ® IL 1451 | Aromatic polyisocyanate based on toluene diisocyanate |
| Desmodur ® IL BA | Aromatic polyisocyanate based on toluene diisocyanate |
| Desmodur ® IL EA | Aromatic polyisocyante resin based on toluylene |
| | diisocyanate |
| Desmodur ® L 1470 | Aromatic polyisocyanate based on toluene diisocyanate |
| Desmodur ® L 67 BA | Aromatic polyisocyanate based on tolulene diisocyanate |
| Desmodur ® L 67 MPA/X | Aromatic polyisocyanate based on tolulene diisocyanate |
| Desmodur ® L 75 | Aromatic polyisocyanate based on tolulene diisocyanate |
| Desmodur ® LD | Low-functionality isocyanate based on hexamethylene |
| | diisocyanate (HDI) |
| Desmodur ® LS 2424 | Monomeric diphenylmethane diisocyanate with high 2,4′- |
| | isomer content |
| Desmodur ® MT | Polyisocyanate prepolymer based on diphenylmethane |
| | diisocyanate |
| Desmodur ® N 100 | Aliphatic polyisocyanate (HDI biuret) |
| Desmodur ® N 3200 | Aliphatic polyisocyanate (low-viscosity HDI biuret) |
| Desmodur ® N 3300 | Aliphatic polyisocyanate (HDI trimer) |
| Desmodur ® N 3368 BA/SN | Aliphatic polyisocyanate (HDI trimer) |
| Desmodur ® N 3368 SN | Aliphatic polyisocyanate (HDI trimer) |
| Desmodur ® N 3386 BA/SN | Aliphatic polyisocyanate (HDI trimer) |
| Desmodur ® N 3390 BA | Aliphatic polyisocyanate (HDI trimer) |
| Desmodur ® N 3390 BA/SN | Aliphatic polyisocyanate (HDI trimer) |
| Desmodur ® N 3400 | Aliphatic polyisocyanate (HDI uretdione) |
| Desmodur ® N 3600 | Aliphatic polyisocyanate (low-viscosity HDI trimer) |
| Desmodur ® N 3790 BA | Aliphatic polyisocyanate (high functional HDI trimer) |
| Desmodur ® N 3800 | Aliphatic polyisocyanate (flexibilizing HDI trimer) |
| Desmodur ® N 3900 | Low-viscosity, aliphatic polyisocyanate resin based on |
| | hexamethylene diisocyanate |
| Desmodur ® N 50 BA/MPA | Aliphatic polyisocyanate (HDI biuret) |
| Desmodur ® N 75 BA | Aliphatic polyisocyanate (HDI biuret) |
| Desmodur ® N 75 MPA | Aliphatic polyisocyanate (HDI biuret) |
| Desmodur ® N 75 MPA/X | Aliphatic polyisocyanate (HDI biuret) |
| Desmodur ® NZ 1 | Aliphatic polyisocyanate |
| Desmodur ® PC-N | Desmodur PC-N is a modified diphenyl-methane-4,4′- |
| | diisocyanate (MDI). |
| Desmodur ® PF | Desmodur PF is a modified diphenyl-methane-4,4′- |
| | diisocyanate (MDI). |
| Desmodur ® PL 340, 60% BA/SN | Blocked aliphatic polyisocyanate based on IPDI |
| Desmodur ® PL 350 | Blocked aliphatic polyisocyanate based on HDI |
| Desmodur ® RC | Solution of a polyisocyanurate of toluene diisocyanate (TDI) |
| | in ethyl acetate. |
| Desmodur ® RE | Solution of triphenylmethane-4,4′,4″-triisocyanate in ethyl |
| | acetate |
| Desmodur ® RFE | Solution of tris(p-isocyanatophenyl) thiophosphate in ethyl |
| | acetate |
| Desmodur ® RN | Solution of a polyisocyanurate with aliphatic and aromatic |
| | NCO groups in ethyl acetate. |
| Desmodur ® T 100 | Pure 2,4′-toluene diisocyanate (TDI) |
| Desmodur ® T 65 N | 2,4- and 2,6-toluene diisocyanate (TDI) in the ratio 67:33 |
| Desmodur ® T 80 | 2,4- and 2,6-toluene diisocyanate (TDI) in the ratio 80:20 |
| Desmodur ® T 80 P | 2,4- and 2,6-toluene diisocyanate (TDI) in the ratio 80:20 |
| | with an increased content of hydrolysable chlorine |
| Desmodur ® VH 20 N | Polyisocyanate based on diphenylmethane diisocyanate |
| Desmodur ® VK | Desmodur VK products re mixtures of diphenylmethane-4,4′- |
| | diisocyanate (MDI) with isomers and higher functional |
| Desmodur ® VKP 79 | Desmodur VKP 79 is a modified diphenylmethane-4,4′- |
| | diisocyanate (MDI) with isomers and homologues. |
| Desmodur ® VKS 10 | Desmodur VKS 10 is a mixture of diphenylmethane-4,4′- |
| | diisocyanate (MDI) with isomers and higher functional |
| Desmodur ® VKS 20 | Desmodur VKS 20 is a mixture of diphenylmethane-4,4′- |
| | diisocyanate (MDI) with isomers and higher functional |
| Desmodur ® VKS 20 F | Desmodur VKS 20 F is a mixture of diphenylmethane-4,4′- |
| | diisocyanate (MDI) with isomers and higher functional |
| Desmodur ® VKS 70 | Desmodur VKS 70 is a mixture of diphenylmethane-4,4′- |
| | diisocyanate (MDI) with isomers and homologues. |
| Desmodur ® VL | Aromatic polyisocyanate based on diphenylmethane |
| | diisocyanate |
| Desmodur ® VP LS 2078/2 | Blocked aliphatic polyisocyanate based on IPDI |
| Desmodur ® VP LS 2086 | Aromatic polyisocyanate prepolymer based on |
| | diphenylmethane diisocyanate |
| Desmodur ® VP LS 2257 | Blocked aliphatic polyisocyanate based on HDI |
| Desmodur ® VP LS 2371 | Aliphatic polyisocyanate prepolymer based on isophorone |
| | diisocyanate. |
| Desmodur ® VP LS 2397 | Desmodur VP LS 2397 is a linear prepolymer based on |
| | polypropylene ether glycol and diphenylmethane diisocyanate |
| Desmodur ® W | Monomeric cycloaliphatic diisocyanate |
| Desmodur ® W/1 | Monomeric cycloaliphatic diisocyanate |
| Desmodur ® XP 2404 | Desmodur XP 2404 is a mixture of monomeric |
| | polyisocyanates |
| Desmodur ® XP 2406 | Aliphatic polyisocyanate prepolymer based on isophorone |
| | diisocyanate |
| Desmodur ® XP 2489 | Aliphatic polyisocyanate |
| Desmodur ® XP 2505 | Desmodur XP 2505 is a prepolymer containing ether groups |
| | based on diphenylmethane-4,4′-diisocyanates (MDI) with |
| Desmodur ® XP 2551 | Aromatic polyisocyanate based on diphenylmethane |
| | diisocyanate |
| Desmodur ® XP 2565 | Low-viscosity, aliphatic polyisocyanate resin based on |
| | isophorone diisocyanate. |
| Desmodur ® XP 2580 | Aliphatic polyisocyanate based on hexamethylene |
| | diisocyanate |
| Desmodur ® XP 2599 | Aliphatic prepolymer containing ether groups and based on |
| | hexamethylene-1,6-diisocyanate (HDI) |
| Desmodur ® XP 2617 | Desmodur XP 2617 is a largely linear NCO prepolymer based |
| | on hexamethylene diisocyanate. |
| Desmodur ® XP 2665 | Aromatic polyisocyanate prepolymer based on |
| | diphenylmethane diisocyanate (MDI). |
| Desmodur ® XP 2675 | Aliphatic polyisocyanate (highly functional HDI trimer) |
| Desmodur ® XP 2679 | Aliphatic polyisocyanate (HDI allophanate trimer) |
| Desmodur ® XP 2714 | Silane-functional aliphatic polyisocyanate based on |
| | hexamethylene diisocyanate |
| Desmodur ® XP 2730 | Low-viscosity, aliphatic polyisocyanate (HDI uretdione) |
| Desmodur ® XP 2731 | Aliphatic polyisocyanate (HDI allophanate trimer) |
| Desmodur ® XP 2742 | Modified aliphatic Polyisocyanate (HDI-Trimer), contains |
| | SiO2 - nanoparticles |

Additional isocyanates suitable for certain embodiments of the present invention are sold under the trade name Tolonate® (Perstorp). In certain embodiments, isocyanates are selected from the group consisting of the materials shown in Table 3, and typically from the subset of this list with functionality in the range of 1.95 and 2.1

TABLE 3

| | |
|---|---|
| Tolonate ™ D2 | a blocked aliphatic polyisocyanate, supplied at |
| | 75% solids in aromatic solvent |
| Tolonate ™ HDB | a viscous solvent-free aliphatic polyisocyanate |
| Tolonate ™ HDB-LV | a solvent free low viscosity aliphatic |
| | polyisocyanate |
| Tolonate ™ HDB 75 B | an aliphatic polyisocyanate, supplied at 75% |
| | solids in methoxy propyl acetate |
| Tolonate ™ HDB 75 BX | an aliphatic polyisocyanate, supplied at 75% |
| | solids |
| Tolonate ™ HDT | a medium viscosity, solvent-free aliphatic |
| | polyisocyanate |
| Tolonate ™ HDT-LV | is a solvent free low viscosity aliphatic |
| | polyisocyanate |
| Tolonate ™ HDT-LV2 | a solvent free, very low viscosity aliphatic |
| | polyisocyanate |
| Tolonate ™ HDT 90 | an aliphatic polyisocyanate, based on HDI- |
| | trimer (isocyanurate), supplied at 90% solids |
| Tolonate ™ HDT 90 B | an aliphatic polyisocyanate, based on HDI- |
| | trimer (isocyanurate), supplied at 90% solids |
| Tolonate ™ IDT 70 B | an aliphatic polyisocyanate, based on HDI- |
| | trimer (isocyanurate), supplied at 70% solids |
| Tolonate ™ IDT 70 S | an aliphatic polyisocyanate, based on HDI- |
| | trimer (isocyanurate), supplied at 70% solids |
| Tolonate ™ X FD 90 B | a high functionality, fast drying aliphatic |
| | polyisocyanate based on HDI-trimer, supplied |
| | at 90% solids |

Other isocyanates suitable for certain embodiments of the present invention are sold under the trade name Mondur® available from Bayer Material Science. In certain embodiments, isocyanates are selected from the group consisting of the materials shown in Table 4, and typically from the subset of isocyanates with functionality between 1.95 and 2.1.

TABLE 4

| Trade Name | Description |
|---|---|
| MONDUR ® 445 | TDI/MDI blend polyisocyanate; blend of toluene diisocyanate and polymeric |
| | diphenylmethane diisocyanate; NCO weight 44.5-45.2% |
| MONDUR ® 448 | modified polymeric diphenylmethane diisocyanate (pMDI) prepolymer; NCO weight |
| | 27.7%; viscosity 140 mPa · s @ 25° C.; equivalent weight 152; functionality 2.2 |
| MONDUR ® 489 | modified polymeric diphenylmethane diisocyanate (pMDI); NCO weight 31.5%; viscosity |
| | 700 mPa · s @ 25° C.; equivalent weight 133; functionality 3.0 |
| MONDUR ® 501 | modified monomeric diphenylmethane diisocyanate (mMDI); isocyanate-terminated |
| | polyester prepolymer; NCO weight 19.0%; viscosity 1,100 mPa · s @ 25° C.; equivalent |
| | weight 221; functionality 2 |
| MONDUR ® 541 | polymeric diphenylmethane diisocyanate (pMDI); binder for composite wood products |
| | and as a raw material in adhesive formulations; NCO weight 31.5%; viscosity 200 mPa · s @ |
| | 25° C. |
| MONDUR ® 582 | polymeric diphenylmethane diisocyanate (pMDI); binder for composite wood products |
| | and as a raw material in adhesive formulations; NCO weight 31.0%; viscosity 200 mPa · s @ |
| | 25° C. |
| MONDUR ® 541-Light | polymeric diphenylmethane diisocyanate (pMDI); NCO weight 32.0%; viscosity 70 mPa · s @ |
| | 25° C.; equivalent weight 131; functionality 2.5 |
| MONDUR ® 841 | modified polymeric MDI prepolymer; NCO, Wt 30.5%; Acidity, Wt 0.02%; Amine |
| | Equivalent 132; Viscosity at 25° C., mPa · s 350; Specific gravity at 25° C. 1.24; Flash Point, |
| | PMCC, ° F. >200 |
| MONDUR ® 1437 | modified diphenylmethane diisocyanate (mMDI); isocyanate-terminated polyether |
| | prepolymer; NCO weight 10.0%; viscosity 2,500 mPa · s @ 25° C.; equivalent weight 420; |
| | functionality 2 |
| MONDUR ® 1453 | modified diphenylmethane diisocyanate (mMDI); isocyanate-terminated polyether |
| | prepolymer based on polypropylene ether glycol (PPG); NCO weight 16.5%; viscosity 600 |
| | mPa · s @ 25° C.; equivalent weight 254; functionality 2 |
| MONDUR ® 1515 | modified polymeric diphenylmethane diisocyanate (pMDI) prepolymer; used in the |
| | production of rigid polyurethane foams, especially for the appliance industry; NCO weight |
| | 30.5%; viscosity 350 mPa · s @ 25° C. |
| MONDUR ® 1522 | modified monomeric 4,4-diphenylmethane diisocyanate (mMDI); NCO weight 29.5%; |
| | viscosity 50 mPa · s @ 25° C.; equivalent weight 143; functionality 2.2 |
| MONDUR ® MA-2300 | modified monomeric MDI, allophanate-modified 4,4′-diphenylmethane diisocyanate |
| | (mMDI); NCO weight 23.0%; viscosity 450 mPa · s @ 25° C.; equivalent weight 183; |
| | functionality 2.0 |
| MONDUR ® MA 2600 | modified monomeric MDI, allophanate-modified 4,4′-diphenylmethane diisocyanate |
| | (mMDI); NCO weight 26.0%; viscosity 100 mPa · s @ 25° C.; equivalent weight 162; |
| | functionality 2.0 |
| MONDUR ® MA 2601 | aromatic diisocyanate blend, allophanate-modified 4,4′-diphenylmethane diisocyanate |
| | (MDI) blended with polymeric diphenylmethane diisocyanate (pMDI) containing 2,4′- |
| | isomer; NCO weight 29.0%; viscosity 60 mPa · s @ 25° C.; equivalent weight 145; |
| | functionality 2.2 |
| MONDUR ® MA 2603 | MDI prepolymer; isocyanate-terminated (MDI) prepolymer blended with an allophanate- |
| | modified 4,4′-diphenylmethane diisocyanate (MDI); NCO weight 16.0%; viscosity 1,050 |
| | mPa · s @ 25° C.; equivalent weight 263; functionality 2.0 |
| MONDUR ® MA-2902 | modified monomeric MDI, allophanate-modified 4,4′-diphenylmethane diisocyanate |
| | (mMDI); NCO weight 29.0%; viscosity 40 mPa · s @ 25° C.; equivalent weight 145; |
| | functionality 2.0 |
| MONDUR ® MA-2903 | modified monomeric MDI; isocyanate-terminated (MDI) prepolymer; NCO weight 19.0%; |
| | viscosity 400 mPa · s @ 25° C.; equivalent weight 221; functionality 2.0 |
| MONDUR ® MA-2904 | Allophanate-modified MDI polyether prepolymer; NCO weight 12.0%; viscosity 1,800 mPa · |
| | s @ 25° C.; equivalent weight 350; functionality of 2.0 |
| MONDUR ® MB | high-purity grade difunctional isocyanante, diphenylmethane 4,4′-diiscocyanate; used in |
| | production of polyurethane elastomers, adhesives, coatings and intermediate |
| | polyurethane products; appearance colorless solid or liquid; specific gravity @ 50° C. ± 15.5 |
| | 1.19; flash point 202° C. PMCC; viscosity (in molten form) 4.1 mPa · S; bult density 10 lb/gal |
| | (fused) or 9.93 lb/gal (molten); freezing temperature 39° C. |
| MONDUR ® MLQ | monomeric diphenylmethan diisocyanate; used in a foams, cast elastomers, coatings and |
| | ahdesives; appearance light yellow clear liquid, NCO 33.4% wt; 1.19 specific gravity at |
| | 25° C., 196° C. flash point, DIN 51758; 11-15° C. freezing temperature |
| MONDUR ® MQ | high-purity-grade difunctional isocyanate, diphenylmethane 4,4′-diisocyanate (MDI); used |
| | in production of solid polyurethane elastomers, adhesives, coatings and in intermediate |
| | polyurethane products; appearance colorless solid or liquid; specific gravity 1.19 @ 50° C.; |
| | flash point 202° C. PMCC; viscosity 4.1 mPa · S; bulk density 10 lb./gal (fused) or 9.93 lb./gal |
| | (molten); freezing temperature 39° C. |
| MONDUR ® MR | polymeric diphenylmethane diisocyanate (pMDI); NCO weight 31.5%; viscosity 200 mPa · s |
| | @ 25° C.; equivalent weight 133; functionality 2.8 |
| MONDUR ® MR LIGHT | polymeric diphenylmethane diisocyanate (pMDI); NCO weight 31.5%; viscosity 200 mPa · s |
| | @ 25° C.; equivalent weight 133; functionality 2.8 |
| MONDUR ® MR-5 | polymeric diphenylmethane diisocyanate (pMDI); NCO weight 32.5%; viscosity 50 mPa · s @ |
| | 25° C.; equivalent weight 129; functionality 2.4 |
| MONDUR ® MRS | 2,4′ rich polymeric diphenylmethane diisocyanate (pMDI); NCO weight 31.5%; viscosity |
| | 200 mPa · s @ 25° C.; equivalent weight 133; functionality2.6 |
| MONDUR ® MRS 2 | 2,4′ rich polymeric diphenylmethane diisocyanate (pMDI); NCO weight 33.0%; viscosity 25 |
| | mPa · s @ 25° C.; equivalent weight 127; functionality2.2 |
| MONDUR ® MRS-4 | 2,4′ rich polymeric diphenylmethane diisocyanate (pMDI); NCO weight 32.5%; viscosity 40 |
| | mPa · s @ 25° C.; equivalent weight 129; functionality 2.4 |
| MONDUR ® MRS-5 | 2,4′ rich polymeric diphenylmethane diisocyanate (pMDI); NCO weight 32.3%; viscosity 55 |
| | mPa · s @ 25° C.; equivalent weight 130; functionality 2.4 |
| MONDUR ® PC | modified 4,4′ diphenylmethane diisocyanate (mMDI); NCO weight 25.8%; viscosity 145 |
| | mPa · s @ 25° C.; equivalent weight 163; functionality 2.1 |
| MONDUR ® PF | modified 4,4′ diphenylmethane diisocyanate (mMDI) prepolymer; NCO weight 22.9%; |
| | viscosity 650 mPa · s @ 25° C.; equivalent weight 183; functionality 2 |
| MONDUR ® TD-65 | monomeric toluene diisocyanate (TDI); 65/35 mixture of 2,4 and 2.6 TDI; NCO weight 48%; |
| | viscosity 3 mPa · s @ 25° C.; equivalent weight 87.5; functionality 2 |
| MONDUR ® TD-80 | monomeric toluene diisocyanate (TDI); 80/20 mixture of the 2,4 and 2,6 isomer; NCO |
| GRADE A | weight 48%; viscosity 5 mPa · s @ 25° C.; equivalent weight 87.5; functionality 2 |
| MONDUR ® TD-80 | monomeric toluene diisocyanate (TDI); 80/20 mixture of the 2,4 and 2,6 isomer; NCO |
| GRADE A/GRADE B | weight 48%; viscosity 5 mPa · s @ 25° C.; equivalent weight 87.5; functionality 2 |

In certain embodiments, one or more of the above-described isocyanate compositions is provided in a formulation typical of a mixture known in the art of polyurethane adhesives manufacture. Such mixtures may comprise prepolymers formed by the reaction of a molar excess of one or more isocyanates with reactive molecules comprising reactive functional groups such as alcohols, amines, thiols, carboxylates and the like. These mixtures may also comprise solvents, surfactants, stabilizers, and other additives known in the art.

In certain embodiments, the composition of the adhesive might comprise a blocked isocyanate and a polyol. Such a mixture of blocked isocyanate and a polyol do not react under normal conditions, even in the presence of water and the curing of this mixture is triggered by heating.

F. Pre-Polymers

In another aspect, the present invention encompasses prepolymers comprising isocyanate-terminated polyols (“isocyanate-terminated prepolymers”) derived from compositions described herein. In certain embodiments, such isocyanate-terminated prepolymers comprise a plurality of polyol segments linked via urethane bonds formed by reaction with polyisocyanate compounds.

In certain embodiments, a prepolymer of the present invention is the result of a reaction between one or more of the polyols described above with a stoichiometric excess of any one or more of the diisocyanates described herein. The degree of polymerization of these prepolymers (i.e. the average number of polyol segments contained in the prepolymer chains) can be manipulated by controlling the relative amount of isocyanate, as well as the order of reagent addition and the reaction conditions.

In certain embodiments, prepolymers comprise compounds conforming to a formula:

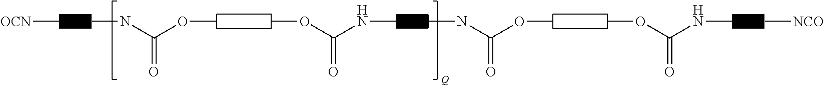

wherein Q is 0 or an integer between 1 and about 50, each open rectangle,

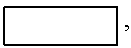

represents a polyol moiety each of which may be the same or different, and where, the black rectangles

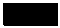

represent the carbon skeleton of the diisocyanate.

In certain embodiments, prepolymers comprise chains conforming to the formula:

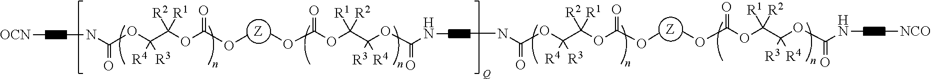

wherein,

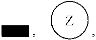

Q, R¹, R², R³, R⁴, and n are as defined above and in the classes and subclasses herein.

In certain embodiments, prepolymers comprise chains conforming to the formula:

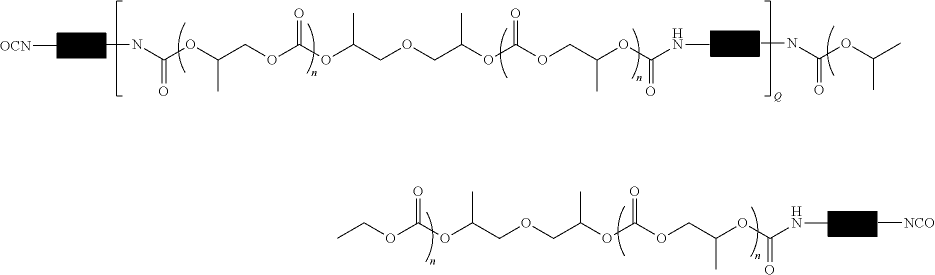

wherein

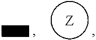

Q, and n are as defined above and in the classes and subclasses herein.

In certain embodiments, prepolymers comprise chains conforming to the formula:

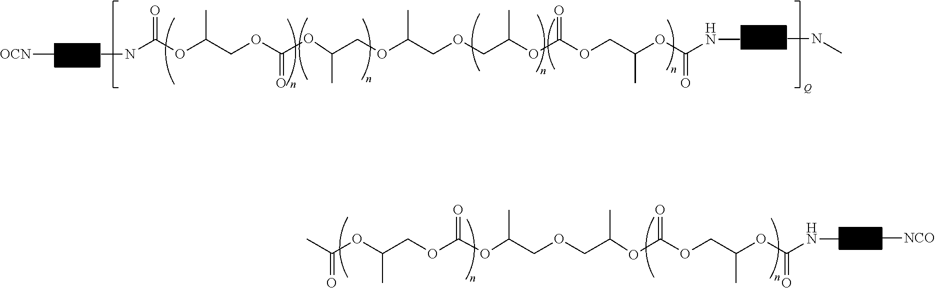

wherein,

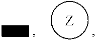

Q, a, and n are as defined above and in the classes and subclasses herein.

In other embodiments, a prepolymer may be formed by reacting a stoichiometric excess of polyol with a limited amount of isocyanate. In such embodiments, the inventive prepolymer has —OH end groups and contains two or more polyol units connected by urethane linkages. In certain embodiments, such prepolymers conform to a structure:

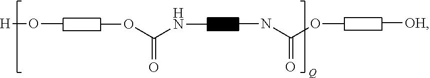

wherein

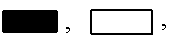

and Q, are as defined above and in the classes and subclasses herein.

In certain embodiments, such prepolymers have structures conforming to:

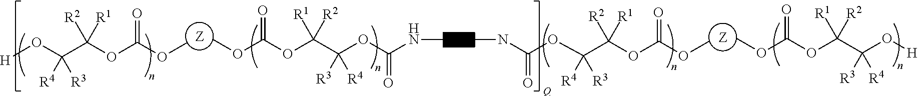

wherein,

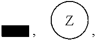

Q, R¹, R², R³, R⁴, and n are as defined above and in the classes and subclasses herein.

It will be appreciated that, e.g., depending on the purpose or application, isocyanate terminated prepolymer compositions may also comprise residual isocyanate reagent. In some embodiments, an isocyanate terminated prepolymer composition comprises up to 50 weight percent residual isocyanate reagent.

Additionally or alternatively, it will be appreciated that, e.g., depending on the purpose or application, isocyanate terminated prepolymer compositions comprise unreacted NCO functionality. Unreacted NCO functionality refers to the weight percent of NCO from residual isocyanate reagent and unreacted NCO groups on the prepolymer in the mass of the isocyanate terminated prepolymer.

In some embodiments, an isocyanate-terminated prepolymer composition comprises between about 0.5% to 20% weight percent residual isocyanate reagent. In some embodiments, an isocyanate-terminated prepolymer composition comprises between about 2% to 18% weight percent residual isocyanate reagent. In some embodiments, an isocyanate-terminated prepolymer composition comprises between about 6% to 16% weight percent residual isocyanate reagent. In some embodiments, an isocyanate-terminated prepolymer composition comprises between about 0.5% to 10% weight percent residual isocyanate reagent. In some embodiments, an isocyanate-terminated prepolymer composition comprises between about 0.5% to 8% weight percent residual isocyanate reagent. In some embodiments, an isocyanate-terminated prepolymer composition comprises between about 0.5% to 6% weight percent residual isocyanate reagent. In some embodiments, an isocyanate-terminated prepolymer composition comprises between about 0.5% to 4% weight percent residual isocyanate reagent.

G. Other Co-Reactants and Additives

In certain embodiments, polyurethane reaction mixtures comprise additional reactive small molecules known as chain extenders such as amines, alcohols, thiols or carboxylic acids that participate in bond-forming reactions with isocyanates. In certain embodiments, additives are selected from the group consisting of: solvents, fillers, clays, blocking agents, stabilizers, thixotropes, plasticizers, compatibilizers, colorants, UV stabilizers, flame retardants, and the like.

1. Chain Extenders

In certain embodiments, the mixtures of the present invention include one or more small molecules reactive toward isocyanates. In certain embodiments, reactive small molecules included in the inventive mixtures comprise low molecular weight organic molecules having one or more functional groups selected from the group consisting of alcohols, amines, carboxylic acids, thiols, and combinations of any two or more of these.

In certain embodiments, the mixtures of the present invention include one or more alcohols. In certain embodiments, the mixtures include polyhydric alcohols.

In certain embodiments, reactive small molecules included in the inventive mixtures comprise dihydric alcohols. In certain embodiments, the dihydric alcohol comprises a C₂₋₄₀ diol. The polyol compound is selected from aliphatic and cycloaliphatic polyol compounds, for example, ethylene glycol, 1,2-ethanediol, 1,2-propanediol, 1,3-propanediol, 1,2-butanediol, 1,2-propylene glycol, 1,3-butanediol, 1,4-butanediol, 1,5-pentanediol, 1,6-hexanediol, 1,8-octanediol, 1,9-nonane diol, 1,10-decane diol, neopentyl glycol, 3-methyl-1,5-pentane diol, 3,3-dimethylolheptane, 1,4-cyclohexane diol, 1,4-cyclohexanedimethanol and 1,4-dihydroxyethyl cyclohexane; and aliphatic and aromatic polyamine compounds, for example, ethylene diamine, 1,2-propylene diamine, 1,6-hexamethylene diamine, isophorone diamine bis(4-aminocyclohexyl)methane, piperazine and meta- or para-xylene diamine; aliphatic, cycloaliphatic and aromatic aminoalcohol compounds, for example, 2-ethanolamine, N-methyldiethanolamine, N-phenyldipropanolamine; hydroxyalkyl sulfamides, for example, hydroxyethyl sulfamide and hydroxyethylaminoethyl sulfamide; urea and water. Among the above-mentioned chain extending compounds, preferably 1,4-butane diol, 2-ethanolamine, and 1,2-propylenediamine are employed. In certain embodiments, the chain extender is selected from the group consisting of: 1,4-cyclohexanediethanol, isosorbide, glycerol monoesters, glycerol monoethers, trimethylolpropane monoesters, trimethylolpropane monoethers, pentaerythritol diesters, pentaerythritol diethers, and alkoxylated derivatives of any of these. The above-mentioned chain-extending compounds may be used alone or in a mixture of two or more thereof.

In certain embodiments, a reactive small molecule included in the inventive mixtures comprises a dihydric alcohol selected from the group consisting of: diethylene glycol, triethylene glycol, tetraethylene glycol, higher poly(ethylene glycol), such as those having number average molecular weights of from 220 to about 2000 g/mol, dipropylene glycol, tripropylene glycol, and higher poly(propylene glycols) such as those having number average molecular weights of from 234 to about 2000 g/mol.

In certain embodiments, a reactive small molecule included in the inventive mixtures comprises an alkoxylated derivative of a compound selected from the group consisting of: a diacid, a diol, or a hydroxy acid. In certain embodiments, the alkoxylated derivatives comprise ethoxylated or propoxylated compounds.

In certain embodiments, a reactive small molecule included in the inventive mixtures comprises a polymeric diol. In certain embodiments, a polymeric diol is selected from the group consisting of polyethers, polyesters, hydroxy-terminated polyolefins, polyether-copolyesters, polyether polycarbonates, polycarbonate-copolyesters, and alkoxylated analogs of any of these. In certain embodiments, the polymeric diol has an average molecular weight less than about 2000 g/mol.

In certain embodiments, a reactive small molecule comprises a hydroxy-carboxylic acid having the general formula (HO)ₓQ(COOH)_{y}, wherein Q is a straight or branched hydrocarbon radical containing 1 to 12 carbon atoms, and x and y are each integers from 1 to 3. In certain embodiments, a coreactant comprises a diol carboxylic acid. In certain embodiments, a coreactant comprises a bis(hydroxylalkyl) alkanoic acid. In certain embodiments, a coreactant comprises a bis(hydroxylmethyl) alkanoic acid. In certain embodiments the diol carboxylic acid is selected from the group consisting of 2,2 bis-(hydroxymethyl)-propanoic acid (dimethylolpropionic acid, DMPA) 2,2-bis(hydroxymethyl) butanoic acid (dimethylolbutanoic acid; DMBA), dihydroxysuccinic acid (tartaric acid), and 4,4′-bis(hydroxyphenyl) valeric acid. In certain embodiments, a coreactant comprises an N,N-bis(2-hydroxyalkyl)carboxylic acid.

In certain embodiments, a reactive small molecule comprises a polyhydric alcohol comprising one or more amino groups. In certain embodiments, a reactive small molecule comprises an amino diol. In certain embodiments, a reactive small molecule comprises a diol containing a tertiary amino group. In certain embodiments, an amino diol is selected from the group consisting of: diethanolamine (DEA), N-methyldiethanolamine (MDEA), N-ethyldiethanolamine (EDEA), N-butyldiethanolamine (BDEA), N,N-bis(hydroxyethyl)-α-amino pyridine, dipropanolamine, diisopropanolamine (DIPA), N-methyldiisopropanolamine, Diisopropanol-p-toluidine, N,N-Bis(hydroxyethyl)-3-chloroaniline, 3-diethylaminopropane-1,2-diol, 3-dimethylaminopropane-1,2-diol and N-hydroxyethylpiperidine. In certain embodiments, a coreactant comprises a diol containing a quaternary amino group. In certain embodiments, a coreactant comprising a quaternary amino group is an acid salt or quaternized derivative of any of the amino alcohols described above. In some embodiments, a reactive small molecule is DMPA.

In certain embodiments, a reactive small molecule is selected from the group consisting of: inorganic or organic polyamines having an average of about 2 or more primary and/or secondary amine groups, polyalcohols, ureas, and combinations of any two or more of these. In certain embodiments, a reactive small molecule is selected from the group consisting of: diethylene triamine (DETA), ethylene diamine (EDA), meta-xylylenediamine (MXDA), aminoethyl ethanolamine (AEEA), 2-methyl pentane diamine, and the like, and mixtures thereof. Also suitable for practice in the present invention are propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, and sulfonated primary and/or secondary amines. In certain embodiments, reactive small molecule is selected from the group consisting of: hydrazine, substituted hydrazines, hydrazine reaction products, and the like, and mixtures thereof. In certain embodiments, a reactive small molecule is a polyalcohol including those having from 2 to 12 carbon atoms, preferably from 2 to 8 carbon atoms, such as ethylene glycol, diethylene glycol, neopentyl glycol, butanediols, hexanediol, and the like, and mixtures thereof. Suitable ureas include urea and its derivatives, and the like, and mixtures thereof.

In certain embodiments, reactive small molecules containing at least one basic nitrogen atom are selected from the group consisting of: mono-, bis- or polyalkoxylated aliphatic, cycloaliphatic, aromatic or heterocyclic primary amines, N-methyl diethanolamine, N-ethyl diethanolamine, N-propyl diethanolamine, N-isopropyl diethanolamine, N-butyl diethanolamine, N-isobutyl diethanolamine, N-oleyl diethanolamine, N-stearyl diethanolamine, ethoxylated coconut oil fatty amine, N-allyl diethanolamine, N-methyl diisopropanolamine, N-ethyl diisopropanolamine, N-propyl diisopropanolamine, N-butyl diisopropanolamine, cyclohexyl diisopropanolamine, N,N-diethoxylaniline, N,N-diethoxyl toluidine, N,N-diethoxyl-1-aminopyridine, N,N′-diethoxyl piperazine, dimethyl-bis-ethoxyl hydrazine, N,N′-bis-(2-hydroxyethyl)-N,N′-diethylhexahydr op-phenylenediamine, N-12-hydroxyethyl piperazine, polyalkoxylated amines, propoxylated methyl diethanolamine, N-methyl-N,N-bis-3-aminopropylamine, N-(3-aminopropyl)-N,N′-dimethyl ethylenediamine, N-(3-aminopropyl)-N-methyl ethanolamine, N,N′-bis-(3-aminopropyl)-N,N′-dimethyl ethylenediamine, N,N′-bis-(3-aminopropyl)-piperazine, N-(2-aminoethyl)-piperazine, N, N′-bisoxyethyl propylenediamine, 2,6-diaminopyridine, diethanolaminoacetamide, diethanolamidopropionamide, N,N-bisoxyethylphenyl thiosemicarbazide, N,N-bis-oxyethylmethyl semicarbazide, p,p′-bis-aminomethyl dibenzyl methylamine, 2,6-diaminopyridine, 2-dimethylaminomethyl-2-methylpropanel, 3-diol. In certain embodiments, chain-extending agents are compounds that contain two amino groups. In certain embodiments, chain-extending agents are selected from the group consisting of: ethylene diamine, 1,6-hexamethylene diamine, and 1,5-diamino-1-methyl-pentane.

2. Catalysts

In certain embodiments, no catalysts are used in provided mixtures. In certain embodiments, in the polymerization reaction for a polyurethane, a conventional catalyst comprising an amine compound or tin compound can be employed to promote the reaction. These embodiments are most commonly found in reactive extrusion methods of polyurethane adhesive production. Any suitable urethane catalyst may be used, including tertiary amine compounds and organometallic compounds may be used. Exemplary tertiary amine compounds include triethylenediamine, N-methylmorpholine, N,N-dimethylcyclohexylamine, pentamethyldiethylenetriamine, tetramefhylefhylenediamine, 1-methyl-4-dimethylaminoethylpiperazine, 3-methoxy-N-dimethylpropylamine, N-ethylmorpholine, diethylethanolamine, N-cocomorpholine, N,N-dimefhyl-N′,N′-dimethyl isopropylpropylenediamine, N,N-diethyl-3-diethylaminopropylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin dilaurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. Such catalysts are used in an amount which measurably increases the rate of polyurethane or polyisocyanurate formation.

In certain embodiments, where mixtures of the present invention comprise catalysts, the catalysts comprise tin based materials. In certain embodiments, tin catalysts are selected from the group consisting of: di-butyl tin dilaurate, dibutylbis(laurylthio)stannate, dibutyltinbis(isooctylmercapto acetate) and dibutyltinbis(isooctylmaleate), tin octanoate and mixtures of any two or more of these.

In certain embodiments, catalysts included in the mixtures comprise tertiary amines. In certain embodiments, catalysts included in the mixtures are selected from the group consisting of: DABCO, pentametyldipropylenetriamine, bis(dimethylamino ethyl ether), pentamethyldiethylenetriamine, DBU phenol salt, dimethylcyclohexylamine, 2,4,6-tris(N,N-dimethylaminomethyl)phenol (DMT-30), triazabicyclodecene (TBD), N-methyl TBD, 1,3,5-tris(3-dimethylaminopropyl)hexahydro-s-triazine, ammonium salts and combinations or formulations of any of these.

In some embodiments, the catalyst is a non-Sn catalyst. In some embodiments, the catalyst is a zinc-catalyst. In some embodiments, a catalyst is a Bi-catalyst.

Typical amounts of catalyst are 0.001 to 10 parts of catalyst per 100 parts by weight of total polyol in the mixture. In certain embodiments, catalyst levels in the formulation, when used, range between about 0.001 pph (weight parts per hundred) and about 3 pph based on the amount of polyol present in the mixture. In certain embodiments, catalyst levels range between about 0.05 pph and about 1 pph, or between about 0.1 pph and about 0.5 pph.

3. Mono-Functional Materials

In certain embodiments, monofunctional components are added to polyurethane reaction mixtures. Suitable monofunctional components can include molecules having a single isocyanate-reactive functional group such as an alcohol, amine, carboxylic acid, or thiol. A monofunctional component will serve as a chain termination which can be used to limit molecular weight or crosslinking if higher functionality species are used. U.S. Pat. No. 5,545,706 illustrates the use of a monofunctional alcohol in a substantially linear polyurethane formulation. The monofunctional alcohol can be any compound with one alcohol available for reaction with isocyanate such as methanol, ethanol, propanol, isopropanol, butanol, isobutanol, pentanol, hexanol, heptanol, octanol, nonanol, decanol, dodecanol, phenol and the like. Additionally, the monofunctional component can be added as a low molecular weight polymer that has been initiated by or reacted with the monofunctional alcohol. The monofunctional alcohol can be a polyether such as polypropylene oxide or polyethylene oxide initiated with any of the monofunctional alcohols listed. The monofunctional alcohol can be a polyester polymer where the monofunctional alcohol is added to the recipe. The monofunctional alcohol can be a polycarbonate polymer such as polyethylene carbonate or polypropylene carbonate initiated with a monofunctional anion, such as halide, nitrate, azide, carboxylate, or a monohydric alcohol.

Similarly, the monofunctional component could be an isocyanate. Any monofunctional isocyanate could be added for this same function. Possible materials include phenyl isocyanate, naphthyl isocyanate, methyl isocyanate, ethyl isocyanate, propyl isocyanate, butyl isocyanate, hexyl isocyanate, octyl isocyanate and the like.

4. Additives

In addition to the above components, mixtures of the present invention may optionally contain various additives as are known in the art of polyurethane technology. Such additives may include, but are not limited to solvents, fillers, clays, blocking agents, stabilizers, thixotropes, plasticizers, compatibilizers, colorants, UV stabilizers, flame retardants, and the like.

a) Solvents

If desired, the polyurethanes or pre-polymers can be dispersed in a mixture of water and organic solvents known to those skilled in the art. Suitable solvents can include aliphatic, aromatic, or halogenated hydrocarbons, ethers, esters, ketones, lactones, sulfones, nitriles, amides, nitrornethane, propylene carbonate, dimethyl carbonate and the like. Representative examples include, but are not limited to: acetone, acetonitrile, benzene, butanol, butyl acetate, g-butyrolactone, butyl caribitl acetate, carbitol acetate, chloroform, cyclohexane, 1,2-dichloromethane, dibasic ester, diglyme, 1,2-dimethoxyethane, dimethylacetamide, dimethylsulfoxide, dimethformamide, 1,4-dioxane, ethanol, ethyl acetate, ethyl ether, ethylene glycol, hexane, hydroxylmethyl methacrylate, isopropyl acetate, methanol, methyl acetate, methyl amnyl ketone, methyl isobutyl ketone, methylene chloride, methyl ethyl ketone (MEK), monoglyme, methyl methacrylate, propylene carbobonate, propylene oxide, styrene, alpha-terpineol, tetrahydrafuran, texanol, toluene, diethyl succinate, diethylene glycol methyl ether, ethylene glycol diacetate, triethyl phosphate and the like. In some embodiments, the solvent is MEK. In some embodiments, e.g., PUD compositions, a solvent is or includes water.

b) Fillers

Optional components of the polyurethane compositions of the invention include fillers. Such fillers are well known to those skilled in the art and include carbon black, titanium dioxide, calcium carbonate, surface treated silicas, titanium oxide, fume silica, talc, aluminum trihydrate and the like. In certain embodiments, fillers comprise carbon black. In certain embodiments, more than one reinforcing filler may be used, of which one is carbon black and a sufficient amount of carbon black is used to provide the desired black color to the adhesive. In certain embodiments, a reinforcing filler is used in sufficient amount to increase the strength of the adhesive and/or to provide thixotropic properties to the adhesive. The amounts of filler or other additives will vary depending on the desired application.

c) Clays

Among optional materials in the polyurethane composition are clays. Preferred clays useful in the invention include kaolin, surface treated kaolin, calcined kaolin, aluminum silicates and surface treated anhydrous aluminum silicates. The clays can be used in any form which facilitates formulation of a pumpable adhesive. Preferably the clay is in the form of pulverized powder, spray-dried beads or finely ground particles.

d) Blocking Agents

One or more blocking agents are utilized to provide an induction period between the mixing of the two parts of the polyurethane adhesive composition and the initiation of the cure. The addition of the blocking agents provides an induction period which causes a reduction in the curing rate immediately after mixing of the components of the adhesive. The reduction in the curing rate results in lower initial tensile shear strengths and storage moduli immediately after mixing than those found in compositions that do not contain a blocking agent. Following the induction period the adhesive quickly cures so that the tensile shear strength and storage modulus are similar to those produced by adhesives that do not contain the blocking agent. Such thixotropes are well known to those skilled in the art and include hydroxyl containing compounds such as diethylene glycol, mono alkyl ethers, butanone oxime, methyl ethyle ketone oxime, nonylphenol, phenol and cresol; amine containing compounds such as caprolactam, diisopropyl amine, 1,2,4-triazole and 3,5-dimethyl pyrazole; and aliphatic containing compounds such as dialkyl malonate.

e) Stabilizers

A polyurethane composition of this invention may further comprise stabilizers which function to protect the polyurethane composition from moisture, thereby inhibiting advancement and preventing premature crosslinking of the isocyanates in the adhesive formulation. Included among such stabilizers are diethylmalonate and alkylphenol alkylates.

f) Thixotrope

Optionally, a polyurethane composition may further comprise a thixotrope. Such thixotropes are well known to those skilled in the art and include alumina, limestone, talc, zinc oxides, sulfur oxides, calcium carbonate, perlite, slate flour, salt (NaCl), cyclodextrin and the like. The thixotrope may be added to the polyurethane composition in a sufficient amount to give the desired rheological properties.

g) Plasticizers

Polyurethane composition of the present invention may further comprise plasticizers so as to modify the rheological properties to a desired consistency. Such materials should be free of water, inert to isocyanate groups and compatible with a polymer. Suitable plasticizers are well known in the art and preferable plasticizers include alkyl phthalates such as dioctylphthalate or dibutylphthalate, partially hydrogenated terpene commercially available as “HB-40”, trioctyl phosphate, epoxy plasticizers, toluene-sulfamide, chloroparaffins, adipic acid esters, castor oil, toluene and alkyl naphthalenes. The amount of plasticizer in the polyurethane composition is that amount which gives the desired rheological properties and/or which is sufficient to disperse any catalyst that may be present in the system.

h) Compatibilizers

In certain embodiments, a polyurethane composition of the present invention comprises one or more suitable compatibilizers. Compatibilizers are molecules that allow two or more nonmiscible ingredients to come together and give a homogeneous liquid phase. Many such molecules are known to the polyurethane industry, these include: amides, amines, hydrocarbon oils, phthalates, polybutyleneglycols, and ureas.

i) Colorants

In certain embodiments, a polyurethane composition of the present invention comprises one or more suitable colorants. Typical inorganic coloring agents included titanium dioxide, iron oxides and chromium oxide. Organic pigments originated from the azo/diazo dyes, phthalocyanines and dioxazines, as well as carbon black. Recent advances in the development of polyol-bound colorants are described in:
Miley, J. W.; Moore, P. D. “Reactive Polymeric Colorants For Polyurethane”, Proceedings Of The SPI-26th Annual Technical Conference; Technomic: Lancaster, Pa., 1981; 83-86.
Moore, P. D.; Miley, J. W.; Bates, S. H.; “New Uses For Highly Miscible Liquid Polymeric Colorants In The Manufacture of Colored Urethane Systems”; Proceedings of the SPI-27th Annual Technical/Marketing Conference; Technomic: Lancaster, Pa., 1982; 255-261.
Bates, S. H.; Miley, J. W. “Polyol-Bound Colorants Solve Polyurethane Color Problems”; Proceedings Of The SPI-30th Annual Technical/Marketing Conference; Technomic: Lancaster, Pa., 1986; 160-165
Vielee, R. C.; Haney, T. V. “Polyurethanes”; In Coloring of Plastics; Webber, T. G., Ed., Wiley-Interscience: New York, 1979, 191-204.

j) UV Stabilizers

In certain embodiments, a polyurethane composition of the present invention comprises one or more suitable UV stabilizers. Polyurethanes based on aromatic isocyanates will typically turn dark shades of yellow upon aging with exposure to light. A review of polyurethane weathering phenomena is presented in: Davis, A.; Sims, D. Weathering Of Polymers; Applied Science: London, 1983, 222-237. Light protection agents, such as hydroxybenzotriazoles, zinc dibutyl thiocarbamate, 2,6-ditertiary butylcatechol, hydroxybenzophenones, hindered amines and phosphites have been used to improve the light stability of polyurethanes. Color pigments have also been used successfully.

k) Flame Retardants

In certain embodiments, a polyurethane composition of the present invention comprises one or more suitable flame retardants. Flame retardants are often added to reduce flammability. The choice of flame retardant for any specific polyurethane adhesive often depends upon the intended service application of that adhesive and the attendant flammability testing scenario governing that application. Aspects of flammability that may be influenced by additives include the initial ignitability, burning rate and smoke evolution.

The most widely used flame retardants are the chlorinated phosphate esters, chlorinated paraffins and melamine powders. These and many other compositions are available from specialty chemical suppliers. A review of this subject has been published: Kuryla, W. C.; Papa, A. J. Flame Retardancy of Polymeric Materials, Vol. 3; Marcel Dekker: New York, 1975, 1-133.

H. Blended Compositions

As described above and herein, in some aspects, the present invention encompasses compositions comprising:
polyol subcomponent (i), which comprises one or more polycarbonate or polyether carbonate polyols derived from copolymerization of carbon dioxide and one or more epoxides; and
polyol subcomponent (ii), which comprises one or more polyether or polyester polyols.

In some embodiments, a polyol component of a composition comprises any of the polyols described above and herein.

In some embodiments, polyol subcomponent (i) comprises a polycarbonate polyol as described above and herein. In some embodiments, polyol subcomponent (i) comprises a polyether carbonate polyol as described above and herein. In some embodiments, polyol subcomponent (ii) comprises a polyether polyol as described above and herein. In some embodiments, polyol subcomponent (ii) comprises a polyester polyol as described above and herein.

In certain embodiments, a provided composition comprises polyol subcomponent (i) and polyol subcomponent (ii) in a weight ratio between about 9:1 to about 1:9. In certain embodiments, a provided composition comprises polyol subcomponent (i) and polyol subcomponent (ii) in a weight ratio between about 7:1 to about 1:7. In certain embodiments, a provided composition comprises polyol subcomponent (i) and polyol subcomponent (ii) in a weight ratio between about 5:1 to about 1:5. In certain embodiments, a provided composition comprises polyol subcomponent (i) and polyol subcomponent (ii) in a weight ratio between about 4:1 to about 1:4. In certain embodiments, a provided composition comprises polyol subcomponent (i) and polyol subcomponent (ii) in a weight ratio between about 3:1 to about 1:3. In certain embodiments, a provided compositions comprise polyol subcomponent (i) and polyol subcomponent (ii) in a weight ratio between about 2:1 to about 1:2. In certain embodiments, a provided composition comprises polyol subcomponent (i) and polyol subcomponent (ii) in a weight ratio between about 1:1.). In some embodiments, a polyol component comprises about 50 weight percent of polycarbonate polyols of formula Q10 and the remaining 50 weight percent is comprised of polyol subcomponent (ii) (e.g., BD-AA or DEG-AA). In some embodiments, a polyol component comprises about 50 weight percent of polycarbonate polyols of formula Q11 and the remaining 50 weight percent is comprised of polyol subcomponent (ii) (e.g., BD-AA or DEG-AA).

In certain embodiments, a provided composition comprises polyol subcomponent (i) and polyol subcomponent (ii) in a weight ratio between about 2:3 to about 3:2. In certain embodiments, a provided composition comprises polyol subcomponent (i) and polyol subcomponent (ii) in a weight ratio between about 4:3 to about 3:4.

In some embodiments, polyol subcomponent (i) comprises a mixture of two or more polycarbonate or polyether carbonate polyols derived from copolymerization of carbon dioxide and one or more epoxides. In some embodiments, polyol subcomponent (i) comprises a mixture of two or more polycarbonate polyols derived from copolymerization of carbon dioxide and one or more epoxides. In some embodiments, polyol subcomponent (i) comprises a mixture of two or more polyether carbonate polyols derived from copolymerization of carbon dioxide and one or more epoxides. In some embodiments, polyol subcomponent (i) comprises a mixture of one or more polycarbonate polyols and one or more polyether carbonate polyols, wherein the polycarbonate polyols and polyether carbonate polyols are derived from copolymerization of carbon dioxide and one or more epoxides.

In some embodiments, polyol subcomponent (i) comprises a mixture of two polycarbonate polyols in a weight ratio between about 10:1 to about 1:10. In some embodiments, polyol subcomponent (i) comprises a mixture of two polycarbonate polyols in a weight ratio between about 9:1 to about 1:9. In some embodiments, polyol subcomponent (i) comprises a mixture of two polycarbonate polyols in a weight ratio between about 7:1 to about 1:7. In some embodiments, polyol subcomponent (i) comprises a mixture of two polycarbonate polyols in a weight ratio between about 5:1 to about 1:5. In some embodiments, polyol subcomponent (i) comprises a mixture of two polycarbonate polyols in a weight ratio between about 4:1 to about 1:4. In some embodiments, polyol subcomponent (i) comprises a mixture of two polycarbonate polyols in a weight ratio between about 3:1 to about 1:3. In some embodiments, polyol subcomponent (i) comprises a mixture of two polycarbonate polyols in a weight ratio between about 2:1 to about 1:2. In some embodiments, polyol subcomponent (i) comprises a mixture of two polycarbonate polyols in a weight ratio of about 1:1.

In some embodiments, polyol subcomponent (i) comprises a mixture of two polycarbonate polyols in a weight ratio between about 3:2 to about 2:3. In some embodiments, polyol subcomponent (i) comprises a mixture of two polycarbonate polyols in a weight ratio between about 4:3 to about 3:4.

In some embodiments, polyol subcomponent (i) comprises polyol subcomponent (i-a) and polyol subcomponent (i-b). In some embodiments, polyol subcomponent (i) comprises:
polyol subcomponent (i-a), which comprises a polycarbonate polyol having a structure of P2b:

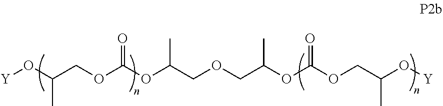

wherein each Y and n is described above and herein; and
polyol subcomponent (i-b), which comprises a polycarbonate polyol having a structure of Q7:

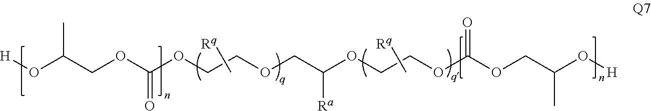

wherein each R^{q}, R^{a}, q, q′, and n is described above and herein.

In some embodiments, polyol subcomponent (i) comprises:
polyol subcomponent (i-a), which comprises a polycarbonate polyol having a structure of Q10:

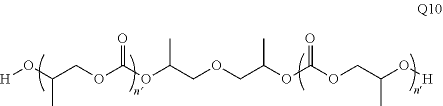

wherein n′ is as described above and herein; and
polyol subcomponent (i-b), which comprises a polycarbonate polyol having a structure of Q11:

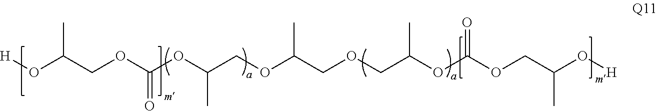

wherein each a and m′ is as described above and herein.

In some embodiments, a polyol component comprises about 20-30 weight percent of polyol subcomponent (i-a), about 20-30 weight percent of polyol subcomponent (i-b), and the remaining weight percent is comprised of polyol subcomponent (ii). In some embodiments, a polyol component comprises about 10-40 weight percent of polyol subcomponent (i-a), about 10-40 weight percent of polyol subcomponent (i-b), and the remaining weight percent is comprised of polyol subcomponent (ii). In some embodiments, a polyol component comprises about 15-35 weight percent of polyol subcomponent (i-a), about 15-35 weight percent of polyol subcomponent (i-b), and the remaining weight percent is comprised of polyol subcomponent (ii). In some embodiments, a polyol component comprises about 23-27 weight percent of polyol subcomponent (i-a), about 23-27 weight percent of polyol subcomponent (i-b), and the remaining weight percent is comprised of polyol subcomponent (ii). In some embodiments, a polyol component comprises about 25 weight percent of polyol subcomponent (i-a), about 25 weight percent of polyol subcomponent (i-b), and the remaining 50 weight percent is comprised of polyol subcomponent (ii).

In some embodiments, a polyol component comprises about 20-30 weight percent of polycarbonate polyols of formula Q10, about 20-30 weight percent of polycarbonate polyols of formula Q11, and the remaining weight percent is comprised of polyol subcomponent (ii). In some embodiments, a polyol component comprises about 10-40 weight percent of polycarbonate polyols of formula Q10, about 10-40 weight percent of polycarbonate polyols of formula Q11, and the remaining weight percent is comprised of polyol subcomponent (ii). In some embodiments, a polyol component comprises about 15-35 weight percent of polycarbonate polyols of formula Q10, about 15-35 weight percent of polycarbonate polyols of formula Q11, and the remaining weight percent is comprised of polyol subcomponent (ii). In some embodiments, a polyol component comprises about 23-27 weight percent of polycarbonate polyols of formula Q10, about 23-27 weight percent of polycarbonate polyols of formula Q11, and the remaining weight percent is comprised of polyol subcomponent (ii). In some embodiments, a polyol component comprises about 25 weight percent of polycarbonate polyols of formula Q10, about 25 weight percent of polycarbonate polyols of formula Q11, and the remaining 50 weight percent is comprised of polyol subcomponent (ii).

In some embodiments, a polyol component comprises about 20-30 weight percent of polycarbonate polyols of formula Q10, about 20-30 weight percent of polycarbonate polyols of formula Q11, and the remaining weight percent is comprised of poly(tetramethylene glycol). In some embodiments, a polyol component comprises about 10-40 weight percent of polycarbonate polyols of formula Q10, about 10-40 weight percent of polycarbonate polyols of formula Q11, and the remaining weight percent is comprised of poly(tetramethylene glycol). In some embodiments, a polyol component comprises about 15-35 weight percent of polycarbonate polyols of formula Q10, about 15-35 weight percent of polycarbonate polyols of formula Q11, and the remaining weight percent is comprised of poly(tetramethylene glycol). In some embodiments, a polyol component comprises about 23-27 weight percent of polycarbonate polyols of formula Q10, about 23-27 weight percent of polycarbonate polyols of formula Q11, and the remaining weight percent is comprised of poly(tetramethylene glycol). In some embodiments, a polyol component comprises about 25 weight percent of polycarbonate polyols of formula Q10, about 25 weight percent of polycarbonate polyols of formula Q11, and the remaining 50 weight percent is comprised of poly(tetramethylene glycol).

In some embodiments, a polyol component comprises about 20-30 weight percent of polycarbonate polyols of formula Q10, about 20-30 weight percent of polycarbonate polyols of formula Q11, and the remaining weight percent is comprised of AA-BDO polyester. In some embodiments, a polyol component comprises about 10-40 weight percent of polycarbonate polyols of formula Q10, about 10-40 weight percent of polycarbonate polyols of formula Q11, and the remaining weight percent is comprised of AA-BDO polyester. In some embodiments, a polyol component comprises about 15-35 weight percent of polycarbonate polyols of formula Q10, about 15-35 weight percent of polycarbonate polyols of formula Q11, and the remaining weight percent is comprised of AA-BDO polyester. In some embodiments, a polyol component comprises about 23-27 weight percent of polycarbonate polyols of formula Q10, about 23-27 weight percent of polycarbonate polyols of formula Q11, and the remaining weight percent is comprised of AA-BDO polyester. In some embodiments, a polyol component comprises about 25 weight percent of polycarbonate polyols of formula Q10, about 25 weight percent of polycarbonate polyols of formula Q11, and the remaining 50 weight percent is comprised of AA-BDO polyester.

In some embodiments, a provided composition comprises about 5-90 weight percent of polyol subcomponent (i-a) (e.g., polycarbonate polyols of formula Q10), about 5-85 weight percent of polyol subcomponent (i-b) (e.g., polycarbonate polyols of formula Q11), and about 5-60 weight percent of polyol subcomponent (ii) (e.g., BD-AA). In some embodiments, a provided composition comprises about 20-85 weight percent of polyol subcomponent (i-a) (e.g., polycarbonate polyols of formula Q10), about 5-63 weight percent of polyol subcomponent (i-b) (e.g., polycarbonate polyols of formula Q11), and about 5-45 weight percent of polyol subcomponent (ii) (e.g., BD-AA). In some embodiments, a provided composition comprises about 30-55 weight percent of polyol subcomponent (i-a) (e.g., polycarbonate polyols of formula Q10), about 5-35 weight percent of polyol subcomponent (i-b) (e.g., polycarbonate polyols of formula Q11), and about 30-45 weight percent of polyol subcomponent (ii) (e.g., BD-AA).

In some embodiments, a provided composition comprises about 80-90 weight percent of polyol subcomponent (i-a) (e.g., polycarbonate polyols of formula Q10), about 0.1-10 weight percent of polyol subcomponent (i-b) (e.g., polycarbonate polyols of formula Q11), and about 0.1-10 weight percent of polyol subcomponent (ii) (e.g., BD-AA). In some embodiments, a provided composition comprises about 86-92 weight percent of polyol subcomponent (i-a) (e.g., polycarbonate polyols of formula Q10), about 2-8 weight percent of polyol subcomponent (i-b) (e.g., polycarbonate polyols of formula Q11), and about 3-9 weight percent of polyol subcomponent (ii) (e.g., BD-AA). In some embodiments, a provided composition comprises about 89 weight percent of polyol subcomponent (i-a) (e.g., polycarbonate polyols of formula Q10), about 5 weight percent of polyol subcomponent (i-b) (e.g., polycarbonate polyols of formula Q11), and about 6 weight percent of polyol subcomponent (ii) (e.g., BD-AA).

In some embodiments, a provided composition comprises about 58-68 weight percent of polyol subcomponent (i-a) (e.g., polycarbonate polyols of formula Q10), about 18-28 weight percent of polyol subcomponent (i-b) (e.g., polycarbonate polyols of formula Q11), and about 9-19 weight percent of polyol subcomponent (ii) (e.g., BD-AA). In some embodiments, a provided composition comprises about 60-66 weight percent of polyol subcomponent (i-a) (e.g., polycarbonate polyols of formula Q10), about 20-26 weight percent of polyol subcomponent (i-b) (e.g., polycarbonate polyols of formula Q11), and about 11-17 weight percent of polyol subcomponent (ii) (e.g., BD-AA). In some embodiments, a provided composition comprises about 63 weight percent of polyol subcomponent (i-a) (e.g., polycarbonate polyols of formula Q10), about 23 weight percent of polyol subcomponent (i-b) (e.g., polycarbonate polyols of formula Q11), and about 14 weight percent of polyol subcomponent (ii) (e.g., BD-AA).

In some embodiments, a provided composition comprises about 29-39 weight percent of polyol subcomponent (i-a) (e.g., polycarbonate polyols of formula Q10), about 27-37 weight percent of polyol subcomponent (i-b) (e.g., polycarbonate polyols of formula Q11), and about 29-39 weight percent of polyol subcomponent (ii) (e.g., BD-AA). In some embodiments, a provided composition comprises about 31-37 weight percent of polyol subcomponent (i-a) (e.g., polycarbonate polyols of formula Q10), about 29-35 weight percent of polyol subcomponent (i-b) (e.g., polycarbonate polyols of formula Q11), and about 31-37 weight percent of polyol subcomponent (ii) (e.g., BD-AA). In some embodiments, a provided composition comprises about 34 weight percent of polyol subcomponent (i-a) (e.g., polycarbonate polyols of formula Q10), about 32 weight percent of polyol subcomponent (i-b) (e.g., polycarbonate polyols of formula Q11), and about 34 weight percent of polyol subcomponent (ii) (e.g., BD-AA).

In some embodiments, a provided composition comprises about 41-51 weight percent of polyol subcomponent (i-a) (e.g., polycarbonate polyols of formula Q10), about 41-51 weight percent of polyol subcomponent (i-b) (e.g., polycarbonate polyols of formula Q11), and about 3-13 weight percent of polyol subcomponent (ii) (e.g., BD-AA). In some embodiments, a provided composition comprises about 43-49 weight percent of polyol subcomponent (i-a) (e.g., polycarbonate polyols of formula Q10), about 43-49 weight percent of polyol subcomponent (i-b) (e.g., polycarbonate polyols of formula Q11), and about 5-11 weight percent of polyol subcomponent (ii) (e.g., BD-AA). In some embodiments, a provided composition comprises about 46 weight percent of polyol subcomponent (i-a) (e.g., polycarbonate polyols of formula Q10), about 46 weight percent of polyol subcomponent (i-b) (e.g., polycarbonate polyols of formula Q11), and about 8 weight percent of polyol subcomponent (ii) (e.g., BD-AA).

In some embodiments, a provided composition comprises about 0.1-10 weight percent of polyol subcomponent (i-a) (e.g., polycarbonate polyols of formula Q10), about 46-56 weight percent of polyol subcomponent (i-b) (e.g., polycarbonate polyols of formula Q11), and about 39-49 weight percent of polyol subcomponent (ii) (e.g., BD-AA). In some embodiments, a provided composition comprises about 2-8 weight percent of polyol subcomponent (i-a) (e.g., polycarbonate polyols of formula Q10), about 48-54 weight percent of polyol subcomponent (i-b) (e.g., polycarbonate polyols of formula Q11), and about 41-47 weight percent of polyol subcomponent (ii) (e.g., BD-AA). In some embodiments, a provided composition comprises about 5 weight percent of polyol subcomponent (i-a) (e.g., polycarbonate polyols of formula Q10), about 51 weight percent of polyol subcomponent (i-b) (e.g., polycarbonate polyols of formula Q11), and about 44 weight percent of polyol subcomponent (ii) (e.g., BD-AA).

In some embodiments, a provided composition comprises about 15-25 weight percent of polyol subcomponent (i-a) (e.g., polycarbonate polyols of formula Q10), about 56-66 weight percent of polyol subcomponent (i-b) (e.g., polycarbonate polyols of formula Q11), and about 14-24 weight percent of polyol subcomponent (ii) (e.g., BD-AA). In some embodiments, a provided composition comprises about 17-23 weight percent of polyol subcomponent (i-a) (e.g., polycarbonate polyols of formula Q10), about 58-64 weight percent of polyol subcomponent (i-b) (e.g., polycarbonate polyols of formula Q11), and about 16-22 weight percent of polyol subcomponent (ii) (e.g., BD-AA). In some embodiments, a provided composition comprises about 20 weight percent of polyol subcomponent (i-a) (e.g., polycarbonate polyols of formula Q10), about 61 weight percent of polyol subcomponent (i-b) (e.g., polycarbonate polyols of formula Q11), and about 19 weight percent of polyol subcomponent (ii) (e.g., BD-AA).

In some embodiments, a provided composition comprises about 5-15 weight percent of polyol subcomponent (i-a) (e.g., polycarbonate polyols of formula Q10), about 80-90 weight percent of polyol subcomponent (i-b) (e.g., polycarbonate polyols of formula Q11), and about 0.1-10 weight percent of polyol subcomponent (ii). (e.g., BD-AA) In some embodiments, a provided composition comprises about 7-13 weight percent of polyol subcomponent (i-a) (e.g., polycarbonate polyols of formula Q10), about 82-88 weight percent of polyol subcomponent (i-b) (e.g., polycarbonate polyols of formula Q11), and about 2-8 weight percent of polyol subcomponent (ii) (e.g., BD-AA). In some embodiments, a provided composition comprises about 10 weight percent of polyol subcomponent (i-a) (e.g., polycarbonate polyols of formula Q10), about 85 weight percent of polyol subcomponent (i-b) (e.g., polycarbonate polyols of formula Q11), and about 5 weight percent of polyol subcomponent (ii) (e.g., BD-AA).

In some embodiments, a provided composition comprises about 65-75 weight percent of polyol subcomponent (i-a) (e.g., polycarbonate polyols of formula Q10), about 5-15 weight percent of polyol subcomponent (i-b) (e.g., polycarbonate polyols of formula Q11), and about 15-25 weight percent of polyol subcomponent (ii) (e.g., BD-AA). In some embodiments, a provided composition comprises about 67-73 weight percent of polyol subcomponent (i-a) (e.g., polycarbonate polyols of formula Q10), about 7-13 weight percent of polyol subcomponent (i-b) (e.g., polycarbonate polyols of formula Q11), and about 17-23 weight percent of polyol subcomponent (ii) (e.g., BD-AA). In some embodiments, a provided composition comprises about 70 weight percent of polyol subcomponent (i-a) (e.g., polycarbonate polyols of formula Q10), about 10 weight percent of polyol subcomponent (i-b) (e.g., polycarbonate polyols of formula Q11), and about 20 weight percent of polyol subcomponent (ii). (e.g., BD-AA).

In some embodiments, a provided composition comprises about 50-60 weight percent of polyol subcomponent (i-a) (e.g., polycarbonate polyols of formula Q10), about 35-45 weight percent of polyol subcomponent (i-b) (e.g., polycarbonate polyols of formula Q11), and about 0.1-10 weight percent of polyol subcomponent (ii) (e.g., BD-AA). In some embodiments, a provided composition comprises about 52-58 weight percent of polyol subcomponent (i-a) (e.g., polycarbonate polyols of formula Q10), about 37-43 weight percent of polyol subcomponent (i-b) (e.g., polycarbonate polyols of formula Q11), and about 2-8 weight percent of polyol subcomponent (ii) (e.g., BD-AA). In some embodiments, a provided composition comprises about 55 weight percent of polyol subcomponent (i-a) (e.g., polycarbonate polyols of formula Q10), about 40 weight percent of polyol subcomponent (i-b) (e.g., polycarbonate polyols of formula Q11), and about 5 weight percent of polyol subcomponent (ii) (e.g., BD-AA).

In some embodiments, a provided composition comprises about 8-18 weight percent of polyol subcomponent (i-a) (e.g., polycarbonate polyols of formula Q10), about 28-38 weight percent of polyol subcomponent (i-b) (e.g., polycarbonate polyols of formula Q11), and about 48-58 weight percent of polyol subcomponent (ii) (e.g., BD-AA). In some embodiments, a provided composition comprises about 10-16 weight percent of polyol subcomponent (i-a) (e.g., polycarbonate polyols of formula Q10), about 30-36 weight percent of polyol subcomponent (i-b) (e.g., polycarbonate polyols of formula Q11), and about 50-56 weight percent of polyol subcomponent (ii) (e.g., BD-AA). In some embodiments, a provided composition comprises about 13 weight percent of polyol subcomponent (i-a) (e.g., polycarbonate polyols of formula Q10), about 33 weight percent of polyol subcomponent (i-b) (e.g., polycarbonate polyols of formula Q11), and about 53 weight percent of polyol subcomponent (ii) (e.g., BD-AA).

In some embodiments, a provided composition comprises about 10-40 weight percent of polyol subcomponent (i-a) (e.g., polycarbonate polyols of formula Q10), about 10-70 weight percent of polyol subcomponent (i-b) (e.g., polycarbonate polyols of formula Q11), and about 10-70 weight percent of polyol subcomponent (ii) (e.g., DEG-AA). In some embodiments, a provided composition comprises about 10-40 weight percent of polyol subcomponent (i-a) (e.g., polycarbonate polyols of formula Q10), about 10-50 weight percent of polyol subcomponent (i-b) (e.g., polycarbonate polyols of formula Q11), and about 10-70 weight percent of polyol subcomponent (ii) (e.g., DEG-AA). In some embodiments, a provided composition comprises about 10-40 weight percent of polyol subcomponent (i-a) (e.g., polycarbonate polyols of formula Q10), about 10-70 weight percent of polyol subcomponent (i-b) (e.g., polycarbonate polyols of formula Q11), and about 10-50 weight percent of polyol subcomponent (ii) (e.g., DEG-AA).

In some embodiments, a provided composition comprises about 28-38 weight percent of polyol subcomponent (i-a) (e.g., polycarbonate polyols of formula Q10), about 28-38 weight percent of polyol subcomponent (i-b) (e.g., polycarbonate polyols of formula Q11), and about 28-38 weight percent of polyol subcomponent (ii) (e.g., DEG-AA). In some embodiments, a provided composition comprises about 30-36 weight percent of polyol subcomponent (i-a) (e.g., polycarbonate polyols of formula Q10), about 30-36 weight percent of polyol subcomponent (i-b) (e.g., polycarbonate polyols of formula Q11), and about 30-36 weight percent of polyol subcomponent (ii) (e.g., DEG-AA). In some embodiments, a provided composition comprises about 33 weight percent of polyol subcomponent (i-a) (e.g., polycarbonate polyols of formula Q10), about 34 weight percent of polyol subcomponent (i-b) (e.g., polycarbonate polyols of formula Q11), and about 33 weight percent of polyol subcomponent (ii) (e.g., DEG-AA).

In some embodiments, a provided composition comprises about 12-22 weight percent of polyol subcomponent (i-a) (e.g., polycarbonate polyols of formula Q10), about 12-22 weight percent of polyol subcomponent (i-b) (e.g., polycarbonate polyols of formula Q11), and about 61-71 weight percent of polyol subcomponent (ii) (e.g., DEG-AA). In some embodiments, a provided composition comprises about 14-20 weight percent of polyol subcomponent (i-a) (e.g., polycarbonate polyols of formula Q10), about 14-20 weight percent of polyol subcomponent (i-b) (e.g., polycarbonate polyols of formula Q11), and about 63-69 weight percent of polyol subcomponent (ii) (e.g., DEG-AA). In some embodiments, a provided composition comprises about 17 weight percent of polyol subcomponent (i-a) (e.g., polycarbonate polyols of formula Q10), about 17 weight percent of polyol subcomponent (i-b) (e.g., polycarbonate polyols of formula Q11), and about 66 weight percent of polyol subcomponent (ii) (e.g., DEG-AA).

In some embodiments, a provided composition comprises about 12-22 weight percent of polyol subcomponent (i-a) (e.g., polycarbonate polyols of formula Q10), about 61-71 weight percent of polyol subcomponent (i-b) (e.g., polycarbonate polyols of formula Q11), and about 12-22 weight percent of polyol subcomponent (ii) (e.g., DEG-AA). In some embodiments, a provided composition comprises about 14-20 weight percent of polyol subcomponent (i-a) (e.g., polycarbonate polyols of formula Q10), about 63-69 weight percent of polyol subcomponent (i-b) (e.g., polycarbonate polyols of formula Q11), and about 14-20 weight percent of polyol subcomponent (ii) (e.g., DEG-AA). In some embodiments, a provided composition comprises about 17 weight percent of polyol subcomponent (i-a) (e.g., polycarbonate polyols of formula Q10), about 66 weight percent of polyol subcomponent (i-b) (e.g., polycarbonate polyols of formula Q11), and about 17 weight percent of polyol subcomponent (ii) (e.g., DEG-AA).

### I. Polyurethane Compositions

As described above and herein, in some aspects, the present invention encompasses polyurethane compositions derived from compositions provided herein. In some embodiments, the present invention encompasses polyurethane compositions comprising the reaction product of a composition described above and herein and an isocyanate component.

In some embodiments, the present invention encompasses polyurethane compositions comprising the reaction product of an isocyanate-terminated prepolymer, wherein the isocyanate terminated prepolymer is derived from compositions described above and herein.

In some embodiments, a polyurethane composition is a waterborne polyurethane dispersion composition. In some embodiments, a polyurethane composition is a 1-component polyurethane composition. In some embodiments, a polyurethane composition is a 2-component polyurethane composition. In some embodiments, a polyurethane composition is a solvent borne polyurethane composition.

In some embodiments, a polyurethane composition comprises a carboxylic acid moiety within the polyurethane backbone. In some embodiments, the carboxylic acid moiety within the polyurethane backbone is derived from dimethylolpropionic acid (DMPA). In some embodiments, the carboxylic acid moiety within the polyurethane backbone is derived from about 0.5 to about 3.5 weight percent dimethylolpropionic acid (DMPA). In some embodiments, the carboxylic acid moiety within the polyurethane backbone is derived from about 1.5 to about 3.5 weight percent dimethylolpropionic acid (DMPA). In some embodiments, the carboxylic acid moiety within the polyurethane backbone is derived from about 2.5 to about 3.5 weight percent dimethylolpropionic acid (DMPA). In some embodiments, the carboxylic acid moiety within the polyurethane backbone is derived from about 1.5, about 2.0, about 2.5, about 3.0 or about 3.5 weight percent dimethylolpropionic acid (DMPA).

II. Polyurethane Compositions with Improved Properties

Polyurethane compositions of the present invention may be useful in adhesive and coating applications. In some embodiments, a substrate is coated with a polyurethane composition, and the water is evaporated, leaving behind a polyurethane film. The polyurethane film may be lifted from the substrate and its properties measured.

It will be appreciated that within the present disclosure, a reference to a polyurethane composition also refers to a waterborne polyurethane dispersion (PUD), composition, a solvent borne polyurethane composition, a one component polyurethane composition, a two component polyurethane composition, or a hot melt polyurethane composition.

In one aspect, polyurethane compositions of the present invention unexpectedly demonstrate improved performance properties (e.g., strength, flexibility, elongation or combinations thereof), as compared to a reference polyurethane composition. In some embodiments, a reference polyurethane composition is a corresponding polyurethane composition lacking polyol subcomponent (i). In some embodiments, a reference polyurethane composition is a corresponding polyurethane composition lacking polyol subcomponent (ii). In some embodiments, a reference polyurethane composition is a corresponding polyurethane composition composed solely of a polycarbonate polyol. In some embodiments, a reference polyurethane composition is a corresponding polyurethane composition composed solely of a polyether polyol. In some embodiments, a reference polyurethane composition is a corresponding polyurethane composition composed solely of a polyester polyol.

In some embodiments, the improved performance property is tensile strength measure according to ASTM D412. In some embodiments, the improved performance property is tensile elongation measured according to ASTM D412. In some embodiments, the improved performance property is modulus at 100% measured according to ASTM D412. In some embodiments, the improved performance property is modulus at 200% measured according to ASTM D412. In some embodiments, the improved performance property is modulus at 300% measured according to ASTM D412. In some embodiments, the improved property is lap shear strength measured according to ASTM D1002. In some embodiments, the improved property is peel strength measured according to ASTM D1876.

In some embodiments, the present invention provides polyurethane compositions characterized in that the tensile strength measured according to ASTM D412 is improved compared to a reference polyurethane composition. In some embodiments, the present invention provides polyurethane compositions characterized in that the tensile strength measured according to ASTM D412 is at least 10, 20, 30, 40, 50, 60, 70, 80, 90, 100, 125, 150, 200, 250, or 300% greater as compared to a reference polyurethane composition. In some embodiments, the present invention provides polyurethane compositions characterized in that the tensile elongation measured according to ASTM D412 is improved compared to a reference polyurethane composition. In some embodiments, the present invention provides polyurethane compositions characterized in that the tensile elongation measured according to ASTM D412 is at least 10, 20, 30, 40, 50, 60, 70, 80, 90, 100, 125, 150, 200, 250, or 300% greater as compared to a reference polyurethane composition.

In some embodiments, the present invention provides a polyurethane composition characterized in that the tensile strength measured according to ASTM D412 is improved, and the tensile elongation measured according to ASTM D412 is about the same, as compared to a reference polyurethane composition. In some embodiments, the present invention provides a polyurethane composition characterized in that the tensile strength measured according to ASTM D412 is improved by at least 10, 20, 30, 40, 50, 60, 70, 80, 90, 100, 125, 150, 200, 250, or 300%, and the tensile elongation measured according to ASTM D412 is within 10%, as compared to a reference polyurethane composition. In some embodiments, the present invention provides a polyurethane composition characterized in that the tensile strength measured according to ASTM D412 is about the same, and the tensile elongation measured according to ASTM D412 is improved, as compared to a reference polyurethane composition. In some embodiments, the present invention provides a polyurethane composition characterized in that the tensile strength measured according to ASTM D412 is within 10%, and the tensile elongation measured according to ASTM D412 is improved by at least 10, 20, 30, 40, 50, 60, 70, 80, 90, 100, 125, 150, 200, 250, or 300%, as compared to a reference polyurethane composition. In some embodiments, the present invention provides a polyurethane composition characterized in that the tensile strength measured according to ASTM D412 and the tensile elongation measured according to ASTM D412 are improved, as compared to a reference polyurethane composition.

In some embodiments, the present invention provides a polyurethane composition characterized in that the tensile strength measured according to ASTM D412 is at least 10, 20, 30, 40, 50, 60, 70, 80, 90, 100, 125, 150, 200, 250, or 300% greater, and the tensile elongation measured according to ASTM D412 is about the same, as compared to a reference polyurethane composition. In some embodiments, the present invention provides a polyurethane composition characterized in that the tensile strength measured according to ASTM D412 is about the same, and the tensile elongation measured according to ASTM D412 is at least 10, 20, 30, 40, 50, 60, 70, 80, 90, 100, 125, 150, 200, 250, or 300% greater, as compared to a reference polyurethane composition. In some embodiments, the present invention provides a polyurethane composition characterized in that the tensile strength measured according to ASTM D412 is at least 10, 20, 30, 40, 50, 60, 70, 80, 90, 100, 125, 150, 200, 250, or 300% greater, and the tensile elongation measured according to ASTM D412 is at least 10, 20, 30, 40, 50, 60, 70, 80, 90, 100, 125, 150, 200, 250, or 300% greater, as compared to a reference polyurethane composition.

In some embodiments, the present invention provides a polyurethane composition characterized in that the modulus at 100% measured according to ASTM D412 is at least 10, 20, 30, 40, 50, 60, 70, 80, 90, 100, 125, 150, 200, 250, or 300% greater, as compared to a reference polyurethane composition. In some embodiments, the present invention provides a polyurethane composition characterized in that the modulus at 200% measured according to ASTM D412 is at least 10, 20, 30, 40, 50, 60, 70, 80, 90, 100, 125, 150, 200, 250, or 300% greater, as compared to a reference polyurethane composition. In some embodiments, the present invention provides a polyurethane composition characterized in that the modulus at 300% measured according to ASTM D412 is at least 10, 20, 30, 40, 50, 60, 70, 80, 90, 100, 125, 150, 200, 250, or 300% greater, as compared to a reference polyurethane composition.

In some embodiments, the present invention provides polyurethane compositions characterized in that the lap shear strength measured according to ASTM D1002 is improved compared to a reference polyurethane composition. In some embodiments, the present invention provides polyurethane compositions characterized in that the lap shear strength measured according to ASTM D1002 is at least 10, 20, 30, 40, 50, 60, 70, 80, 90, 100, 125, 150, 200, 250, or 300% greater as compared to a reference polyurethane composition. In some embodiments, the present invention provides polyurethane compositions characterized in that the peel strength measured according to ASTM D1876 is improved compared to a reference polyurethane composition. In some embodiments, the present invention provides polyurethane compositions characterized in that the peel strength measured according to ASTM D1876 is at least 10, 20, 30, 40, 50, 60, 70, 80, 90, 100, 125, 150, 200, 250, or 300% greater as compared to a reference polyurethane composition.

In some embodiments, the present invention provides a polyurethane composition characterized in that it is about the same density as compared to a reference polyurethane composition.

### III. Methods of Improving Properties of Polyurethane Compositions

In another aspect, the present invention encompasses methods of improving a performance property of a polyurethane compositions comprising the reaction product of a polyol component and a polyisocyanate component, the method comprising the step of incorporating into the polyol component:
polyol subcomponent (i), which comprises one or more polycarbonate or polyether carbonate polyols derived from copolymerization of carbon dioxide and one or more epoxides; and
polyol subcomponent (ii), which comprises one or more polyether or polyester polyols, wherein the polyether or polyester polyols comprise a repeating tetramethylene unit.

It will be appreciated that within the present disclosure, a reference to a polyurethane composition also refers to a waterborne polyurethane dispersion (PUD) composition, a solvent borne polyurethane composition, a one component polyurethane composition, a two component polyurethane composition, or a hot melt polyurethane composition.

In one aspect, methods of the present invention unexpectedly demonstrate improved performance properties (e.g., strength, flexibility, elongation or a combination thereof) of polyurethane compositions, as compared to a reference polyurethane composition. In some embodiments, a reference polyurethane composition is a corresponding polyurethane composition lacking polyol subcomponent (i). In some embodiments, a reference polyurethane composition is a corresponding polyurethane composition lacking polyol subcomponent (ii). In some embodiments, a reference polyurethane composition is a corresponding polyurethane composition composed solely of a polycarbonate polyol. In some embodiments, a reference polyurethane composition is a corresponding polyurethane composition composed solely of a polyether polyol. In some embodiments, a reference polyurethane composition is a corresponding polyurethane composition composed solely of a polyester polyol.

In some embodiments, the improved performance property is tensile strength measure according to ASTM D412. In some embodiments, the improved performance property is tensile elongation measured according to ASTM D412. In some embodiments, the improved performance property is modulus at 100% measured according to ASTM D412. In some embodiments, the improved performance property is modulus at 200% measured according to ASTM D412. In some embodiments, the improved performance property is modulus at 300% measured according to ASTM D412. In some embodiments, the improved property is lap shear strength measured according to ASTM D1002. In some embodiments, the improved property is peel strength measured according to ASTM D1876.

In some embodiments, the present invention provides methods of improving the tensile strength measured according to ASTM D412 of a polyurethane composition compared to a reference polyurethane composition. In some embodiments, the present invention provides methods of improving the tensile strength measured according to ASTM D412 of a polyurethane composition by at least 10, 20, 30, 40, 50, 60, 70, 80, 90, 100, 125, 150, 200, 250, or 300% as compared to a reference polyurethane composition. In some embodiments, the present invention provides methods of improving the tensile elongation measured according to ASTM D412 of a polyurethane composition compared to a reference polyurethane composition. In some embodiments, the present invention provides methods of improving the tensile elongation measured according to ASTM D412 of a polyurethane composition by at least 10, 20, 30, 40, 50, 60, 70, 80, 90, 100, 125, 150, 200, 250, or 300% as compared to a reference polyurethane composition.

In some embodiments, the present invention provides methods of improving the tensile strength measured according to ASTM D412 of a polyurethane composition as compared to a reference polyurethane composition, and the tensile elongation measured according to ASTM D412 of the polyurethane composition is about the same, as compared to a reference polyurethane composition. In some embodiments, the present invention provides methods of improving the tensile elongation measured according to ASTM D412 of a polyurethane composition as compared to a reference polyurethane composition, and the tensile strength measured according to ASTM D412 of the polyurethane composition is about the same, as compared to a reference polyurethane composition. In some embodiments, the present invention provides methods of improving the tensile strength measured according to ASTM D412 and the tensile elongation measured according to ASTM D412 of a polyurethane composition, as compared to a reference polyurethane composition.

In some embodiments, the present invention provides methods of improving the tensile strength measured according to ASTM D412 of a polyurethane composition by at least 10, 20, 30, 40, 50, 60, 70, 80, 90, 100, 125, 150, 200, 250, or 300% greater as compared to a reference polyurethane composition, and the tensile elongation measured according to ASTM D412 of the polyurethane composition is about the same as compared to a reference polyurethane composition. In some embodiments, the present invention provides methods of improving the tensile strength measured according to ASTM D412 of a polyurethane composition by at least 10, 20, 30, 40, 50, 60, 70, 80, 90, 100, 125, 150, 200, 250, or 300% greater as compared to a reference polyurethane composition, and the tensile elongation measured according to ASTM D412 of the polyurethane composition is within about 10% as compared to a reference polyurethane composition. In some embodiments, the present invention provides methods of improving the tensile elongation measured according to ASTM D412 of the polyurethane composition by at least 10, 20, 30, 40, 50, 60, 70, 80, 90, 100, 125, 150, 200, 250, or 300% as compared to a reference polyurethane composition, and the tensile strength measured according to ASTM D412 of the polyurethane composition is about the same as compared to a reference polyurethane composition. In some embodiments, the present invention provides methods of improving the tensile elongation measured according to ASTM D412 of the polyurethane composition by at least 10, 20, 30, 40, 50, 60, 70, 80, 90, 100, 125, 150, 200, 250, or 300% as compared to a reference polyurethane composition, and the tensile strength measured according to ASTM D412 of the polyurethane composition is within about 10% as compared to a reference polyurethane composition. In some embodiments, the present invention provides methods of improving the tensile strength measured according to ASTM D412 of a polyurethane composition by at least 10, 20, 30, 40, 50, 60, 70, 80, 90, 100, 125, 150, 200, 250, or 300% as compared to a reference polyurethane composition, and the tensile elongation measured according to ASTM D412 of the polyurethane composition by at least 10, 20, 30, 40, 50, 60, 70, 80, 90, 100, 125, 150, 200, 250, or 300% greater as compared to a reference polyurethane composition.

In some embodiments, the present invention provides methods of improving the modulus at 100% measured according to ASTM D412 of the polyurethane composition by at least 10, 20, 30, 40, 50, 60, 70, 80, 90, 100, 125, 150, 200, 250, or 300% greater, as compared to a reference polyurethane composition. In some embodiments, the present invention provides methods of improving the modulus at 200% measured according to ASTM D412 of the polyurethane composition by at least 10, 20, 30, 40, 50, 60, 70, 80, 90, 100, 125, 150, 200, 250, or 300% greater, as compared to a reference polyurethane composition. In some embodiments, the present invention provides methods of improving the modulus at 300% measured according to ASTM D412 of the polyurethane composition at least 10, 20, 30, 40, 50, 60, 70, 80, 90, 100, 125, 150, 200, 250, or 300% greater, as compared to a reference polyurethane composition. In some embodiments, the present invention provides methods of improving the lap shear strength measured according to ASTM D1002 of the polyurethane composition at least 10, 20, 30, 40, 50, 60, 70, 80, 90, 100, 125, 150, 200, 250, or 300% greater, as compared to a reference polyurethane composition. In some embodiments, the present invention provides methods of improving the peel strength measured according to ASTM D1876 of the polyurethane composition at least 10, 20, 30, 40, 50, 60, 70, 80, 90, 100, 125, 150, 200, 250, or 300% greater, as compared to a reference polyurethane composition.

In some embodiments, the present invention provides methods characterized in that the polyurethane composition has about the same density as compared to a reference polyurethane composition.

### IV. Methods for Producing Polyurethane Compositions

In some aspects, the present invention encompasses methods of producing a polyurethane composition, the method comprising the steps of:
(a) providing an A-side composition comprising one or more isocyanate reagents;
(b) providing a B-side composition comprising:
   polyol subcomponent (i), which comprises one or more polycarbonate or polyether carbonate polyols derived from copolymerization of carbon dioxide and one or more epoxides; and
   polyol subcomponent (ii), which comprises a polyether or polyester polyol; and
(c) mixing the A-side composition and the B-side composition and allowing the mixture to cure into the polyurethane composition.

It will be appreciated that within the present disclosure, a reference to a polyurethane composition also refers to a waterborne polyurethane dispersion (PUD) composition, a solvent borne polyurethane composition, a one component polyurethane composition, a two component polyurethane composition, or a hot melt polyurethane composition.

In some aspects, the present invention encompasses methods of producing a polyurethane composition, the method comprising the steps of:
(a) providing an isocyanate-terminated prepolymer composition derived from a composition as described above and herein; and
(b) allowing the composition to cure into a polyurethane composition.

In some embodiments, methods of producing polyurethane compositions further comprise the step of providing between about 0.5 and about 2.5 weight percent dimethylol propionic acid (DMPA). In some embodiments, methods of producing polyurethane compositions further comprise the step of providing between about 0.75 and about 2.25 weight percent dimethylol propionic acid (DMPA). In some embodiments, methods of producing polyurethane compositions further comprise the step of providing between about 1.0 and about 2.0 weight percent dimethylol propionic acid (DMPA). In some embodiments, methods of producing polyurethane compositions further comprise the step of providing between about 1.25 and about 1.75 weight percent dimethylol propionic acid (DMPA). In some embodiments, methods of producing polyurethane compositions further comprise the step of providing between about 0.75 and about 1.0 weight percent dimethylol propionic acid (DMPA). In some embodiments, methods of producing polyurethane compositions further comprise the step of providing between about 1.0 and about 1.5 weight percent dimethylol propionic acid (DMPA). In some embodiments, methods of producing polyurethane compositions further comprise the step of providing between about 1.5 and about 2.0 weight percent dimethylol propionic acid (DMPA). In some embodiments, methods of producing polyurethane compositions further comprise the step of providing between about 1.75 and about 2.25 weight percent dimethylol propionic acid (DMPA). In some embodiments, methods of producing polyurethane compositions further comprise the step of providing between about 2.0 and about 2.5 weight percent dimethylol propionic acid (DMPA).

Polyurethane compositions of the present invention may be prepared according to the scheme depicted in FIG. 1. In some embodiments, T1 is 110° C. In some embodiments, T2 is 95° C. In some embodiments, T3 is 70° C. In some embodiments, T4 is 45° C. In some embodiments, T5 is 10° C. In some embodiments, catalysts are not added. In some embodiments, the solvent is methyl ethyl ketone (MEK). In some embodiments, the base is triethylamine (TEA). In some embodiments, the chain extender is 1,2-ethylene diamine (EDA).

### V. Coatings With Improved Properties

In some embodiments, the present invention provides polyurethane compositions for use as coatings. In some embodiments, the present invention provides polyurethane coating compositions.

It will be appreciated that within the present disclosure, a reference to a polyurethane composition also refers to a waterborne polyurethane dispersion (PUD) composition, a solvent borne polyurethane composition, a one component polyurethane composition, a two component polyurethane composition, or a hot melt polyurethane composition. It will also be appreciated that within the present disclosure, a reference to a polyurethane coating composition also refers to a waterborne polyurethane dispersion (PUD) coating composition, a solvent borne polyurethane composition, a one component polyurethane composition, a two component polyurethane composition, or a hot melt polyurethane composition. In some embodiments, a polyurethane coating composition is a waterborne polyurethane dispersion (PUD) coating composition. In some embodiments, a polyurethane coating composition is a one component polyurethane composition. In some embodiments, a polyurethane coating composition is a two component polyurethane composition. In some embodiments, a polyurethane coating composition is a hot melt polyurethane composition.

Polyurethane coating compositions of the present invention may exhibit improved performance as defined herein, for example they may exhibit improved hardness, flexibility, corrosion resistance and/or outdoor durability. The cured coatings resulting from compositions present invention may exhibit a broad range of protective properties like one or more of: excellent hardness, flexibility, processability, resistance against solvent, stain, corrosion and/or dirt pick up, hydrolytic stability against humidity and/or sterilization and/or outdoor durability.

Such improved properties may be in at least one, preferably a plurality, more preferably three of more of those properties labeled numerically below. Preferred polymers and/or compositions and/or coating compositions may exhibit comparable properties in one or more, preferably a plurality, more preferably three or more, most preferably in the rest of those properties labelled numerically herein.

A. Properties

1. Hardness

Hardness (Konig, Persoz and/or pencil hardness measured as described DIN 53157/1-87 (Konig), DIN 53157/11-87 (Persoz) and/or ISO 3270-1984, DIN EN 13523-4, ECCA T4 and/or ISO 15184:1998 (pencil hardness) and/or otherwise as described herein).

2. Flexibility

Flexibility (may be measured using the T-bend test as described in European standard EN 13523-7:2001 and/or otherwise as described herein).

3. Corrosion Resistance

Corrosion resistance (measured as described herein) is visually determined as described herein and rated from 1-5.

4. Hydrolysis Resistance

Hydrolysis resistance (according to the methods described herein to determine hydrolysis of coatings as described herein). Hydrolysis resistance is a general property useful for all coatings while sterilization is usually only useful for specific types of coatings such as those used to coat cans.

5. Outdoor Durability

Outdoor durability (for example with respect to UV-A and UV-B resistance such as in the QUV-test (a laboratory simulation of the damaging forces of weather, for the purpose of predicting the relative durability of coatings/materials exposed to the outdoor environment and described in ASTMG 53-95 and/or otherwise as described herein)).

6. Chemical Resistance

Chemical resistance (to methyl ethyl ketone (MEK) in the MEK double rubs test as described herein).

B. Application Tests

1. Visual Rating Scale

The degree of damage to a coating in various tests herein is determined visually based on the following ratings where 5 is the best and 0 is the worse:
5=very good: no visible damage or degradation/discoloration;
4=only slight visible damage or haze/blooming;
3=clear haze/blooming or damage;
2=coating partially dissolved;
1=coating is almost completely dissolved;
0=very poor: coating is completely dissolved.

2. Surface Hardness (Konig Hardness)

Konig hardness is determined following DIN 53157 NEN5319 using Erichsen hardness measuring equipment. The values are given in seconds and the higher the value is the harder is the coating. A Koenig hardness above 100 and combined with a T-bend of 1T or lower is considered very good.

3. Surface Hardness (Pencil Hardness)

Pencil hardness was determined following ISO 15184:1998 using a set of KOH-I-NOR drawing pencils in the following range: 6B-5B-4B-3B-2B-B-HB-F-H-2H-3H-4H-5H-6H (soft to hard). The hardest lead which does not penetrate the coating determines the degree of hardness. The minimum needed hardness is 1H. When at least 3H is obtained combined with a T-bend of 1T or lower, this is considered very good.

4. Flexibility (T-Bend)

May be measured using the T-bend test as described in European standard EN 13523-7:2001. A T-bend of 1T or lower is considered very flexible. In general a flexibility 1.5T or lower is aimed for.

5. Chemical Resistance (MEK Rubs)

The degree of cross-linking of a coating is determined by means of its resistance against wiping a cloth which is wetted with a strong organic solvent. The apparatus used is a DJH Designs MEK rub test machine and Greenson 4×4 pads. The reagent used is methyl ethyl ketone (MEK). The coated panel to be tested is at least 13×3 cm and is taped or clamped onto the machine. The pad is wetted automatically with approx 2 mL MEK. The wet pad is moved automatically over a length of about 12 cm forwards and backward in one movement, which is repeated continuously with a pressure of 3 kg and a cycle time of about 1 second. One double rub is one cycle and the procedure is repeated for 100 cycles or until the coating is ruptured or dissolved and the bare metal (or the primer layer) becomes visible. Matt coatings become glossy during the MEK test but this is not rated as coating damage. After the test the coating is visually examined in the middle of the rubbed area and given a rating from 5 to 1 as indicated above. To be acceptable for use in many applications typically coatings have chemical resistance of at least 100 MEK double rubs. For coating cans MEK resistance is not a relevant criteria.

6. Outdoor Durability (QUV Test)

The QUV-test is a laboratory simulation of the damaging forces of weather, for the purpose of predicting the relative durability of coatings/materials exposed to the outdoor environment according to ASTMG 53-95. Apparatus used is a Q.U.V. accelerated weathering tester and eight fluorescent UV-B 313 lamps. Reagent used is demineralised water. Test panels/materials of 75×150 mm size were coated with the test coatings and exposed to test cycles for four hours of UV radiation at 50° C., relative humidity 40%. The test panels/materials are mounted in the specimen racks with the test surfaces facing the UV lamps. Empty spaces are filled with blank panels to maintain the test conditions within the chamber. The total time of exposure is measured by the apparatus. The gloss 20°, 600 and L*, a*, b* values are measured and the test is finished when for high gloss coatings: 20° gloss is <20% and for semi gloss coatings: 600 gloss is 50% of original gloss. According to ECCA T10, 2000 hrs QUV-A is obtained for a good outdoor durable system. According to ECCA T10, 1000 hrs QUV-B is obtained for a good outdoor durable system.

C. Hardness

In some embodiments, a polyurethane composition is characterized in that, after curing, the polyurethane composition has a higher Konig hardness relative to a corresponding polyurethane composition that lacks polyol subcomponent (i), wherein the Konig hardness is measured in accordance with DIN 53157/1-87. In some embodiments, a polyurethane composition is characterized in that, after curing, the polyurethane composition has a Konig hardness that is at least 10%, at least 20%, at least 30%, at least 40%, at least 50%, at least 75%, at least 100%, or at least 200%, higher relative to a corresponding polyurethane composition that lacks polyol subcomponent (i), wherein the Konig hardness is measured in accordance with DIN 53157/1-87.

In some embodiments, a polyurethane composition is characterized in that, after curing, the polyurethane composition has a higher Persoz hardness relative to a corresponding polyurethane composition that lacks polyol subcomponent (i), wherein the Persoz hardness is measured in accordance with DIN 53157/11-87. In some embodiments, a polyurethane composition is characterized in that, after curing, the coating composition has a Persoz hardness that is at least 10%, at least 20%, at least 30%, at least 40%, at least 50%, at least 75%, at least 100%, or at least 200%, higher relative to a corresponding polyurethane composition that lacks polyol subcomponent (i), wherein the Persoz hardness is measured in accordance with DIN 53157/11-87.

In some embodiments, a polyurethane composition is characterized in that, after curing, the polyurethane composition has a higher Pencil hardness relative to a corresponding PUD composition that lacks polyol subcomponent (i), wherein the Pencil hardness is measured in accordance with ISO 15184:1998. In some embodiments, a polyurethane composition is characterized in that, after curing, the polyurethane composition has a Pencil hardness that is at least 10%, at least 20%, at least 30%, at least 40%, at least 50%, at least 75%, at least 100%, or at least 200%, higher relative to a corresponding polyurethane composition that lacks polyol subcomponent (i), wherein the Pencil hardness is measured in accordance with ISO 15184:1998.

D. Flexibility

In some embodiments, a polyurethane composition is characterized in that, after curing, the polyurethane composition has a lower T-bend flexibility relative to a corresponding PUD composition that lacks polyol subcomponent (i), wherein the T-bend flexibility is measured in accordance with EN 13523-7:2001. In some embodiments, a polyurethane composition is characterized in that, after curing, the polyurethane composition has a T-bend flexibility that is at least 10%, at least 20%, at least 30%, at least 40%, at least 50%, at least 75%, or about 100% lower relative to a corresponding polyurethane composition that lacks polyol subcomponent (i), wherein the T-bend flexibility is measured in accordance with EN 13523-7:2001.

E. Corrosion Resistance

In some embodiments, a polyurethane composition is characterized in that, after curing, the polyurethane composition has a higher corrosion resistance relative to a corresponding polyurethane composition that lacks polyol subcomponent (i), wherein the corrosion resistance is measured as described above. In some embodiments, a polyurethane composition is characterized in that, after curing, the polyurethane composition has a corrosion resistance that is at least 10%, at least 20%, at least 30%, at least 40%, at least 50%, at least 75%, or about 100% lower relative to a corresponding polyurethane composition that lacks polyol subcomponent (i), wherein the corrosion resistance is measured as described above.

F. Hydrolysis Resistance

In some embodiments, a polyurethane composition is characterized in that, after curing, the polyurethane composition has an improved hydrolysis resistance relative to a corresponding polyurethane composition that lacks polyol subcomponent (i), wherein the hydrolysis resistance is measured as described above. In some embodiments, a polyurethane composition is characterized in that, after curing, the polyurethane composition has a hydrolysis resistance that is at least 10%, at least 20%, at least 30%, at least 40%, at least 50%, at least 75%, or about 100% lower relative to a corresponding polyurethane composition that lacks polyol subcomponent (i), wherein the hydrolysis resistance is measured as described above.

G. Outdoor Durability

In some embodiments, a polyurethane composition is characterized in that, after curing, the polyurethane composition has an improved outdoor durability relative to a corresponding polyurethane composition that lacks polyol subcomponent (i), wherein the outdoor durability is measured in accordance with the QUV-test. In some embodiments, a polyurethane composition is characterized in that, after curing, the polyurethane composition has an outdoor durability that is at least 10%, at least 20%, at least 30%, at least 40%, at least 50%, at least 75%, or about 100% lower relative to a corresponding polyurethane composition that lacks polyol subcomponent (i), wherein the outdoor durability is measured in accordance with the QUV-test.

H. Chemical Resistance

In some embodiments, a polyurethane composition is characterized in that, after curing, the polyurethane composition has an improved chemical resistance relative to a corresponding polyurethane composition that lacks polyol subcomponent (i), wherein the chemical resistance is measured in accordance with the salt-spray test described above. In some embodiments, a polyurethane composition is characterized in that, after curing, the polyurethane composition has a chemical resistance that is at least 10%, at least 20%, at least 30%, at least 40%, at least 50%, at least 75%, or about 100% lower relative to a corresponding polyurethane composition that lacks polyol subcomponent (i), wherein the chemical resistance is measured in accordance with the salt-spray test described above.

### VI. Adhesives With Improved Properties

In another aspect, a polyurethane composition of the present invention is an adhesive composition. In certain embodiments, the polyurethane adhesive compositions comprise the reaction product of an isocyanate component and a composition, as described above and herein; or an isocyanate-terminated prepolymer composition as described above and herein.

It will be appreciated that within the present disclosure, a reference to a polyurethane composition also refers to a waterborne polyurethane dispersion (PUD) composition, a solvent borne polyurethane composition, a one component polyurethane composition, a two component polyurethane composition, or a hot melt polyurethane composition. It will also be appreciated that within the present disclosure, a reference to a polyurethane adhesive composition also refers to a waterborne polyurethane dispersion (PUD) adhesive composition, a solvent borne polyurethane composition, a one component polyurethane composition, a two component polyurethane composition, or a hot melt polyurethane composition. In some embodiments, a polyurethane adhesive composition is a waterborne polyurethane dispersion (PUD) coating composition. In some embodiments, a polyurethane adhesive composition is a one component polyurethane composition. In some embodiments, a polyurethane adhesive composition is a two component polyurethane composition. In some embodiments, a polyurethane adhesive composition is a hot melt polyurethane composition.

A. Reactive 1-Component Polyurethane Adhesives

In one aspect, the present invention encompasses reactive one-component adhesives. In certain embodiments, such one-component adhesives compositions are derived from a composition as defined above and in the embodiments and examples herein.

In certain embodiments the one-component adhesives are prepolymers made with one or more polyols; these prepolymers typically have low isocyanate values and are produced by reacting an excess of isocyanate with a relatively high molecular weight polyol. These adhesives are typically cured with water which can be added or which is present in the atmosphere or the material being bonded.

In some embodiments, MDI is the isocyanate reacted with a polyol component as described above. In some embodiments requiring unique adhesive performance properties, TDI and/or aliphatic isocyanates are used in place of, or in addition to, MDI. In some embodiments, isophorone diisocyanate (IPDI) is the isocyanate reacted with a polyol component described above and herein.

In certain embodiments the one component adhesives comprise 100% solids (e.g. no solvent is present at the time of application). In certain embodiments, the one component adhesives formulations may be dissolved, dispersed, and/or emulsified in a solvent or water to reduce viscosity or otherwise improve the applicability of the one component adhesive in these applications.

In certain embodiments no catalysts are used. In certain embodiments catalysts are included in the formulation to increase the reaction rate of free isocyanate and water.

In certain embodiments, hydroxyethyl acrylate groups may be included in the polycarbonate polyol, other polyols, and/or the derivative prepolymers to introduce ultraviolet light curing properties.

In certain embodiments, fatty acid groups and/or other molecules with unsaturation functionality may be included in polyols and/or the derivative prepolymers to enable cross linking via oxidation.

In certain embodiments, the 1-component adhesive mixture forms a final, cured polyurethane adhesive with the following composition:
1-80 parts by weight of one or more isocyanate components or pre-polymers based on isocyanate components as described above and in the specific embodiments and examples herein;
20-99 parts by weight of a polyol component (or a polyol-based pre-polymer component) described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

B. Reactive 2-Component Polyurethane Adhesives

In another aspect, the present invention encompasses reactive two-component adhesive compositions. In certain embodiments, such two-component adhesive compositions are derived from a composition as defined above and in the embodiments and examples herein.

In certain embodiments the two-component adhesives include prepolymers derived from one or more polyols. These prepolymers can be produced with excess isocyanate and/or excess hydroxyl content and are then mixed with one or more of the isocyanates, polyols, and other components described above.

In certain embodiments, the two-component adhesives are formulated to an isocyanate index range of 90 to 150. In certain embodiments, isocyanate indexes above 100 are used to increase hardness of the adhesive and to improve bonding to substrates, in particular those substrates with hydroxyl groups on their surfaces. In certain embodiments, isocyanate indexes below 100 are used to produce softer and more flexible adhesives.

In certain embodiments, MDI is the isocyanate used in the formulation of the two-component adhesives. In certain embodiments, TDI is the isocyanate used in the formulation of the two-component adhesives. In certain embodiments, IPDI is the isocyanate used in the formulation of the two-component adhesives. In certain embodiments, these isocyanates have a functionality greater than two, and may be polymeric. In certain embodiments, other isocyanates are used, including aliphatic isocyanates in cases where resistance to ultraviolet light is a requirement.

In certain embodiments, the two-component adhesives are formulated with isocyanates and/and or polyols which are 2.0 functional or lower. In certain embodiments the adhesives are formulated with isocyanates and/or polyols functionality greater than 2.0 (in other words, some degree of branching) to introduce cross-linking in the cured two-component adhesives. In certain embodiments, the total level of crosslinking is relatively high to produce adhesives with high modulus, high hardness, and good tensile, shear stress, and peel strength properties. In certain embodiments, the total level of crosslinking is relatively low to produce adhesives with greater elasticity.

In certain embodiments the two-component adhesives are applied as 100% solids. In certain embodiments, the two component adhesives may be dissolved, dispersed, and/or emulsified in a solvent or water to reduce viscosity or otherwise improve their applicability. In certain embodiments, solvents such as acetone, methyl ethyl ketone, ethylacetate, toluene, or xylene are preferred.

In certain embodiments no fillers are present in the two-component adhesives. In other embodiments calcium carbonate, talc, clays, or the like are added as fillers to control rheology, reduce shrinkage, reduce cost, and/or for other reasons. In certain embodiments the two-component adhesives include thixotropic agents, flow agents, film-forming additives, and/or catalysts to achieve the processing and finished adhesives properties required.

In certain embodiments, the 2-component adhesive mixture forms a final, cured polyurethane adhesive with the following composition:
10-40 parts by weight of one or more isocyanate components or pre-polymers based on isocyanate components as described above and in the specific embodiments and examples herein;
60-90 parts by weight of a polyol component (or a polyol-based pre-polymer component) described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

C. Hot-Melt Polyurethane Adhesives

In one aspect, the present invention also encompasses reactive hot melt adhesives. In certain embodiments, such reactive hot melt adhesive compositions are derived from a composition as defined above and in the embodiments and examples herein. In some embodiments, a polyurethane composition for use in a hot melt adhesive comprises a composition described above and herein.

In certain embodiments the hot-melt adhesives include prepolymers derived from one or more polyols. These prepolymers can be produced with excess isocyanate and/or excess hydroxyl content and are then mixed with one or more of the isocyanates, polyols, and other components described above. In certain embodiments the molar ratio of isocyanate to polyol is between 1.5:1 and 4:1, preferably between 1.9:1 and 3:1, and often very near 2:1.

In certain embodiments, MDI is the isocyanate to react with a polyol component as described above. In certain embodiments, IPDI is the isocyanate to react with a polyol component as described above. In certain embodiments requiring unique hot melt adhesive performance properties, TDI and/or aliphatic isocyanates are used in place of or in addition to MDI.

In certain embodiments the reactive hot melt adhesive prepolymers are produced by reacting an excess of isocyanate with a relatively high molecular weight polyol. These prepolymers thus have an excess of isocyanate, or “free” isocyanate groups, which react with atmospheric moisture to improve the finished properties of the reactive hot melt adhesive. In certain embodiments the amount of free isocyante is about 1-5 percent by weight.

In certain embodiments the polyols, isocyanates, and/or prepolymers comprising the primary components of the reactive hot melt adhesive are formulated such that the viscosity of the adhesive formulation is sufficiently low at the application temperature to enable efficient application to the substrate. The reactive hot melt viscosity increases as it cools to rapidly provide good adhesive properties.

In certain embodiments, the reactive hot melt polyurethane adhesive mixture forms a final, cured polyurethane adhesive with the following composition:
5-40 parts by weight of one or more isocyanate components or pre-polymers based on isocyanate components as described above and in the specific embodiments and examples herein;
60-95 parts by weight of a polyol component or a polyol-based pre-polymer component described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

D. Non-Reactive Solvent-Borne Polyurethane Adhesive

In another aspect, the present invention encompasses non-reactive solvent-borne adhesives. In certain embodiments, such solvent-borne adhesives compositions are derived a composition comprising a composition as defined above and in the embodiments and examples herein.

In some embodiments, a polyurethane composition for use in a non-reactive solvent-borne adhesive comprises a composition described above and herein.

In certain embodiments the solvent-borne adhesives are produced by reacting one or more polyols with one or more isocyanates and/or all other additives described above to create higher molecular weight prepolymers and/or polyurethane adhesives. These high molecular weight polyurethanes are then dissolved in one or more solvents for application onto various substrates. In these embodiments the solvent-borne adhesive is described as a one-component system. Additional fillers and performance enhancing additives may be included in the formulation.

In certain embodiments, solvent-borne cross-linkers are added to solvent-born polyurethane adhesives as described above to improve the strength and resistance of the finished adhesive. The crosslinkers may be any combination polyols and isocyanates described above and may also be other types of thermosetting components. In these embodiments the solvent-borne adhesive is described as a two-component reactive system and are thus similar and/or equivalent to the two-component reactive adhesives described above, in the embodiments in which these systems are dissolved in one or more solvents.

In certain embodiments, the non-reactive solvent-borne adhesive mixture forms a final, cured polyurethane adhesive with the following composition:
5-30 parts by weight of one or more isocyanate components or pre-polymers based on isocyanate components as described above and in the specific embodiments and examples herein;
70-95 parts by weight of a polyol component (or a polyol-based pre-polymer component) described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

E. Non-Reactive Water-Borne Adhesive

In one aspect, the present invention encompasses reactive water-borne adhesives. In certain embodiments, such water-borne adhesive compositions are derived from a composition as defined above and in the embodiments and examples herein.

In certain embodiments the water-borne adhesives are produced by reacting one or more polyols with one or more isocyanates and/or all other additives described above to create higher molecular weight prepolymers and/or polyurethane adhesives, which are then dispersed in water and known as polyurethane dispersions (PUDs). In certain embodiments, they may contain low levels of solvents to help stabilize the polymers in water.

In certain embodiments, the solids content of the final PUD adhesive is in the range of 25-75%, preferably in the range of 35-50%. In certain embodiments, the water-borne adhesives are formulated to be on the very high or low end of these ranges depending on viscosity requirements, other processing considerations, and finished adhesive properties required.

In certain embodiments, water-borne cross-linkers are added to water-born PUDs as described above to improve the performance of the finished adhesive. The crosslinkers may be any combination of polyols and isocyanates described above and may also be other types of thermosetting components. In these embodiments the water-borne adhesive is akin to the two-component reactive system described above (except it is dispersed in an aqueous system) in the embodiments in which these systems are dispersed or emulsified in water.

In certain embodiments, the non-reactive water-borne adhesive mixture forms a final, cured polyurethane adhesive with the following composition:
20-50 parts by weight of one or more isocyanate components or pre-polymers based on isocyanate components as described above and in the specific embodiments and examples herein;
50-80 parts by weight of a polyol component (or a polyol-based pre-polymer component) described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

F. Non-Reactive Hot Melt Adhesives

In one aspect, the present invention encompasses non-reactive hot melt adhesives. In certain embodiments, such non-reactive hot melt adhesives compositions are derived from a composition as defined above and in the embodiments and examples herein. In some embodiments, a polyurethane composition for use in a hot melt adhesive comprises a composition described above and herein.

In certain embodiments the non-reactive hot melt adhesives are produced by reacting one or more polyols with one or more isocyanates an and/or all other additives described above to create higher molecular weight polymers and/or polyurethane adhesives. Additional fillers and performance enhancing additives may be included in the formulation.

In certain embodiments the polyols, isocyanates, prepolymers and/or polyurethane adhesives comprising the primary components of the non-reactive hot melt adhesive are formulated such that the viscosity of the adhesive formulation is sufficiently low at the application temperature to enable efficient application to the substrate. The non-reactive hot melt viscosity increases as it cools to rapidly provide good adhesive properties. In certain applications, they are formulated to have melt viscosities between 25,000 and 500,000 mPa*s, more preferable between 50,000 to 250,000 mPa*s.

In certain embodiments, the non-reactive hot-melt adhesive mixture forms a final, cured polyurethane adhesive with the following composition:
1-80 parts by weight of one or more isocyanate components or pre-polymers based on isocyanate components as described above and in the specific embodiments and examples herein;
20-99 parts by weight of a polyol component (or a polyol-based pre-polymer component) described above and in the specific embodiments and examples herein;
0 to 1 parts by weight of one or more catalysts as described above and in the specific embodiments and examples herein;
0 to 20 parts by weight of one or more chain extenders, wherein the chain extenders molecules are substantially as described above and in the specific embodiments and examples herein; and
0 to 10 parts by weight of one or more additives, wherein the additives are selected from the group consisting of: fillers, clays, blocking agents, stabilizers, thixotropic materials, plasticizers, compatibilizers, colorants, UV stabilizers or flame retardants as described above and in the specific embodiments and examples herein.

G. Hybrid Systems

In certain embodiments, any of the above reactive and non-reactive adhesive formulations are combined with other adhesive chemistries in hybrid systems. In certain embodiments, the finished adhesives are urethane acrylic systems which can take a number of forms, including aqueous systems using water-dispersable isocyanates with PUDs and acrylic emulsion polymers, mixing acrylic and hydroxyl polyols to create co-polymerized resins, and the like. In certain embodiments, vinyl-terminated acrylic polymers are used to improve impact resistance. In certain embodiments, polyurethanes with acrylic functionality are also used in anaerobic or radiation-cured adhesives to increase toughness. In certain embodiments, urethanes are combined with epoxy chemistries using amine curing systems to create fast-curing adhesives for structural and heavy duty applications.

H. Improved High Temperature Strength

Adhesives provided by the present invention have unique and unexpected properties. In certain embodiments, the present invention encompasses adhesives comprising a polyurethane composition as described herein, and characterized in that the cured adhesives have unexpectedly high strength at elevated temperatures. The high strength at elevated temperature can be demonstrated by measuring the strength of the cured adhesive strength on metal substrate using the ASTM D1002 lap sheer test at ambient temperature and then performing the same measurement at one or more elevated temperatures.

In some embodiments, a reference polyurethane composition is a corresponding polyurethane composition lacking polyol subcomponent (i). In some embodiments, a reference polyurethane composition is a corresponding polyurethane composition lacking polyol subcomponent (ii). In some embodiments, a reference polyurethane composition is a corresponding polyurethane composition composed solely of a polycarbonate polyol. In some embodiments, a reference polyurethane composition is a corresponding polyurethane composition composed solely of a polyether polyol. In some embodiments, a reference polyurethane composition is a corresponding polyurethane composition composed solely of a polyester polyol.

In certain embodiments, adhesives of the present invention (i.e., any of the adhesive compositions described above and herein derived from a compound described above and herein) are characterized in that the strength of the cured bond formed by the adhesive composition between two specimens of the substrate has a greater strength relative to a corresponding adhesive composition derived from a reference polyurethane composition, wherein the strength is measured by an ASTM D1002 lap sheer test. In certain embodiments, adhesives of the present invention are characterized in that the strength of the cured adhesive measured is least 5%, is least 10%, at least 20%, at least 30%, at least 40%, at least 50%, at least 60%, at least 70%, at least 80%, at least 90%, at least 100%, at least 150%, or at least 200% greater than the corresponding adhesive composition derived from a reference polyurethane composition. In certain embodiments, the strengths compared above are indicated by a measurement selected from the group consisting of. Load at Failure; Tensile Energy to Break; Stress at Yield; and Strain at Yield.

In certain embodiments, adhesives of the present invention (i.e. any of the adhesive compositions described above and herein derived from a composition described above and herein) are characterized in that the strength of the cured bond formed by the adhesive composition between two specimens retains at least 50% of its room temperature strength when heated to a temperature of 50° C. In some embodiments the strength is measured using ASTM D1002. In certain embodiments, adhesives of the present invention are characterized in that the strength of the cured bond formed by the adhesive composition between two specimens measured at 50° C. is least 5%, least 10%, least 20%, least 30%, least 40%, least 50%, least 60%, least 65%, at least 70%, at least 75%, at least 80%, at least 85%, at least 90%, at least 92%, at least 95%, or at least 98%; or between about 5% and about 10%, about 5% and about 25%, about 5% and about 50%, about 5% and about 75%, about 5% and about 100%, about 10% and about 100%, about 25% and about 100%, about 50% and about 100%, about 75% and about 100%, about 20% and about 80%, and about 40% and about 60% of the strength measured using the same procedure at room temperature. In certain embodiments, adhesives of the present invention are characterized in that the strength of the cured bond formed by the adhesive composition between two specimens measured at 70° C. is least 5%, least 10%, least 20%, least 30%, least 40%, least 50%, least 60%, least 65%, at least 70%, at least 75%, at least 80%, at least 85%, at least 90%, at least 92%, at least 95%, or at least 98%; or between about 5% and about 10%, about 5% and about 25%, about 5% and about 50%, about 5% and about 75%, about 5% and about 100%, about 10% and about 100%, about 25% and about 100%, about 50% and about 100%, about 75% and about 100%, about 20% and about 80%, and about 40% and about 60% of the strength measured using the same procedure at room temperature. In certain embodiments, the strengths compared above are indicated by a measurement selected from the group consisting of: Load at Failure; Tensile Energy to Break; Stress at Yield; and Strain at Yield.

In certain embodiments, adhesives of the present invention (i.e. any of the adhesive compositions described above and herein derived from a composition described above and herein) are characterized in that the strength of the cured bond formed by the adhesive composition between two specimens indicated by Load at Failure measured using ASTM D1002 at 50° C. is at least 60% of the Load at Failure measured using the same procedure at 25° C. In certain embodiments, adhesives of the present invention are characterized in that the Load at Failure of the cured adhesive measured at 50° C. is least 65%, at least 70%, at least 75%, at least 80%, at least 85%, at least 90%, at least 92%, at least 95%, or at least 98% of the Load at Failure measured using the same procedure at 25° C. In certain embodiments, adhesives of the present invention are characterized in that the Load at Failure of the cured adhesive measured at 50° C. is between 50 and 100% of the Load at Failure measured using the same procedure at 25° C. In certain embodiments, adhesives of the present invention are characterized in that the Load at Failure of the cured adhesive measured at 50° C. is between 50% and 80%, between 70% and 80%, between 60% and 80%, between 70% and 100%, or between 80% and 100% of the Load at Failure measured using the same procedure at 25° C.

In certain embodiments, adhesives of the present invention (i.e. any of the adhesive compositions described above and herein derived from a composition described above and herein) are characterized in that the strength of the cured bond formed by the adhesive composition between two specimens indicated by the Tensile Energy to Break measured using ASTM D1002 at 50° C. is at least 60% of the Tensile Energy to Break measured using the same procedure at 25° C. In certain embodiments, adhesives of the present invention are characterized in that the Tensile Energy to Break the cured adhesive measured at 50° C. is least 65%, at least 70%, at least 75%, at least 80%, at least 85%, at least 90%, at least 92%, at least 95%, or at least 98% of the Tensile Energy to Break measured using the same procedure at 25° C. In certain embodiments, adhesives of the present invention are characterized in that the Tensile Energy to Break the cured adhesive measured at 50° C. is between 50 and 100% of the Tensile Energy to Break measured using the same procedure at 25° C. In certain embodiments, adhesives of the present invention are characterized in that the Tensile Energy to Break the cured adhesive measured at 50° C. is between 50% and 80%, between 70% and 80%, between 60% and 80%, between 70% and 100%, or between 80% and 100% of the Tensile Energy to Break measured using the same procedure at 25° C.

In certain embodiments, adhesives of the present invention (i.e. any of the adhesive compositions described above and herein derived from a composition described above and herein) are characterized in that the strength of the cured bond formed by the adhesive composition between two specimens indicated by Stress at Yield or Strain at Yield measured using ASTM D1002 at 50° C. is at least 60% of the corresponding parameter measured using the same procedure at 25° C. In certain embodiments, adhesives of the present invention are characterized in that the Stress at Yield or Strain at Yield of the cured adhesive measured at 50° C. is least 65%, at least 70%, at least 75%, at least 80%, at least 85%, at least 90%, at least 92%, at least 95%, or at least 98% of the corresponding parameter measured using the same procedure at 25° C. In certain embodiments, adhesives of the present invention are characterized in that the Stress at Yield or Strain at Yield of the cured adhesive measured at 50° C. is between 50 and 100% of the corresponding parameter measured using the same procedure at 25° C. In certain embodiments, adhesives of the present invention are characterized in that the Stress at Yield or Strain at Yield of the cured adhesive measured at 50° C. is between 50% and 80%, between 70% and 80%, between 60% and 80%, between 70% and 100%, or between 80% and 100% of the corresponding parameter measured using the same procedure at 25° C.

In certain embodiments, adhesives of the present invention (i.e. any of the adhesive compositions described above and herein derived from a composition described above and herein) are characterized in that the strength of the cured adhesive measured using ASTM D1002 at 50° C. is greater than the strength at 25° C. In certain embodiments, adhesives of the present invention are characterized in that the strength of the cured adhesive measured using ASTM D1002 at 50° C. is at least 10% higher than the strength measured using the same procedure at 25° C. In certain embodiments, adhesives of the present invention are characterized in that the strength of the cured adhesive at 50° C. is at least 15%, at least 20%, at least 30%, at least 40%, at least 50%, at least 75%, at least 100%, or at least 150% greater than the strength measured using the same procedure at 25° C. In certain embodiments, adhesives of the present invention are characterized in that the strength of the cured adhesive measured at 50° C. is between 100% and 200%, between 100% and 150%, between 120% and 180%, between 120% and 150%, or between 100% and 120% of the strength measured using the same procedure at 25° C. In certain embodiments, the strengths compared above are indicated by a measurement selected from the group consisting of. Load at Failure; Tensile Energy to Break; Stress at Yield; and Strain at Yield. In certain embodiments, the strengths compared above are indicated by a measurement selected from the group consisting of: Load at Failure; Tensile Energy to Break; and Strain at Yield.

In certain embodiments, adhesives of the present invention (i.e. any of the adhesive compositions described above and herein derived from a composition described above and herein) are characterized in that the strength of the cured bond formed by the adhesive composition between two specimens indicated by Load at Failure measured using ASTM D1002 at 50° C. is greater than the Load at Failure at 25° C. In certain embodiments, adhesives of the present invention are characterized in that the Load at Failure of the cured adhesive measured using ASTM D1002 at 50° C. is at least 10% higher than the Load at Failure measured using the same procedure at 25° C. In certain embodiments, adhesives of the present invention are characterized in that the Load at Failure of the cured adhesive at 50° C. is at least 15%, at least 20%, at least 30%, at least 40%, at least 50%, at least 75%, at least 100%, or at least 150% greater than the Load at Failure at 25° C. In certain embodiments, adhesives of the present invention are characterized in that the Load at Failure of the cured adhesive measured at 50° C. is between 100% and 200%, between 100% and 150%, between 120% and 180%, between 120% and 150%, or between 100% and 120% of the Load at Failure measured using the same procedure at 25° C.

In certain embodiments, adhesives of the present invention (i.e. any of the adhesive compositions described above and herein derived from a composition described above and herein) are characterized in that the strength of the cured bond formed by the adhesive composition between two specimens indicated by the Tensile Energy to Break measured using ASTM D1002 at 50° C. is greater than the Tensile Energy to Break at 25° C. In certain embodiments, adhesives of the present invention are characterized in that the Tensile Energy to Break the cured adhesive measured using ASTM D1002 at 50° C. is at least 10% higher than the Tensile Energy to Break measured using the same procedure at 25° C. In certain embodiments, adhesives of the present invention are characterized in that the Tensile Energy to Break the cured adhesive at 50° C. is at least 15%, at least 20%, at least 30%, at least 40%, at least 50%, at least 75%, at least 100%, or at least 150% greater than the Tensile Energy to Break the adhesive at 25° C. In certain embodiments, adhesives of the present invention are characterized in that the Tensile Energy to Break the cured adhesive measured at 50° C. is between 100% and 200%, between 100% and 150%, between 120% and 180%, between 120% and 150%, or between 100% and 120% of the Tensile Energy to Break the adhesive at 25° C.

In certain embodiments, adhesives of the present invention (i.e. any of the adhesive compositions described above and herein derived from a composition described above and herein) are characterized in that the strength of the cured bond formed by the adhesive composition between two specimens indicated by the Strain at Yield measured using ASTM D1002 at 50° C. is greater than the Strain at Yield at 25° C. In certain embodiments, adhesives of the present invention are characterized in that the Strain at Yield of the cured adhesive measured using ASTM D1002 at 50° C. is at least 10% higher than the Strain at Yield measured using the same procedure at 25° C. In certain embodiments, adhesives of the present invention are characterized in that the Strain at Yield of the cured adhesive at 50° C. is at least 15%, at least 20%, at least 30%, at least 40%, at least 50%, at least 75%, at least 100%, or at least 150% greater than the Strain at Yield of the adhesive at 25° C. In certain embodiments, adhesives of the present invention are characterized in that the Strain at Yield of the cured adhesive measured at 50° C. is between 100% and 200%, between 100% and 150%, between 120% and 180%, between 120% and 150%, or between 100% and 120% of the Strain at Yield of the adhesive at 25° C.

In certain embodiments, adhesives of the present invention (i.e. any of the adhesive compositions described above and herein derived from a composition described above and herein) are characterized in that the strength of the cured adhesive measured using ASTM D1002 at 70° C. retains at least 40% of the strength measured using the same procedure at 25° C. In certain embodiments, adhesives of the present invention are characterized in that the strength of the cured adhesive measured at 50° C. is least 55%, at least 60%, at least 65%, at least 70%, at least 75%, or at least 80% of the strength measured using the same procedure at 25° C. In certain embodiments, adhesives of the present invention are characterized in that the strength of the cured adhesive measured at 70° C. is between 40% and 100% of the strength measured using the same procedure at 25° C. In certain embodiments, adhesives of the present invention are characterized in that the strength of the cured adhesive measured at 70° C. is between 40% and 80%, between 40% and 60%, between 50% and 80%, between 50% and 70%, or between 70% and 90% of the strength measured using the same procedure at 25° C. In certain embodiments, the strengths compared above are indicated by a measurement selected from the group consisting of. Load at Failure; Tensile Energy to Break; Stress at Yield; and Strain at Yield.

In certain embodiments, adhesives of the present invention (i.e. any of the adhesive compositions described above and herein derived from a composition described above and herein) are characterized in that the strength of the cured bond formed by the adhesive composition between two specimens indicated by the Strain at Yield measured using ASTM D1002 at 70° C. is greater than the Strain at Yield at 25° C. In certain embodiments, adhesives of the present invention are characterized in that the Strain at Yield of the cured adhesive measured using ASTM D1002 at 70° C. is at least 10% higher than the Strain at Yield measured using the same procedure at 25° C. In certain embodiments, adhesives of the present invention are characterized in that the Strain at Yield of the cured adhesive at 70° C. is at least 15%, at least 20%, at least 30%, at least 40%, at least 50%, at least 75%, at least 100%, or at least 150% greater than the Strain at Yield of the adhesive at 25° C. In certain embodiments, adhesives of the present invention are characterized in that the Strain at Yield of the cured adhesive measured at 70° C. is between 100% and 200%, between 100% and 150%, between 120% and 180%, between 120% and 150%, or between 100% and 120% of the Strain at Yield of the adhesive at 25° C.

I. Improved Resistance to Solvents

In another aspect, the present invention encompasses adhesive compositions (i.e. any of the adhesive compositions described above and herein derived from a composition described above and herein) characterized in that the cured adhesive is highly resistant to solvents. Such solvent resistance properties are unexpected since analogous adhesives formulated with commercially available polycarbonate polyols (e.g. those having more than two carbon atoms enchained between adjacent carbonate linkages) are degraded by solvent to a greater degree than the adhesives of the present invention.

In certain embodiments, adhesive compositions of the present invention (i.e. any of the adhesive compositions described above and herein derived from a composition described above and herein) are further characterized in that they have excellent resistance to hydrocarbon solvents. In certain embodiments, adhesive compositions of the present invention are characterized in that they have superb resistance to aromatic hydrocarbons. In certain embodiments, the present invention comprises epoxide-CO₂-based polyols characterized in that they gain less than 5% mass when immersed in aromatic hydrocarbon liquid for 1 week. In certain embodiments, they gain less than 5% mass when immersed in toluene for 1 week. In certain embodiments, they gain less than 1% mass when immersed in xylenes for 1 week.

### EXAMPLES

The present invention is illustrated by the following examples. It is to be understood that the particular examples, materials, amounts, and procedures are to be interpreted broadly in accordance with the scope and spirit of the invention as set forth herein.

### Example 1: Preparation of Polyurethane Compositions

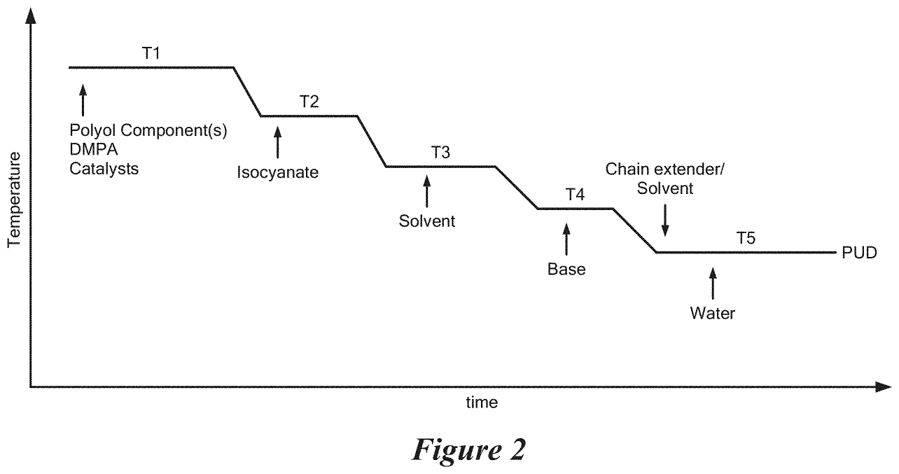

The PUD compositions 1-8, 11-13, 16-22, and 24 were prepared according to the reaction scheme depicted in FIG. 2.

### Example 2: Preparation of PUD Coatings

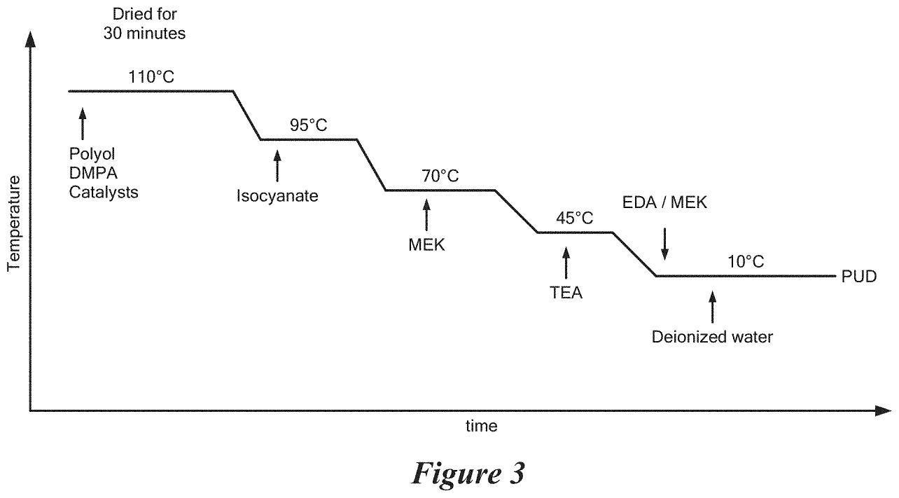

PUD coatings were prepared from PUD compositions 1-8, 11-13, 16-22, and 24 according to the scheme depicted in FIG. 3

As depicted in FIG. 3, a substrate was coated with the PUD composition and then the water was evaporated, leaving behind the PU coating. The PU coating was lifted from the substrate, cut into the appropriate shape, and its performance properties were measured.

### Example 3: Preparation and Characterization of PUD Compositions 1-5

Example 3 demonstrates that higher amounts of standard 0.5% DMPA content is insufficient for preparing shelf-stable PUDs when they contain PC Polyol 1 or PC Polyol 2, since they lead to larger particle size (see Table 6, PUD1). Higher DMPA content in these formulations achieved improved shelf stability (e.g., 2.0 wt %), as shown by the decreased particle size (see Table 6, PUDs 2-5). Example 3 also demonstrates that increased DMPA content results in PUD coatings with improved tensile strength, while maintain tensile elongation (see Table 7).

PUDs 1-5 were prepared according to Example 1, as specified in Table 5. All amounts in Table 5 are weights listed in grams. PC Polyol 1 and PC Polyol 2 were prepared by methods disclosed in, for example, PCT publication WO2010/028362, using a polymerization catalyst. Polymerization catalysts include those disclosed in, for example, R.-R. Ang et al., Journal of Cleaner Production. 102 (2015) 1-17; Zhang, et al., Chem. Rev. 2018 (118), 839-885; Liu et al., Current Opinion in Green and Sustainable Chemistry 2017 (3), 61-66; or Quin, et. al., Journal of CO2 Utilization 2015 (11), 3-9; U.S. Pat. Nos. 7,304,172 and 6,870,004; EP Patent No. EP 2258745B1; PCT Publication Nos. WO 2010/022388, 2008/136591, 2008/150033, 2009/137540, 2010/013948, 2010/147421, 2012/037282, 2013/022932, 2013/012895, 2013/096602, 2014/031811, 2016/012785, 2016/012786, and 2010/028362; and in Chinese Patent Publication Nos. CN 2007/10010706 and 2008/10229276. PC Polyol 1 was prepared from a polyol (propylene glycol) initiator and comprises polymer chains of formula:

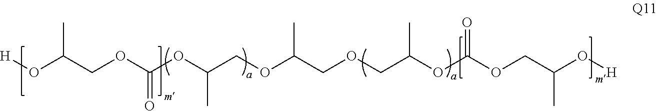

where, on average within the composition, the sum of the a moieties within each polymer chain is about 16, and the sum of the m′ moieties within each polymer chain is about 10.

PC Polyol 1 has an OH # of about 56, a functionality of 2.0, and a wt % of CO₂ of about 20. The number average molecular weight of PC Polyol 1 is about 2,000 g/mol.

PC Polyol 2 was prepared from a dipropylene glycol initiator and comprises polymer chains of formula:

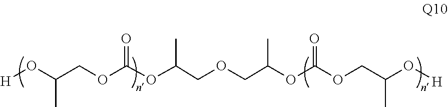

where, on average within the composition, the sum of the n′ moieties within each polymer chain is about 9.

PC Polyol 2 has an OH # of about 112, a functionality of 2.0, and a wt % of CO₂ of about 40.

TABLE 5
Formulations for PUDs 1-5.

| Reagent | PUD 1 | PUD 2 | PUD 3 | PUD 4 | PUD 5 |
|---|---|---|---|---|---|
| IPDI | 45.5 | 49.7 | 53.8 | 57.9 | 62.1 |
| PC Polyol 1 | 75.7 | 72.2 | 68.6 | 65.1 | 61.5 |
| PTMEG-2000 | 75.7 | 72.2 | 68.6 | 65.1 | 61.5 |
| PC Polyol 2 | 0 | 0 | 0 | 0 | 0 |
| BD-AA | 0 | 0 | 0 | 0 | 0 |
| DMPA (wt %) | 2.9 (0.5%) | 5.9 (1.0%) | 8.9 (1.5%) | 11.9 (2.0%) | 14.9 (2.5%) |
| TEA | 2.3 | 4.7 | 6.9 | 9.3 | 11.6 |
| EDA | 4.8 | 4.8 | 4.8 | 4.8 | 4.8 |
| AAS | 0 | 0 | 0 | 0 | 0 |
| MEK | 41.4 | 32.3 | 42.4 | 42.8 | 43.3 |
| Water | 466.7 | 466.7 | 466.7 | 466.7 | 466.7 |

PUDs 1-5 were characterized as disclosed in Table 6. As demonstrated in Table B, standard 0.5% DMPA content is insufficient for preparing shelf-stable PUDs when they contain PC Polyol 1 or PC Polyol 2. DMPA content adjusted to 2.0 wt % in these formulations achieved good shelf stability.

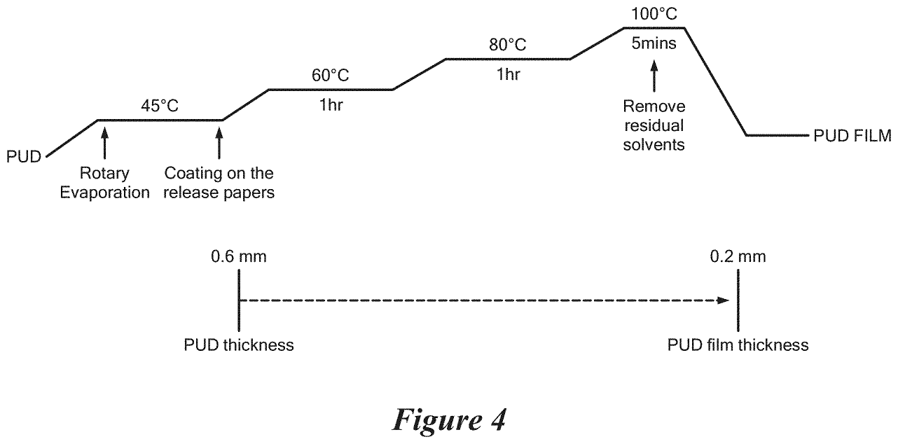

FIG. 4 depicts PUDs 1-5, and demonstrates that larger average particle size leads to a milky white PUD, which can lead to instability (see PUD1). PUDs 2-5, which have smaller average particle size, are translucent and more stable, as shown in FIG. 4.

TABLE 6
Properties of PUDs 1-5

| Property | PUD1 | PUD2 | PUD3 | PUD4 | PUD5 |
|---|---|---|---|---|---|
| Particle size (nm) | 218 | 52 | 50 | 40 | 36 |
| Solid content (wt %) | 30 | 40 | 38 | 38 | 38 |
| Viscosity (cps/30 c.) | 30 | 400 | 80 | 85 | 85 |
| NCO (%) | 4.5 | 4.5 | 4.5 | 4.5 | 4.5 |
| COOH (%) | 0.5 | 1.0 | 1.5 | 2.0 | 2.5 |
| HS (%) | 22.8 | 25.9 | 26.9 | 29.0 | 31.1 |

PUDs 1-5 were prepared as coatings according to the process described in Example 2. The tensile strength and tensile elongation of coatings derived from PUDs 1-5 were measured according to ASTM D412, and modulus at 100%, 200%, and 300% were measured according to ASTM D412, and are provided in Table 7.

TABLE 7
Mechanical Properties of PUDs 1-5.

| Property | PUD1 | PUD2 | PUD3 | PUD4 | PUD5 |
|---|---|---|---|---|---|
| Tensile strength (psi) | 1050 | 4800 | 6450 | 4650 | 5600 |
| Tensile Elongation (psi) | 575 | 500 | 525 | 550 | 500 |
| M100 (psi) | 300 | 900 | 1260 | 1200 | 1450 |
| M200 (psi) | 400 | 1450 | 1950 | 1650 | 2260 |
| M300 (psi) | 550 | 2300 | 2900 | 2250 | 3250 |

### Example 4: Preparation and Characterization of PUD Compositions 6-7

Example 4 demonstrates that incorporation of PC Polyol 1 within a PUD coating results in improved tensile strength, while maintaining similar (or resulting in improved) tensile elongation and modulus (see Table 10).

PUDs 6-7 were prepared according to Example 1, as specified in Table 8 (PUDs 2-3, described in Example 3, are also included for comparison). PUDs 6-7 were characterized as in Table 9 (PUDs 2-3, described in Example 3, are also included for comparison).

TABLE 8
Formulations for PUDs 6-7, as compared to PUDs 2-3.

| Reagent | PUD 6 | PUD 2 | PUD 3 | PUD 7 |
|---|---|---|---|---|
| IPDI | 49.7 | 49.7 | 53.8 | 49.7 |
| PC Polyol 1 | 0 | 72.2 | 68.6 | 72.2 |
| PTMEG-2000 | 144.4 | 72.2 | 68.6 | 72.2 |
| PC Polyol 2 | 0 | 0 | 0 | 0 |
| BD-AA | 0 | 0 | 0 | 0 |
| DMPA | 5.9 | 5.9 | 8.9 | 5.9 |
| TEA | 4.7 | 4.7 | 6.9 | 4.7 |
| EDA | 4.8 | 4.8 | 4.8 | 4.8 |
| AAS | 0 | 0 | 0 | 4.9 |
| MEK | 32.3 | 32.3 | 42.4 | 32.3 |
| Water | 466.7 | 466.7 | 466.7 | 466.7 |
| PTMEG/PC | 100/0 | 50/50 | 50/50 | 50/50 |
| DPMA/AAS | 1.0%/0.0% | 1.0%/0.0% | 1.5%/0.0% | 1.0%/0.6% |

TABLE 9
Properties of PUDs 6-7, as compared to PUDs 2-3.

| Property | PUD 6 | PUD 2 | PUD 3 | PUD 7 |
|---|---|---|---|---|
| Particle size (nm) | not measured | 52 | 50 | 110 |
| Solid content (wt %) | not measured | 40 | 38 | 31 |
| Viscosity (cps/30 c.) | not measured | 400 | 80 | 50 |
| NCO (%) | 4.5 | 4.5 | 4.5 | 4.5 |
| COOH (%) | 1.0 | 1.0 | 1.5 | 1.6 |
| HS (%) | 24.7 | 25.9 | 26.9 | 27.6 |

PUDs 6-7 were prepared as coatings according to the process described in Example 2. The tensile strength and tensile elongation of coatings derived from PUDs 6-7 were measured according to ASTM D412, and modulus at 100%, 200%, and 300% were measured according to ASTM D412, and are provided in Table 10.

TABLE 10
Mechanical Properties of PUDs 6-7, as compared to PUDs 2-3.

| Property | PUD 6 | PUD 2 | PUD 3 | PUD 7 |
|---|---|---|---|---|
| Tensile strength (psi) | 4000 | 4800 | 6450 | 5300 |
| Tensile elongation (psi) | 400 | 500 | 525 | 550 |
| M100 (psi) | 1150 | 900 | 1260 | 850 |
| M200 (psi) | 1700 | 1450 | 1950 | 1400 |
| M300 (psi) | 2650 | 2300 | 2900 | 2200 |

### Example 5: Preparation and Characterization of PUD Compositions 8

Example 5 demonstrates that incorporation of PC Polyol 1 within a PUD coating results in improved tensile strength, while maintaining similar (or resulting in improved) tensile elongation and modulus (see Table 13).

PUD8 was prepared according to Example 1, as disclosed in Table 11 (PUDs 2-3 and 6, as described in Examples 3-4, are also included for comparison). PUD8 was characterized as in Table 12 (PUDs 2-3 and 6, as described in Examples 3-4, are also included for comparison).

TABLE 11
Formulation for PUD8, as compared to PUDs 2-3 and 8.

| Reagent | PUD6 | PUD2 | PUD3 | PUD8 |
|---|---|---|---|---|
| IPDI | 49.7 | 49.7 | 53.8 | 49.7 |
| PC Polyol 1 | 0 | 72.2 | 68.6 | 72.2 |
| PTMEG-2000 | 144.4 | 72.2 | 68.6 | 0 |
| PC Polyol 2 | 0 | 0 | 0 | 0 |
| BD-AA | 0 | 0 | 0 | 72.2 |
| DMPA | 5.9 | 5.9 | 8.9 | 5.9 |
| TEA | 4.7 | 4.7 | 6.9 | 4.7 |
| EDA | 4.8 | 4.8 | 4.8 | 4.8 |
| AAS | 0 | 0 | 0 | 0 |
| MEK | 32.3 | 32.3 | 42.4 | 32.3 |
| Water | 466.7 | 466.7 | 466.7 | 466.7 |
| PTMEG or BD-AA/PC | 100/0 | 50/50 | 50/50 | 50/50 |
| DPMA/AAS | 1.0%/0.0% | 1.0%/0.0% | 1.5%/0.0% | 1.0%/0.0% |

TABLE 12
Properties of PUD 8, as compared to PUDs 2-3 and 8.

| Property | PUD 6 | PUD 2 | PUD 3 | PUD 8 |
|---|---|---|---|---|
| Particle size (nm) | not measured | 52 | 50 | not measured |
| Solid content (wt %) | not measured | 40 | 38 | not measured |
| Viscosity (cps/30 c.) | not measured | 400 | 80 | not measured |
| NCO (%) | 4.5 | 4.5 | 4.5 | 4.5 |
| COOH (%) | 1.0 | 1.0 | 1.5 | 1.6 |
| HS (%) | 24.7 | 25.9 | 26.9 | 33.1 |

PUD8 was prepared as a coating according to the process described in Example 2. The tensile strength and tensile elongation of a coating derived from PUD8 was measured according to ASTM D412, and modulus at 100%, 200%, and 300% were measured according to ASTM D412, and are provided in Table 13 (PUDs 2-3 and 6, as described in Examples 3-4, are also included for comparison).

TABLE 13
Mechanical Properties of PUD8, as compared to PUDs 2-3 and 8.

| Property | PUD 6 | PUD 2 | PUD 3 | PUD 8 |
|---|---|---|---|---|
| Tensile strength (psi) | 4000 | 4800 | 6450 | 6600 |
| Tensile Elongation (psi) | 400 | 500 | 525 | 500 |
| M100 (psi) | 1150 | 900 | 1260 | 2050 |
| M200 (psi) | 1700 | 1450 | 1950 | 2900 |
| M300 (psi) | 2650 | 2300 | 2900 | 4000 |

### Example 6: Preparation and Characterization of PUD Compositions 11-13

Example 6 demonstrates that incorporation of PC Polyol 1 or 2 within a PUD coating results in improved tensile strength, while maintaining similar (or resulting in improved) tensile elongation and modulus (see Table 16). In addition, Example 6 demonstrates that incorporation of both PC Polyol 1 and PC Polyol 2 within a PUD coating results in a coating with even further improved tensile strength, while maintaining similar (or resulting in improved) tensile elongation and modulus (see Table 16).

PUDs 11-13 are prepared according to Example 1, as disclosed in Table 14 (PUDs 2, 4, and 6, as described in Examples 3-4, are also included for comparison). PUDs 11-13 were characterized as in Table 15 (PUDs 2-3 and 6, as described in Examples 3-4, are also included for comparison).

PUDs 11-13 were prepared as coatings according to Example 2. The tensile strength and tensile elongation of coatings derived from PUDs 11-13 were measured according to ASTM D412, and modulus at 100%, 200%, and 300% were measured according to ASTM D412, and are provided in Table 16.

TABLE 14
Formulations for PUDs 11-13, as compared to PUDs 2, 4, and 6.

| Reagent | PUD 6 | PUD 2 | PUD 4 | PUD 11 | PUD 12 | PUD 13 |
|---|---|---|---|---|---|---|
| IPDI | 49.7 | 49.7 | 57.9 | 64.2 | 61.1 | 103.6 |
| PC Polyol 1 | 0 | 72.2 | 65.1 | 0 | 31.7 | 42.4 |
| PTMEG-2000 | 144.4 | 72.2 | 65.1 | 61.9 | 63.5 | 84.8 |
| PC Polyol 2 | 0 | 0 | 0 | 61.9 | 31.7 | 42.4 |
| BD-AA | 0 | 0 | 0 | 0 | 0 | 0 |
| DMPA | 5.9 | 5.9 | 11.9 | 11.9 | 11.9 | 26.8 |
| TEA | 4.7 | 4.7 | 9.3 | 9.3 | 9.3 | 20.9 |
| EDA | 4.8 | 4.8 | 4.8 | 4.8 | 4.8 | 7.2 |
| AAS | 0 | 0 | 0 | 0 | 0 | 0 |
| MEK | 32.3 | 32.3 | 42.8 | 42.8 | 43 | 65 |
| Water | 466.7 | 466.7 | 466.7 | 466.7 | 467 | 700 |
| PTMEG or BD-AA/ | 100/0/0 | 50/50/0 | 50/50/0 | 50/0/50 | 50/25/25 | 50/25/25 |
| PC Polyol 1/ | | | | | | |
| PC Polyol 2 | | | | | | |
| DPMA/AAS | 1.0% | 1.0% | 2.0% | 2.0% | 2.0% | 3.0% |

TABLE 15
Properties of PUDs 11-13, as compared to PUDs 2, 4, and 6.

| Property | PUD 6 | PUD 2 | PUD 4 | PUD 11 | PUD 12 | PUD 13 |
|---|---|---|---|---|---|---|
| Particle size (nm) | nm | 52 | 40 | 70 | 62 | 52 |
| Solid content (wt %) | nm | 40 | 38 | 40 | 42 | 38 |
| Viscosity (cps/30 c.) | nm | 150 | 85 | 100 | 100 | 75 |
| NCO (%) | 4.5 | 4.5 | 4.5 | 4.5 | 4.5 | 4.5 |
| COOH (%) | 1.0 | 1.0 | 2.0 | 2.0 | 2.0 | 3.0 |
| HS (%) | 24.7 | 25.9 | 29.0 | 32.0 | 31.0 | 34.0 |

TABLE 16
Mechanical Properties of PUDs 11-13, as compared to PUDs 2, 4, and 6.

| Property | PUD 6 | PUD 2 | PUD 4 | PUD 11 | PUD 12 | PUD 13 |
|---|---|---|---|---|---|---|
| PC Polyol 1 (wt %) | 0 | 50 | 50 | 0 | 25 | 25 |
| PC Polyol 2 (wt %) | 0 | 0 | 0 | 50 | 25 | 25 |
| PTMEG-2000 (wt %) | 100 | 50 | 50 | 50 | 50 | 50 |
| BD-AA (wt %) | 0 | 0 | 0 | 0 | 0 | 0 |
| COOH (%) | 1.0 | 1.0 | 2.0 | 2.0 | 2.0 | 3.0 |
| Tensile strength (psi) | 4000 | 4800 | 4650 | 5700 | 8000 | 7300 |
| Tensile Elongation (psi) | 400 | 500 | 550 | 375 | 425 | 350 |
| M100 (psi) | 1150 | 900 | 1200 | 2750 | 2500 | 4550 |
| M200 (psi) | 1700 | 1450 | 1650 | 3450 | 3700 | 5500 |
| M300 (psi) | 2650 | 2300 | 2250 | 4650 | 5350 | 6650 |

### Example 7: Preparation and Characterization of PUD Compositions 16-22 and 24

Example 7 demonstrates that incorporation of PC Polyol 1 or 2 within a PUD coating results in improved tensile strength, while maintaining similar (or resulting in improved) tensile elongation and modulus (see Table 19). In addition, Example 7 demonstrates that incorporation of both PC Polyol 1 and PC Polyol 2 within a PUD coating results in a coating with even further improved tensile strength, while maintaining similar (or resulting in improved) tensile elongation and modulus (see Table 19).

PUDs 16-22 and 24 were prepared according to Example 1, as disclosed in Table 17. PUDs 16-22 and 24 were characterized as in Table 18. PUDs 16-22 and 24 were prepared as coatings according to Example 2. The tensile strength and tensile elongation of coatings derived from PUDs 16-22 and 24 were measured according to ASTM D412, and modulus at 100%, 200%, and 300% were measured according to ASTM D412, and are provided in Table 19.

TABLE 17
Formulations for PUDs 16-22 and 24.

| Reagent | PUD16 | PUD17 | PUD18 | PUD19 | PUD20 | PUD21 | PUD22 | PUD24 |
|---|---|---|---|---|---|---|---|---|
| IPDI | 57.9 | 49.7 | 79.8 | 57.9 | 64.2 | 91.7 | 66.3 | 103.6 |
| PC Polyol 1 | 0 | 72.2 | 52.8 | 65.1 | 0 | 47.6 | 57.9 | 42.4 |
| PTMEG-2000 | 0 | 0 | 0 | 0 | 0 | 0 | 0 | 0 |
| PC Polyol 2 | 0 | 0 | 52.8 | 0 | 61.9 | 47.6 | 0 | 42.4 |
| BD-AA | 130.2 | 72.2 | 105.7 | 65.1 | 61.9 | 95.2 | 57.9 | 84.8 |
| DMPA | 11.9 | 5.9 | 8.9 | 11.9 | 11.9 | 17.9 | 17.9 | 26.8 |
| TEA | 9.3 | 4.6 | 6.9 | 9.3 | 9.3 | 13.9 | 13.9 | 20.9 |
| EDA | 4.8 | 4.8 | 7.2 | 4.8 | 4.8 | 7.2 | 4.8 | 7.2 |
| AAS | 0 | 0 | 0 | 0 | 0 | 0 | 0 | 0 |
| MEK | 42.8 | 42.8 | 63 | 42.8 | 42.8 | 64 | 42.8 | 65 |
| Water | 466.7 | 466.7 | 700 | 466.7 | 466.7 | 700 | 466.7 | 700 |
| PTMEG or BD-AA/ | 100/0/0 | 50/50/0 | 50/25/25 | 50/50/0 | 50/0/50 | 50/25/25 | 50/50/0 | 50/25/25 |
| PC Polyol 1/ | | | | | | | | |
| PC Polyol 2 | | | | | | | | |
| DPMA/AAS | 2.0% | 1.0% | 1.0% | 2.0% | 2.0% | 2.0% | 3.0% | 3.0% |

TABLE 18
Properties of PUDs 16-22 and 24.

| Property | PUD16 | PUD17 | PUD18 | PUD19 | PUD20 | PUD21 | PUD22 | PUD24 |
|---|---|---|---|---|---|---|---|---|
| Particle size (nm) | 46 | 67 | 95 | 33 | 60 | 53 | 30 | 33 |
| Solid content (wt %) | 37 | 36 | 36 | 39 | 40 | 39 | 36 | 38 |
| Viscosity (cps/30 c.) | 75 | 75 | 50 | 85 | 100 | 75 | 75 | 85 |
| NCO (%) | 4.5 | 4.5 | 4.5 | 4.5 | 4.5 | 4.5 | 4.5 | 4.5 |
| COOH (%) | 2.0 | 1.0 | 1.0 | 2.0 | 2.0 | 2.0 | 3.0 | 3.0 |
| HS (%) | 29 | 27 | 28 | 31 | 40 | 31 | 36 | 34 |

TABLE 19
Mechanical Properties of PUDs 16-22 and 24.

| Property | PUD16 | PUD17 | PUD18 | PUD19 | PUD20 | PUD21 | PUD22 | PUD24 |
|---|---|---|---|---|---|---|---|---|
| PC Polyol 1 (wt %) | 0 | 50 | 25 | 50 | 0 | 25 | 50 | 25 |
| PC Polyol 2 (wt %) | 0 | 0 | 25 | 0 | 50 | 25 | 0 | 25 |
| PTMEG-2000 (wt %) | 0 | 0 | 0 | 0 | 0 | 0 | 0 | 0 |
| BD-AA (wt %) | 100 | 50 | 50 | 50 | 50 | 50 | 50 | 50 |
| COOH (%) | 2.0 | 1.0 | 1.0 | 2.0 | 2.0 | 2.0 | 3.0 | 3.0 |
| Tensile strength (psi) | 5950 | 3750 | 3150 | 6450 | 5750 | 8000 | 5100 | 7650 |
| Tensile Elongation (psi) | 475 | 550 | 500 | 525 | 375 | 425 | 475 | 375 |
| M100 (psi) | 1100 | 600 | 900 | 1200 | 1700 | 2450 | 1300 | 2900 |
| M200 (psi) | 1900 | 950 | 1250 | 2000 | 2300 | 3700 | 2100 | 4450 |
| M300 (psi) | 3150 | 1400 | 1750 | 3100 | 3200 | 7450 | 3050 | 6150 |

### Example 8: Preparation and Characterization of Polyurethane Compositions 1-14 (“PU 1-14”)

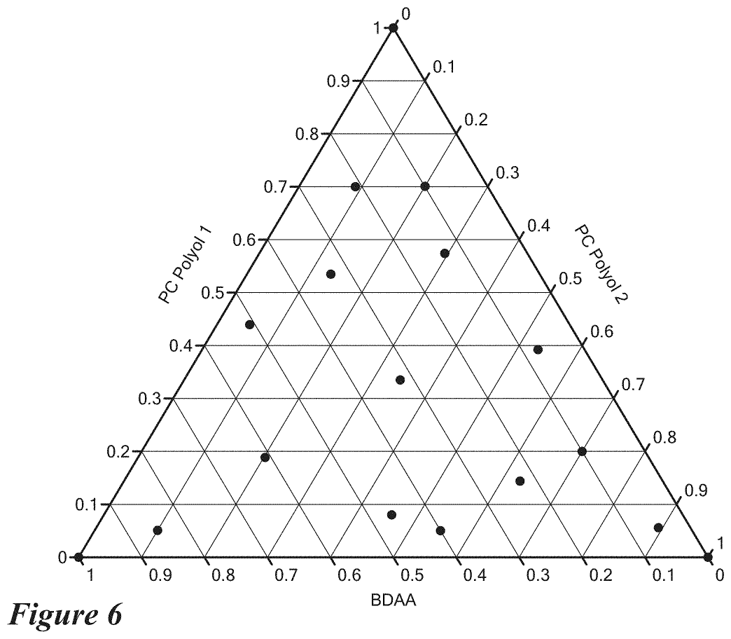

For each of PUs 1-14, the polyols were blended, converted to 8% NCO-terminated prepolymers with excess MDI and then cast as thin films on a glass plate and moisture cured. The resulting films were lifted from the glass plate and prepared for mechanical testing according to ASTM D412. PUs 1-14 were prepared and characterized as in Tables 19 and 20, where at least three replicates were run for each test and the average value is shown for tensile strength at break (T_{b}) and elongation at break (E_{b}). PUs 1-14 are also depicted in FIG. 6.

To determine if the T_{b} or E_{b} is unexpectedly high or low, the actual T_{b} and E_{b} values are compared with the expected values. The expected values were calculated by a weighted average of the T_{b} and E_{b} values of a PU composition comprising only a single polyol and are reported as “Expected T_{b}” and “Expected E_{b}.” In Table 21, PU-A, —B, and —C represent a polyurethane composition composed solely of BD-AA, PC Polyol 1, or PC Polyol 2, respectively. The mechanical properties for PC Polyol 2 are an extrapolation from blends PC Polyol 1 and PC Polyol 2 since it is not possible to measure the mechanical properties of a polyurethane derived solely from PC Polyol 2 given its brittleness. To determine whether measured values differed from expected values, the Expected T_{b} and Expected E_{b} were subtracted from the measured T_{b} and E_{b}, and the percent difference between expected and observed was calculated.

When developing polyurethanes derived from blends of polyols, it is generally expected that the polyurethane comprised of a blend will consist of a weighted average of the properties of polyurethanes derived from a single polyol (e.g., PU-A, —B, and —C). Alternatively or additionally, in many polyurethane systems, E_{b} and T_{b} are inversely proportional: higher T_{b} results in lower E_{b}.

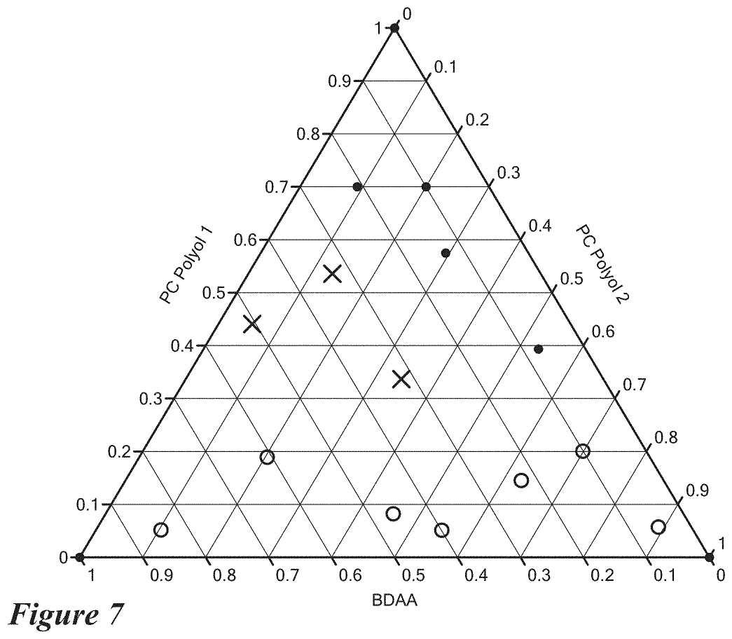

Here, it was first observed that in some instances, the polyurethane derived from a blend displayed mechanical properties that are unexpectedly improved as compared to the expected value. Alternatively or additionally, it was observed that in some instances higher than expected E_{b} values did not result in proportional loss of T_{b}, and in some cases showed no change or an improvement in T_{b}. FIG. 7 illustrates the ranges where unexpected polyurethanes derived from blends displayed unexpected improvements.

TABLE 19
Mechanical Properties of PUs 1-7.

| Property | PU1 | PU2 | PU3 | PU4 | PU5 | PU6 | PU7 |
|---|---|---|---|---|---|---|---|
| PC Polyol 1 (wt %) | 5.10 | 7.50 | 13.20 | 21.11 | 22.65 | 32.20 | 46.30 |
| PC Polyol 2 (wt %) | 89.30 | 53.40 | 29.50 | 9.02 | 62.95 | 34.30 | 45.70 |
| BD-AA (wt %) | 5.60 | 39.10 | 57.30 | 69.86 | 14.40 | 33.50 | 8.00 |
| T_{b} (psi) | 4747 | 5102 | 8243 | 9987 | 6477 | 7190 | 4998 |
| E_{b} (%) | 346 | 170 | 21 | 13 | 362 | 346 | 362 |
| Expected T_{b} (psi) | 5765.1 | 8133.7 | 9498.3 | 10251 | 6301.2 | 7610.3 | 5726.4 |
| T_{b} − Expected T_{b} (psi) | −1018 | −3032 | −1155 | −264 | 175.76 | −420.3 | −728.4 |
| T_{b} % Diff | −18% | −37% | −12% | −3% | +3% | −6% | −13% |
| Expected E_{b} (%) | 297.92 | 198.1 | 148.17 | 117.6 | 288.28 | 239.38 | 330.97 |
| E_{b} − Expected E_{b} (%) | 48.082 | −28.1 | −127.2 | −104.5 | 73.72 | 106.62 | 31.026 |
| E_{b} % Diff | +16% | −14% | −86% | −89% | +26% | +45% | +9% |

TABLE 20
Mechanical Properties of PUs 8-14.

| Property | PU8 | PU9 | PU10 | PU11 | PU12 | PU13 | PU14 |
|---|---|---|---|---|---|---|---|
| PC Polyol 1 (wt %) | 50.89 | 61.00 | 84.92 | 10.00 | 40.00 | 33.30 | 10.00 |
| PC Polyol 2 (wt %) | 5.22 | 20.20 | 10.07 | 70.00 | 55.00 | 13.30 | 20.00 |
| BD-AA (wt %) | 43.88 | 18.80 | 5.01 | 20.00 | 5.00 | 53.40 | 70.00 |
| T_{b} (psi) | 6945 | 5888 | 5420 | 5756 | 5581 | 7024 | 9296 |
| E_{b} (%) | 323 | 366 | 452 | 260 | 404 | 250 | 3.2 |
| Expected T_{b} (psi) | 8253.3 | 6419.2 | 5317.5 | 6763.6 | 5545.2 | 9019 | 10317 |
| T_{b} − Expected T_{b} (psi) | −1308 | −531.2 | 102.46 | −1008 | 35.85 | −1995 | −1021 |
| T_{b} % Diff | −16% | −8% | +2% | −15% | +1% | −22% | −10% |
| Expected E_{b} (%) | 226.03 | 312.44 | 377.95 | 258.8 | 333.95 | 179.76 | 106.3 |
| E_{b} − Expected E_{b} (%) | 96.972 | 53.56 | 74.05 | 1.2 | 70.05 | 70.236 | −103.1 |
| E_{b} % Diff | +43% | +17% | +20% | +0.5% | +21% | +39% | −97% |

TABLE 21
Mechanical Properties of PU-A, -B, and -C.

| Property | PU-A | PU-B | PU-C |
|---|---|---|---|
| PC Polyol 1 (wt %) | 0 | 100.00 | 0 |
| PC Polyol 2 (wt %) | 0 | 0 | 100.00 |
| BD-AA (wt %) | 100.00 | 0 | 0 |
| T_{b} (psi) | 4885 | 5393 | 12500 |
| E_{b} (%) | 408 | 310 | 5 |

### Example 9: Preparation and Characterization of Polyurethane Compositions 15-21 (“PU 1-15-21”)

PUs 15-21 were prepared and characterized according to Example 8, as disclosed in Table 22. In Table 23, PU-B, —C, and -D represent a polyurethane composition composed solely of PC Polyol 1, PC Polyol 2, or DEG-AA respectively. The mechanical properties for PC Polyol 2 are an extrapolation from blends PC Polyol 1 and PC Polyol 2 since it is not possible to measure the mechanical properties of a polyurethane derived solely from PC Polyol 2 given its brittleness.

When developing polyurethanes derived from blends of polyols, it is generally expected that the polyurethane comprised of a blend will consist of a weighted average of the properties of polyurethanes derived from a single polyol (e.g., PU-D, -E, and -F). Alternatively or additionally, in many polyurethane systems, E_{b} and T_{b} are inversely proportional: higher T_{b} results in lower E_{b}.

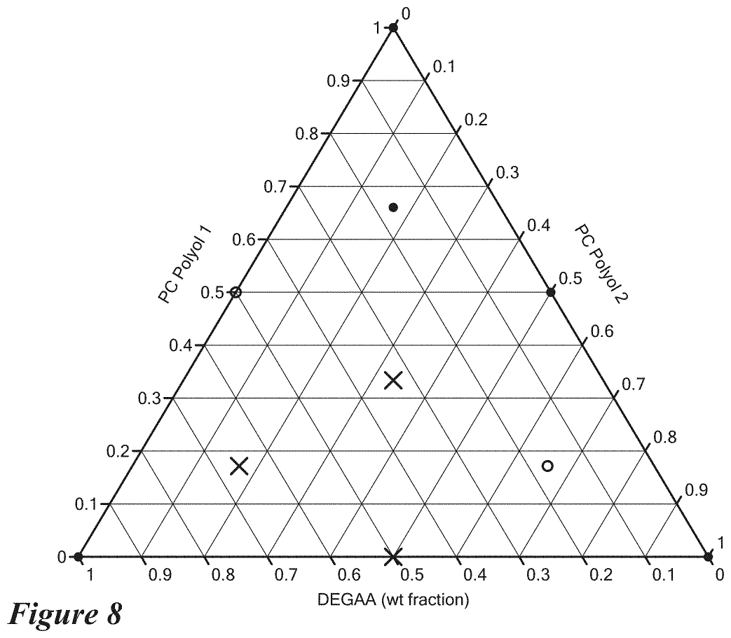

Here, it was first observed that in some instances, the polyurethane derived from a blend displayed mechanical properties that are unexpectedly improved as compared to the expected value. Alternatively or additionally, it was observed that in some instances higher than expected E_{b} values did not result in proportional loss of T_{b}, and in some cases showed no change or an improvement in T_{b}. FIG. 8 illustrates the ranges where unexpected polyurethanes derived from blends displayed unexpected improvements.

TABLE 22
Mechanical Properties of PUs 18-23.

| Property | PU15 | PU16 | PU17 | PU18 | PU19 | PU20 | PU21 |
|---|---|---|---|---|---|---|---|
| PC Polyol 1 (wt %) | 50.0 | 0 | 50.0 | 33.4 | 17.0 | 66.0 | 17.0 |
| PC Polyol 2 (wt %) | 50.0 | 50.0 | 0 | 33.2 | 17.0 | 17.0 | 66.0 |
| DEG-AA (wt %) | 0 | 50.0 | 50.0 | 33.4 | 66.0 | 17.0 | 17.0 |
| T_{b} (psi) | 5687 | 6738 | 5913 | 7393 | 6403 | 6724 | 10538 |
| E_{b} (%) | 351 | 384 | 524 | 361 | 477 | 347 | 9 |
| Expected T_{b} (psi) | 9093.5 | 8887.5 | 5481 | 7811.3 | 6573.3 | 6775.2 | 10114 |
| T_{b} − Expected T_{b} (psi) | −934.5 | −2149.5 | 432 | −418.31 | −170.29 | −51.17 | 424.46 |
| T_{b} % Diff | −10% | −24% | +8% | −5% | −3% | −1% | +4% |
| Expected E_{b} (%) | 178 | 243 | 416 | 279.55 | 377.98 | 314.28 | 144.74 |
| E_{b} − Expected E_{b} (%) | −165.0 | 141.0 | 108.0 | 81.5 | 99.0 | 32.7 | −135.7 |
| E_{b} % Diff | −93% | +58% | +26% | +29% | +26% | +10% | −94% |

TABLE 21
Mechanical Properties of PU-B, -C, and -D.

| Property | PU-D | PU-E | PU-F |
|---|---|---|---|
| PC Polyol 1 (wt %) | 100.00 | 0 | 0 |
| PC Polyol 2 (wt %) | 0 | 100.00 | 0 |
| DEG-AA (wt %) | 0 | 0 | 100.0 |
| T_{b} (psi) | 5687 | 12500 | 5275 |
| E_{b} (%) | 351 | 5 | 481 |

### EQUIVALENTS

All material cited in this application, including, but not limited to, patents and patent applications, regardless of the format of such literature and similar materials, are expressly incorporated herein by reference in their entirety. In the event that one or more of the incorporated literature and similar materials differs from or contradicts this application, including but not limited to defined terms, term usage, described techniques, or the like, this application controls.

### ENUMERATED EMBODIMENTS

The following numbered embodiments, while non-limiting, are exemplary of certain aspects of the present disclosure:

1. A polyurethane composition comprising the reaction product of a polyol component and a polyisocyanate component, wherein:
the polyol component comprises:
   polyol subcomponent (i), which comprises one or more aliphatic polycarbonate polyols or polyether carbonate polyols derived from copolymerization of carbon dioxide and one or more epoxides; and
   polyol subcomponent (ii), which comprises one or more polyether or polyester polyols, wherein the polyether or polyester polyols comprise a repeating tetramethylene unit.
      2. The polyurethane composition according to embodiment 1, wherein the polyurethane composition is a waterborne polyurethane dispersion (PUD) composition.
      3. The polyurethane composition according to embodiment 1 or 2, wherein polyol subcomponent (ii) comprises a polyether polyol.
      4. The polyurethane composition according to embodiment 3, wherein the polyether polyol comprises a repeating unit of formula:

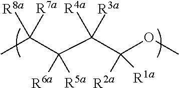

wherein
   R^{1a}, R^{2a}, R^{3a}, R^{4a}, R^{5a}, R^{6a}, R^{7a}, and R^{8a} are, independently at each occurrence in the polymer chain, selected from the group consisting of hydrogen and optionally substituted C₁-C₆ aliphatic.
      5. The polyurethane composition according to embodiment 4, wherein R¹, R², R³, R⁴, R⁵, R⁶, R⁷, and R⁸ are, independently at each occurrence in the polymer chain, selected from the group consisting of hydrogen and methyl.
      6. The polyurethane composition according to any one of embodiments 3-5, wherein the polyether polyol comprises a repeating unit of formula:

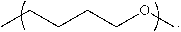

7. The polyurethane composition according to any one of embodiments 1-6, wherein polyol subcomponent (ii) comprises poly(tetramethylene glycol).
8. The polyurethane composition according to embodiment 1, wherein polyol subcomponent (ii) comprises a polyester polyol.
9. The polyurethane composition according to embodiment 8, wherein the polyester polyol comprises a repeating unit of formula:

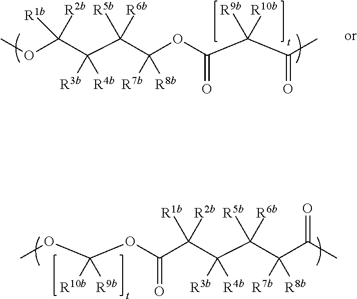

wherein
   R^{1b}, R^{2b}, R^{3b}, R^{4b}, R^{5b}, R^{6b}, R^{7b}, R^{8b}, R^{9b}, and R^{10b} are, independently at each occurrence in the polymer chain, selected from the group consisting of hydrogen and optionally substituted C₁-C₆ aliphatic; and
   each t is, at each occurrence within a polymer chain, an integer from 1 to 8.
      10. The polyurethane composition according to embodiment 9, wherein R^{1b}, R^{2b}, R^{3b}, R^{4b}, R^{5b}, R^{6b}, R^{7b}, R^{8b}, R^{9b}, and R^{10b} are, independently at each occurrence in the polymer chain, selected from the group consisting of hydrogen and methyl.
      11. The polyurethane composition according to any one of embodiments 8-10, wherein the polyester polyol comprises a repeating unit of formula:

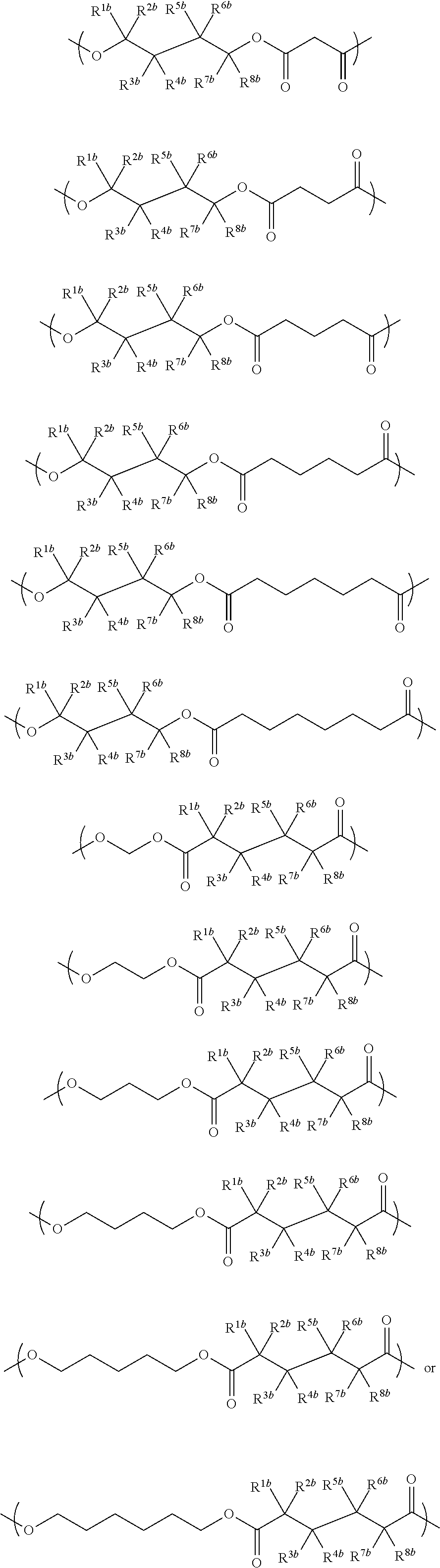

12. The polyurethane composition according to any one of embodiments 1-2 or 8-11, wherein polyol subcomponent (ii) comprises a polyester polyol selected from a butane diol/adipic acid copolymer (BD-AA).
13. The polyurethane composition according to any one of embodiments 1-12, wherein polyol subcomponent (i) comprises polycarbonate polyols having a structure of P1:

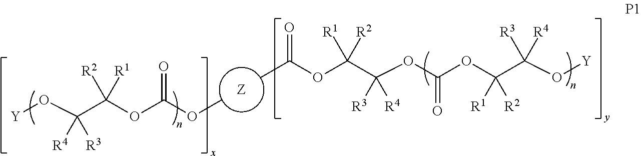

wherein,
R¹, R², R³, and R⁴ are, at each occurrence in the polymer chain, independently selected from the group consisting of —H, fluorine, an optionally substituted C₁₋₃₀ aliphatic group, and an optionally substituted C₁₋₄₀ heteroaliphatic group, and an optionally substituted aryl group, where any two or more of R¹, R², R³, and R⁴ may optionally be taken together with intervening atoms to form one or more optionally substituted rings optionally containing one or more heteroatoms;
Y is, at each occurrence, independently —H, a reactive group (as defined hereinabove), or a site of attachment to any of the chain-extending moieties or isocyanates described in the classes and subclasses herein;
n is at each occurrence, independently an integer from about 2 to about 50;

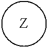

is a covalent bond or a multivalent moiety; and
x and y are each independently an integer from 0 to 6, where the sum of x and y is between 2 and 6.
   14. The polyurethane composition according to embodiment 13, wherein:
R¹, R², R³, and R⁴ are, independently at each occurrence in the polymer chain, selected from the group consisting of hydrogen and optionally substituted C₁-C₆ aliphatic; and
Y is, at each occurrence, —H or the site of attachment to a chain-extending moiety.
   15. The polyurethane composition according to embodiment 13 or 14, wherein R¹, R², R³, and R⁴ are, independently at each occurrence in the polymer chain, selected from the group consisting of hydrogen and methyl.
   16. The polyurethane composition according to any one of embodiments 13-15, where

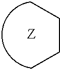

is derived from a dihydric alcohol.
17. The polyurethane composition according to embodiment 16, wherein the dihydric alcohol is selected from the group consisting of diethylene glycol, triethylene glycol, tetraethylene glycol, poly(ethylene glycol) having a Mₙ of about 220 to about 2000 g/mol, dipropylene glycol, tripropylene glycol, and poly(propylene glycol) having a Mₙ between about 234 and about 2000 g/mol.
18. The polyurethane composition according to embodiment 16 or 17, wherein the dihydric alcohol is dipropylene glycol.
19. The polyurethane composition according to embodiment 16 or 17, wherein the dihydric alcohol is poly(propylene glycol) having a Mₙ between about 234 and about 2000 g/mol.
20. The polyurethane composition according to embodiment 19, wherein the poly(propylene glycol) has a Mₙ between about 900 g/mol and 1,100 g/mol.
21. The polyurethane composition according to embodiment 19, wherein the poly(propylene glycol) has a Mₙ of about 1000 g/mol.
22. The polyurethane composition according to any one of embodiments 1-12, wherein polyol subcomponent (i) comprises polycarbonate polyols having a structure of Q10:

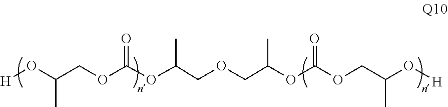

wherein,
each n′ is, at each occurrence, independently an integer from about 2 to about 50.
   23. The polyurethane composition according to any one of embodiments 1-12, wherein polyol subcomponent (i) comprises polycarbonate polyols having a structure of Q11:

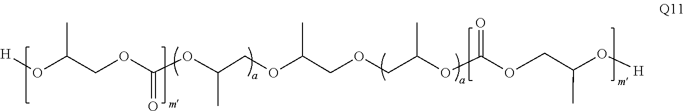

wherein
each a is, at each occurrence, independently an integer from about 2 to about 50; and
each m′ is, at each occurrence, independently an integer from about 2 to about 50.
   24. The polyurethane composition according to any one of embodiments 1-23, wherein the polyol component of the polyurethane composition comprises polyol subcomponent (i) and polyol subcomponent (ii) in a weight ratio of about 2:3 to about 3:2.
   25. The polyurethane composition according to any one of embodiments 1-23, wherein the polyol component of the polyurethane composition comprises polyol subcomponent (i) and polyol subcomponent (ii) in a weight ratio of about 1:1.
   26. The polyurethane composition according to any one of embodiments 1-25, wherein polyol subcomponent (i) comprises a mixture of two or more polycarbonate polyols.
   27. The polyurethane composition according to embodiment 26, wherein polyol subcomponent (i) comprises:
polyol subcomponent (i-a), which comprises polycarbonate polyols having a structure of Q10:

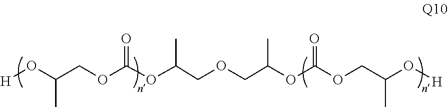

wherein,
   each n′ is, at each occurrence, independently an integer from about 2 to about 50; and polyol subcomponent (i-b), which comprises polycarbonate polyols having a structure of Q11:

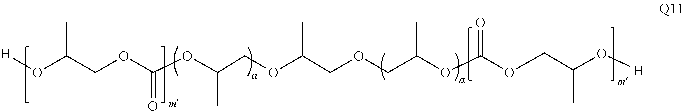

wherein,
   each a is, at each occurrence, independently an integer from about 2 to about 50; and
   each m′ is, at each occurrence, independently an integer from about 2 to about 50.
      28. The polyurethane composition according to embodiment 27, wherein the polyol component comprises about 20-30 weight percent of polyol subcomponent (i-a), about 20-30 weight percent of polyol subcomponent (i-b), and the remaining weight percent is comprised of polyol subcomponent (ii).
      29. The polyurethane composition according to embodiment 27, wherein the polyol component comprises about 25 weight percent of polyol subcomponent (i-a), about 25 weight percent of polyol subcomponent (i-b), and the remaining 50 weight percent is comprised of polyol subcomponent (ii).
      30. The polyurethane composition according to any one of embodiments 1-29, wherein the polyurethane composition is characterized in that a performance property is improved compared to a reference polyurethane composition.
      31. The polyurethane composition according to embodiment 30, wherein the improved performance property is strength, flexibility, or both.
      32. The polyurethane composition according to embodiment 30 or 31, wherein the improved performance property is tensile strength measure according to ASTM D412, tensile elongation measured according to ASTM D412, modulus at 100% measured according to ASTM D412, modulus at 200% measured according to ASTM D412, modulus at 300% measured according to ASTM D412, lap shear strength measured according to ASTM D1002, or peel strength measured according to ASTM D1876.
      33. The polyurethane composition according to any one of embodiments 30-32, wherein the reference polyurethane composition is a corresponding polyurethane composition lacking polyol subcomponent (i), a corresponding polyurethane composition lacking polyol subcomponent (ii), a corresponding polyurethane composition composed solely of a polycarbonate polyol, a corresponding polyurethane composition composed solely of a polyether polyol, or a corresponding polyurethane composition composed solely of a polyester polyol
      34. The polyurethane composition according to any one of embodiments 30-33, wherein the polyurethane composition is characterized in that the tensile strength measured according to ASTM D412 is at least 10, 20, 30, 40, 50, 60, 70, 80, 90, 100, 125, 150, 200, 250, or 300% greater as compared to a reference polyurethane composition.
      35. The polyurethane composition according to any one of embodiments 30-34, wherein the polyurethane composition is characterized in that the tensile elongation measured according to ASTM D412 is at least 10, 20, 30, 40, 50, 60, 70, 80, 90, 100, 125, 150, 200, 250, or 300% greater as compared to a reference polyurethane composition.
      36. The polyurethane composition according to any one of embodiments 30-35, wherein the polyurethane composition is characterized in that it is about the same density compared to a reference polyurethane composition.
      37. A method for producing a polyurethane composition, the method comprising the steps of:
(a) providing an A-side composition comprising one or more isocyanate reagents;
(b) providing a B-side composition comprising:
   polyol subcomponent (i), which comprises one or more polycarbonate or polyethercarbonate polyols derived from copolymerization of carbon dioxide and one or more epoxides; and
   polyol subcomponent (ii), which comprises polyether or polyester polyols, wherein the polyether or polyester polyols comprise a repeating tetramethylene unit; and
(c) mixing the A-side composition and the B-side composition and allowing the mixture to cure into the polyurethane composition.
   38. The method according to embodiment 37, further comprising the step of providing between about 2 weight percent and about 3 weight percent dimethylol propionic acid (DMPA).
   39. The method according to embodiment 37 or 38, wherein the A-side composition comprises one or more isocyanate reagents selected from the group consisting of isophorone diisocyanate (IPDI), hydrogenated methylene diphenyl diisocyanate (H12MDI), and toluene diisocyanate (TDI).
   40. The method according to any one of embodiments 37-39, wherein the cured polyurethane composition is the polyurethane composition according to any one of embodiments 1-36.
   41. A composition comprising:
one or more aliphatic polycarbonate polyols or polyether carbonate polyols derived from copolymerization of carbon dioxide and one or more epoxides; and
one or more polyether or polyester polyols, wherein the polyether or polyester polyols comprise a repeating tetramethylene unit.

The following numbered embodiments, while non-limiting, are exemplary of certain aspects of the present disclosure:

1. A composition comprising:
polyol subcomponent (i), which comprises one or more aliphatic polycarbonate polyols or polyether carbonate polyols derived from copolymerization of carbon dioxide and one or more epoxides; and
polyol subcomponent (ii), which comprises one or more polyether or polyester polyols.
   2. The composition of embodiment 1, wherein the polyether or polyester polyol comprises a repeating tetramethylene unit.
   3. The composition according to embodiment 1 or 2, wherein polyol subcomponent (ii) comprises a polyether polyol.
   4. The composition according to embodiment 3, wherein the polyether polyol comprises a repeating unit of formula:

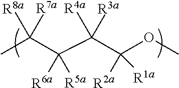

wherein
   R^{1a}, R^{2a}, R^{3a}, R^{4a}, R^{5a}, R^{6a}, R^{7a}, and R^{8a} are, independently at each occurrence in the polymer chain, selected from the group consisting of hydrogen and optionally substituted C₁-C₆ aliphatic.
      5. The composition according to embodiment 4, wherein R¹, R², R³, R⁴, R⁵, R⁶, R⁷, and R⁸ are, independently at each occurrence in the polymer chain, selected from the group consisting of hydrogen and methyl.
      6. The composition according to any one of embodiments 3-5, wherein the polyether polyol comprises a repeating unit of formula:

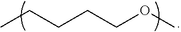

7. The composition according to any one of embodiments 1-6, wherein polyol subcomponent (ii) comprises poly(tetramethylene glycol).
8. The composition according to any one of embodiments 1-7, wherein polyol subcomponent (ii) comprises a polyester polyol.
9. The composition according to embodiment 8, wherein the polyester polyol comprises a repeating unit of formula:

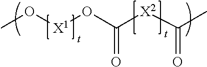

wherein
X¹ and X² are, independently at each occurrence in the polymer chain, selected from —C(R^{9b})(R^{10b})— or —(C(R^{9b})(R^{10b}))_{n″}—O—(C(R^{9b})(R^{10b}))_{n″}—;
R^{1b}, R^{2b}, R^{3b}, R^{4b}, R^{5b}, R^{6b}, R^{7b}, R^{8b}, R^{9b}, and R^{10b}, are, independently at each occurrence in the polymer chain, selected from the group consisting of hydrogen and optionally substituted C₁-C₆ aliphatic; or
two of R^{1b}, R^{2b}, R^{3b}, R^{4b}, R^{5b}, R^{6b}, R^{7b}, R^{8b}, R^{9b}, and R^{10b}, when present on adjacent atoms, together with their intervening atoms, may form a 4- to 8-membered carbocyclic ring;
each n″ is, at each occurrence in the polymer chain, an integer from 1 to 4; and
each t, independently at each occurrence in the polymer chain, an integer from 1 to 8.
   10. The composition according to embodiment 8 or 9, wherein the polyester comprises a tetramethylene repeating unit.
   11. The composition according to any one of embodiments 8-10, wherein the polyester polyol comprises a repeating unit of formula:

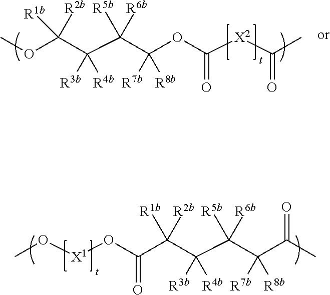

wherein
X¹ and X² are, independently at each occurrence in the polymer chain, selected from —C(R^{9b})(R^{10b})— or —(C(R^{9b})(R^{10b}))_{n″}—O—(C(R^{9b})(R^{10b}))_{n″}—
X¹ and X² are, independently at each occurrence in the polymer chain, selected from —C(R⁹b)(R^{10b})— or —(C(R^{9b})(R^{10b}))_{n″}—O—(C(R^{9b})(R^{10b}))_{n″}—
R^{1b}, R^{2b}, R^{3b}, R^{4b}, R^{5b}, R^{6b}, R^{7b}, R^{8b}, R^{9b}, and R^{10b}, are, independently at each occurrence in the polymer chain, selected from the group consisting of hydrogen and optionally substituted C₁-C₆ aliphatic; or
two of R^{1b}, R^{2b}, R^{3b}, R^{4b}, R^{5b}, R^{6b}, R^{7b}, R^{8b}, R^{9b}, and R^{10b}, when present on adjacent atoms, together with their intervening atoms, may form a 4- to 8-membered carbocyclic ring;
each t is, independently at each occurrence within a polymer chain, an integer from 1 to 8; and
each n″ is, independently at each occurrence within a polymer chain, an integer from 1-4.
   12. The composition according to any one of embodiments 8-11 wherein, R^{1b}, R^{2b}, R^{3b}, R^{4b}, R^{5b}, R^{6b}, R^{7b}, R^{8b}, R^{9b}, and R^{10b}, are, independently at each occurrence in the polymer chain, selected from the group consisting of hydrogen and optionally substituted C₁-C₆ aliphatic.
   13. The composition according to any one of embodiments 8-12, wherein R^{1b}, R^{2b}, R^{3b}, R^{4b}, R^{5b}, R^{6b}, R^{7b}, R^{8b}, R^{9b}, and R^{10b} are, independently at each occurrence in the polymer chain, selected from the group consisting of hydrogen and methyl.
   14. The composition according to any one of embodiments 8-13, wherein the polyester polyol comprises a repeating unit of formula:

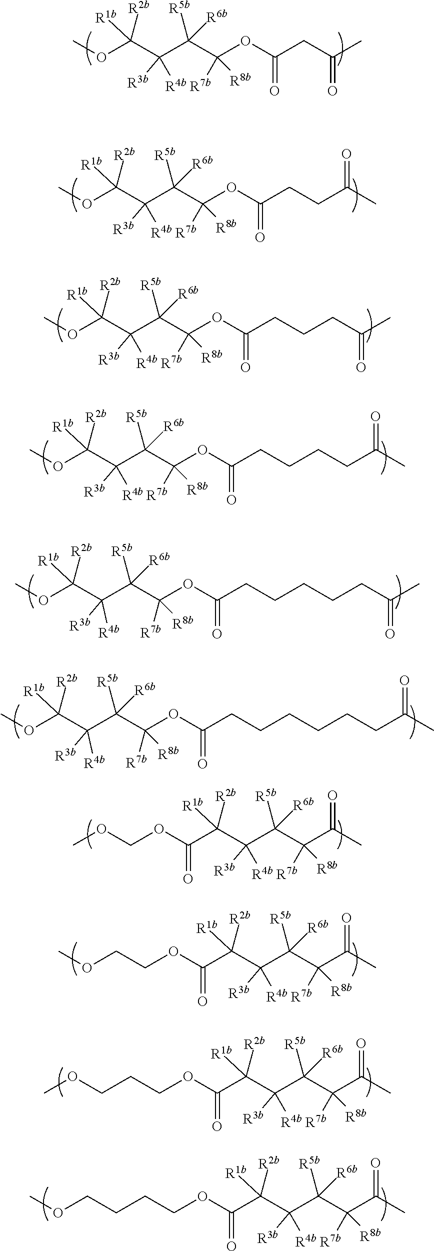

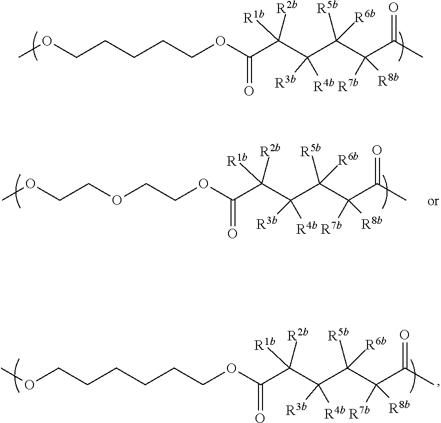

15. The composition according to any one of embodiments 8-13, wherein the polyester polyol is a copolymer of a diol and a diacid, wherein:
the diol is selected from the group consisting of 1,3 propanediol, 1,2-ethanediol, 1,4-butanediol (BDO), 1,5-pentanediol, 1,6-hexanediol, dipropylene glycol, propylene glycol, neopentyl glycol, octane diol, and cyclohexanedimethanol; and
the diacid is selected from the group consisting of adipic acid (AA), sebacic acid (SBA), succinic acid (SA), dodecanedioic acid (DDA), isophthalic acid (iPA), azelaic acid (Az), phthalic acid, and terephthalic acid.
   16. The composition according to any one of embodiments 1 or 8-15, wherein polyol subcomponent (ii) comprises a polyester polyol selected from a butane diol/adipic acid copolymer (BD-AA) or a diethylene glycol/adipic acid copolymer (DEG-AA).
   17. The composition according to any one of embodiments 1-16, wherein polyol subcomponent (i) comprises polycarbonate polyols having a structure of P1:

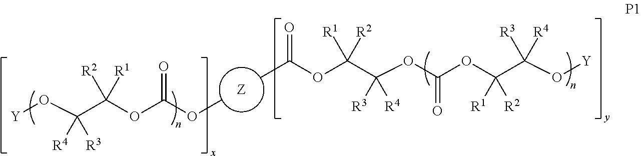

wherein,
R¹, R², R³, and R⁴ are, at each occurrence in the polymer chain, independently selected from the group consisting of —H, fluorine, an optionally substituted C₁₋₃₀ aliphatic group, and an optionally substituted C₁₋₄₀ heteroaliphatic group, and an optionally substituted aryl group, where any two or more of R¹, R², R³, and R⁴ may optionally be taken together with intervening atoms to form one or more optionally substituted rings optionally containing one or more heteroatoms;
Y is, at each occurrence, independently —H, a reactive group (as defined hereinabove), or a site of attachment to any of the chain-extending moieties or isocyanates described in the classes and subclasses herein;
n is at each occurrence, independently an integer from about 2 to about 50;

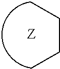

is a covalent bond or a multivalent moiety; and
x and y are each independently an integer from 0 to 6, where the sum of x and y is between 2 and 6.
   18. The composition according to embodiment 17, wherein:
R¹, R², R³, and R⁴ are, independently at each occurrence in the polymer chain, selected from the group consisting of hydrogen and optionally substituted C₁-C₆ aliphatic; and
Y is, at each occurrence, —H or the site of attachment to a chain-extending moiety.
   19. The composition according to embodiment 17 or 18, wherein R¹, R², R³, and R⁴ are, independently at each occurrence in the polymer chain, selected from the group consisting of hydrogen and methyl.
   20. The composition according to any one of embodiments 17-19, where

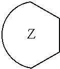

is derived from a dihydric alcohol.
21. The composition according to embodiment 16, wherein the dihydric alcohol is selected from the group consisting of diethylene glycol, triethylene glycol, tetraethylene glycol, poly(ethylene glycol) having a Mₙ of about 220 to about 2000 g/mol, dipropylene glycol, tripropylene glycol, and poly(propylene glycol) having a Mₙ between about 234 and about 2000 g/mol.
22. The composition according to embodiment 20 or 21, wherein the dihydric alcohol is dipropylene glycol.
23. The composition according to embodiment 20 or 21, wherein the dihydric alcohol is poly(propylene glycol) having a Mₙ between about 234 and about 2000 g/mol.
24. The composition according to embodiment 23, wherein the poly(propylene glycol) has a Mₙ between about 900 g/mol and 1,100 g/mol.
25. The composition according to embodiment 23, wherein the poly(propylene glycol) has a Mₙ of about 1000 g/mol.
26. The composition according to any one of embodiments 1-16, wherein polyol subcomponent (i) comprises polycarbonate polyols having a structure of Q10:

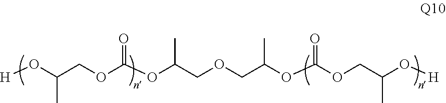

wherein,
each n′ is, at each occurrence, independently an integer from about 2 to about 50.
   27. The composition according to any one of embodiments 1-11, wherein polyol subcomponent (i) comprises polycarbonate polyols having a structure of Q11:

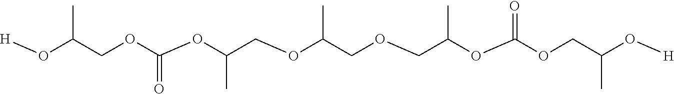

wherein,
each a is, at each occurrence, independently an integer from about 2 to about 50; and
each m′ is, at each occurrence, independently an integer from about 2 to about 50.
   28. The composition according to any one of embodiments 1-27, wherein the polyol component of the polyurethane composition comprises polyol subcomponent (i) and polyol subcomponent (ii) in a weight ratio of about 2:3 to about 3:2.
   29. The composition according to any one of embodiments 1-28, wherein the polyol component of the polyurethane composition comprises polyol subcomponent (i) and polyol subcomponent (ii) in a weight ratio of about 2:3 to about 3:2.
   30. The composition according to any one of embodiments 1-29, wherein the polyol component of the polyurethane composition comprises polyol subcomponent (i) and polyol subcomponent (ii) in a weight ratio of about 1:1.
   31. The composition according to any one of embodiments 1-30, wherein polyol subcomponent (i) comprises a mixture of two or more polycarbonate polyols.
   32. The composition according to embodiment 31, wherein polyol subcomponent (i) comprises:
polyol subcomponent (i-a), which comprises polycarbonate polyols having a structure of Q10:

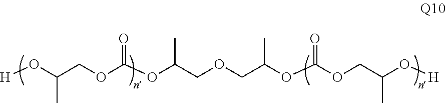

wherein,
   each n′ is, at each occurrence, independently an integer from about 2 to about 50; and polyol subcomponent (i-b), which comprises polycarbonate polyols having a structure of Q11:

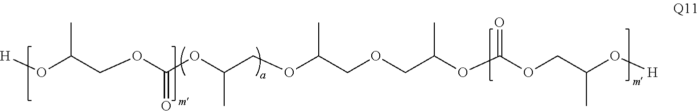

wherein,
   each a is, at each occurrence, independently an integer from about 2 to about 50; and
   each m′ is, at each occurrence, independently an integer from about 2 to about 50.
      33. The composition according to embodiment 32, wherein the composition comprises about 20-30 weight percent of polyol subcomponent (i-a), about 20-30 weight percent of polyol subcomponent (i-b), and the remaining weight percent is comprised of polyol subcomponent (ii).
      34. The composition according to embodiment 32, wherein the composition comprises about 25 weight percent of polyol subcomponent (i-a), about 25 weight percent of polyol subcomponent (i-b), and the remaining 50 weight percent is comprised of polyol subcomponent (ii).
      35. The composition according to embodiment 32, wherein the composition comprises about 5-90 weight percent of polyol subcomponent (i-a), about 5-85 weight percent of polyol subcomponent (i-b), and about 5-60 weight percent of polyol subcomponent (ii).
      36. The composition according to embodiment 32, wherein the composition comprises about 80-90 weight percent of polyol subcomponent (i-a), about 0.1-10 weight percent of polyol subcomponent (i-b), and about 0.1-10 weight percent of polyol subcomponent (ii).
      37. The composition according to embodiment 36, wherein the composition comprises about 89 weight percent of polyol subcomponent (i-a), about 5 weight percent of polyol subcomponent (i-b), and about 6 weight percent of polyol subcomponent (ii).
      38. The composition according to embodiment 32, wherein the composition comprises about 58-68 weight percent of polyol subcomponent (i-a), about 18-28 weight percent of polyol subcomponent (i-b), and about 9-19 weight percent of polyol subcomponent (ii).
      39. The composition according to embodiment 38, wherein the composition comprises about 63 weight percent of polyol subcomponent (i-a), about 23 weight percent of polyol subcomponent (i-b), and about 14 weight percent of polyol subcomponent (ii).
      40. The composition according to embodiment 32, wherein the composition comprises about 29-39 weight percent of polyol subcomponent (i-a), about 27-37 weight percent of polyol subcomponent (i-b), and about 29-39 weight percent of polyol subcomponent (ii).
      41. The composition according to embodiment 40, wherein the composition comprises about 34 weight percent of polyol subcomponent (i-a), about 32 weight percent of polyol subcomponent (i-b), and about 34 weight percent of polyol subcomponent (ii).
      42. The composition according to embodiment 32, wherein the composition comprises about 41-51 weight percent of polyol subcomponent (i-a), about 41-51 weight percent of polyol subcomponent (i-b), and about 3-13 weight percent of polyol subcomponent (ii).
      43. The composition according to embodiment 42, wherein the composition comprises about 46 weight percent of polyol subcomponent (i-a), about 46 weight percent of polyol subcomponent (i-b), and about 8 weight percent of polyol subcomponent (ii).
      44. The composition according to embodiment 32, wherein the composition comprises about 0.1-10 weight percent of polyol subcomponent (i-a), about 46-56 weight percent of polyol subcomponent (i-b), and about 39-49 weight percent of polyol subcomponent (ii).
      45. The composition according to embodiment 44, wherein the composition comprises about 5 weight percent of polyol subcomponent (i-a), about 51 weight percent of polyol subcomponent (i-b), and about 44 weight percent of polyol subcomponent (ii).
      46. The composition according to embodiment 32, wherein the composition comprises about 15-25 weight percent of polyol subcomponent (i-a), about 56-66 weight percent of polyol subcomponent (i-b), and about 14-24 weight percent of polyol subcomponent (ii).
      47. The composition according to embodiment 46, wherein the composition comprises about 20 weight percent of polyol subcomponent (i-a), about 61 weight percent of polyol subcomponent (i-b), and about 19 weight percent of polyol subcomponent (ii).
      48. The composition according to embodiment 32, wherein the composition comprises about 5-15 weight percent of polyol subcomponent (i-a), about 80-90 weight percent of polyol subcomponent (i-b), and about 0.1-10 weight percent of polyol subcomponent (ii).
      49. The composition according to embodiment 48, wherein the composition comprises about 10 weight percent of polyol subcomponent (i-a), about 85 weight percent of polyol subcomponent (i-b), and about 5 weight percent of polyol subcomponent (ii).
      50. The composition according to embodiment 32, wherein the composition comprises about 65-75 weight percent of polyol subcomponent (i-a), about 5-15 weight percent of polyol subcomponent (i-b), and about 15-25 weight percent of polyol subcomponent (ii).
      51. The composition according to embodiment 50, wherein the composition comprises about 70 weight percent of polyol subcomponent (i-a), about 10 weight percent of polyol subcomponent (i-b), and about 20 weight percent of polyol subcomponent (ii).
      52. The composition according to embodiment 32, wherein the composition comprises about 50-60 weight percent of polyol subcomponent (i-a), about 35-45 weight percent of polyol subcomponent (i-b), and about 0.1-10 weight percent of polyol subcomponent (ii).
      53. The composition according to embodiment 52, wherein the composition comprises about 55 weight percent of polyol subcomponent (i-a), about 40 weight percent of polyol subcomponent (i-b), and about 5 weight percent of polyol subcomponent (ii).
      54. The composition according to embodiment 32, wherein the composition comprises about 8-18 weight percent of polyol subcomponent (i-a), about 28-38 weight percent of polyol subcomponent (i-b), and about 48-58 weight percent of polyol subcomponent (ii).
      55. The composition according to embodiment 54, wherein the composition comprises about 13 weight percent of polyol subcomponent (i-a), about 33 weight percent of polyol subcomponent (i-b), and about 53 weight percent of polyol subcomponent (ii).
      56. The composition according to any one of embodiments 32-55, wherein polyol subcomponent (ii) comprises a BD-AA copolymer.
      57. The composition according to embodiment 32, wherein the composition comprises about 10-40 weight percent of polyol subcomponent (i-a), about 10-70 weight percent of polyol subcomponent (i-b), and about 10-70 weight percent of polyol subcomponent (ii).
      58. The composition according to embodiment 32, wherein the composition comprises about 28-38 weight percent of polyol subcomponent (i-a), about 28-38 weight percent of polyol subcomponent (i-b), and about 28-38 weight percent of polyol subcomponent (ii).
      59. The composition according to embodiment 58, wherein the composition comprises about 33 weight percent of polyol subcomponent (i-a), about 34 weight percent of polyol subcomponent (i-b), and about 33 weight percent of polyol subcomponent (ii).
      60. The composition according to embodiment 32, wherein the composition comprises about 12-22 weight percent of polyol subcomponent (i-a), about 12-22 weight percent of polyol subcomponent (i-b), and about 61-71 weight percent of polyol subcomponent (ii).
      61. The composition according to embodiment 60, wherein the composition comprises about 17 weight percent of polyol subcomponent (i-a), about 17 weight percent of polyol subcomponent (i-b), and about 66 weight percent of polyol subcomponent (ii).
      62. The composition according to embodiment 32, wherein the composition comprises about 12-22 weight percent of polyol subcomponent (i-a), about 61-71 weight percent of polyol subcomponent (i-b), and about 12-22 weight percent of polyol subcomponent (ii).
      63. The composition according to embodiment 62, wherein the composition comprises about 17 weight percent of polyol subcomponent (i-a), about 66 weight percent of polyol subcomponent (i-b), and about 17 weight percent of polyol subcomponent (ii).
      64. The composition according to any one of embodiments 57-63, wherein polyol subcomponent (ii) comprises a DEG-AA copolymer.
      65. An isocyanate-terminated prepolymer derived from a composition according to any one of embodiments 1-64.
      66. A polyurethane composition comprising the reaction product of i) a composition according to any one of embodiments 1-64 and an isocyanate, or ii) an isocyanate-terminated prepolymer of embodiment 65.
      67. The polyurethane composition according to embodiment 66, wherein the polyurethane composition is a waterborne polyurethane dispersion (PUD) composition.
      68. The polyurethane composition according to embodiment 66, wherein the polyurethane composition is a 1-component polyurethane composition.
      69. The polyurethane composition according to embodiment 66, wherein the polyurethane composition is a 2-component polyurethane composition.
      70. The polyurethane composition according to embodiment 66, wherein the polyurethane composition is a solvent borne polyurethane composition.
      71. The polyurethane compositions according to any one of embodiments 66-70, wherein the polyurethane composition is a coating, adhesive, or elastomer composition.
      72. The polyurethane composition according to any one of embodiments 66-71, wherein the polyurethane composition is characterized in that a performance property is improved compared to a reference polyurethane composition.
      73. The polyurethane composition according to embodiment 72, wherein the improved performance property is strength, flexibility, elongation, or combinations thereof.
      74. The polyurethane composition according to embodiment 72 or 73, wherein the improved performance property is tensile strength measure according to ASTM D412, tensile elongation measured according to ASTM D412, modulus at 100% measured according to ASTM D412, modulus at 200% measured according to ASTM D412, modulus at 300% measured according to ASTM D412, lap shear strength measured according to ASTM D1002, or peel strength measured according to ASTM D1876.
      75. The polyurethane composition according to any one of embodiments 72-74, wherein the reference polyurethane composition is a corresponding polyurethane composition lacking polyol subcomponent (i), a corresponding polyurethane composition lacking polyol subcomponent (ii), a corresponding polyurethane composition composed solely of a polycarbonate polyol, a corresponding polyurethane composition composed solely of a polyether polyol, or a corresponding polyurethane composition composed solely of a polyester polyol
      76. The polyurethane composition according to any one of embodiments 72-75, wherein the polyurethane composition is characterized in that the tensile strength measured according to ASTM D412 is at least 10, 20, 30, 40, 50, 60, 70, 80, 90, 100, 125, 150, 200, 250, or 300% greater as compared to a reference polyurethane composition.
      77. The polyurethane composition according to any one of embodiments 72-76, wherein the polyurethane composition is characterized in that the tensile elongation measured according to ASTM D412 is at least 10, 20, 30, 40, 50, 60, 70, 80, 90, 100, 125, 150, 200, 250, or 300% greater as compared to a reference polyurethane composition.
      78. The polyurethane composition according to any one of embodiments 72-77, wherein the polyurethane composition is characterized in that it is about the same density compared to a reference polyurethane composition.

1. A composition comprising:
polyol subcomponent (i), which comprises one or more aliphatic polycarbonate polyols or polyether carbonate polyols derived from copolymerization of carbon dioxide and one or more epoxides; and
polyol subcomponent (ii), which comprises one or more polyether or polyester polyols.

2. The composition according to claim 1, wherein polyol subcomponent (ii) comprises a polyether polyol.

3. The composition according to claim 2, wherein the polyether polyol comprises a repeating unit of formula: 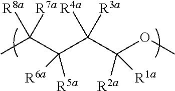
wherein
R^{1a}, R^{2a}, R^{3a}, R^{4a}, R^{5a}, R^{6a}, R^{7a}, and R^{8a} are, independently at each occurrence in the polymer chain, selected from the group consisting of hydrogen and optionally substituted C₁-C₆ aliphatic.

4. The composition according to claim 1, wherein polyol subcomponent (ii) comprises poly(tetramethylene glycol).

5. The composition according to claim 1, wherein polyol subcomponent (ii) comprises a polyester polyol.

6. The composition according to claim 5, wherein the polyester polyol comprises a repeating unit of formula: 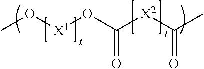
wherein
X¹ and X² are, independently at each occurrence in the polymer chain, selected from —C(R^{9b})(R^{10b})— or —(C(R^{9b})(R^{10b}))_{n″}—O—(C(R^{9b})(R^{10b}))_{n″}—;
R^{9b} and R^{10b} are, independently at each occurrence in the polymer chain, selected from the group consisting of hydrogen and optionally substituted C₁-C₆ aliphatic; or
two of R^{9b} and R^{10b}, when present on adjacent atoms, together with their intervening atoms, may form a 4- to 8-membered carbocyclic ring;
each n″ is, independently at each occurrence in the polymer chain, an integer from 1 to 4; and
each t is, independently at each occurrence in the polymer chain, an integer from 1 to 8.

7. The composition according to claim 6, wherein R^{9b} and R^{10b} are, independently at each occurrence in the polymer chain, selected from the group consisting of hydrogen and methyl.

8. The composition according to claim 5, wherein the polyester polyol is a copolymer of a diol and a diacid, wherein:
the diol is selected from the group consisting of 1,3 propanediol, 1,2-ethanediol, 1,4-butanediol (BDO), 1,5-pentanediol, 1,6-hexanediol, dipropylene glycol, propylene glycol, neopentyl glycol, octane diol, and cyclohexanedimethanol; and
the diacid is selected from the group consisting of adipic acid (AA), sebacic acid (SBA), succinic acid (SA), dodecanedioic acid (DDA), isophthalic acid (iPA), azelaic acid (Az), phthalic acid, and terephthalic acid.

9. The composition according to claim 1, wherein polyol subcomponent (i) comprises polycarbonate polyols having a structure of Q10: 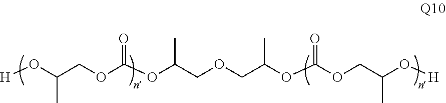
wherein,
each n′ is, at each occurrence, independently an integer from about 2 to about 50.

10. The composition according to claim 1, wherein polyol subcomponent (i) comprises polycarbonate polyols having a structure of Q11: 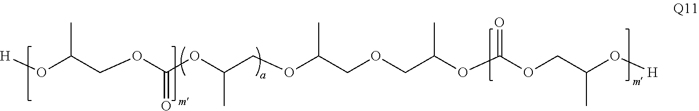
wherein,
each a is, at each occurrence, independently an integer from about 2 to about 50; and
each m′ is, at each occurrence, independently an integer from about 2 to about 50.

11. The composition according to claim 1, wherein the composition comprises polyol subcomponent (i) and polyol subcomponent (ii) in a weight ratio of about 2:3 to about 3:2; about 2:3 to about 3:2; or about 1:1.

12. The composition according to claim 1, wherein polyol subcomponent (i) comprises a mixture of two or more polycarbonate polyols.

13. The composition according to claim 12, wherein polyol subcomponent (i) comprises:
polyol subcomponent (i-a), which comprises polycarbonate polyols having a structure of Q10: 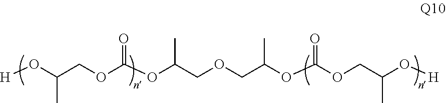
wherein,
each n′ is, at each occurrence, independently an integer from about 2 to about 50; and polyol subcomponent (i-b), which comprises polycarbonate polyols having a structure of Q11: 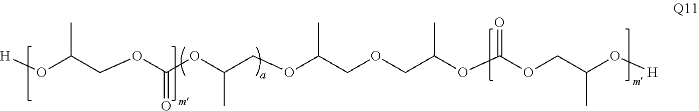
wherein,
each a is, at each occurrence, independently an integer from about 2 to about 50; and
each m′ is, at each occurrence, independently an integer from about 2 to about 50.

14. The composition according to claim 13, wherein the composition comprises:
about 20-30 weight percent of polyol subcomponent (i-a), about 20-30 weight percent of polyol subcomponent (i-b), and the remaining weight percent is comprised of polyol subcomponent (ii);
about 25 weight percent of polyol subcomponent (i-a), about 25 weight percent of polyol subcomponent (i-b), and the remaining 50 weight percent is comprised of polyol subcomponent (ii);
about 5-90 weight percent of polyol subcomponent (i-a), about 5-85 weight percent of polyol subcomponent (i-b), and about 5-60 weight percent of polyol subcomponent (ii);
about 80-90 weight percent of polyol subcomponent (i-a), about 0.1-10 weight percent of polyol subcomponent (i-b), and about 0.1-10 weight percent of polyol subcomponent (ii);
about 89 weight percent of polyol subcomponent (i-a), about 5 weight percent of polyol subcomponent (i-b), and about 6 weight percent of polyol subcomponent (ii);
about 58-68 weight percent of polyol subcomponent (i-a), about 18-28 weight percent of polyol subcomponent (i-b), and about 9-19 weight percent of polyol subcomponent (ii);
about 63 weight percent of polyol subcomponent (i-a), about 23 weight percent of polyol subcomponent (i-b), and about 14 weight percent of polyol subcomponent (ii);
about 29-39 weight percent of polyol subcomponent (i-a), about 27-37 weight percent of polyol subcomponent (i-b), and about 29-39 weight percent of polyol subcomponent (ii);
about 34 weight percent of polyol subcomponent (i-a), about 32 weight percent of polyol subcomponent (i-b), and about 34 weight percent of polyol subcomponent (ii);
about 41-51 weight percent of polyol subcomponent (i-a), about 41-51 weight percent of polyol subcomponent (i-b), and about 3-13 weight percent of polyol subcomponent (ii);
about 46 weight percent of polyol subcomponent (i-a), about 46 weight percent of polyol subcomponent (i-b), and about 8 weight percent of polyol subcomponent (ii);
about 0.1-10 weight percent of polyol subcomponent (i-a), about 46-56 weight percent of polyol subcomponent (i-b), and about 39-49 weight percent of polyol subcomponent (ii);
about 5 weight percent of polyol subcomponent (i-a), about 51 weight percent of polyol subcomponent (i-b), and about 44 weight percent of polyol subcomponent (ii);
about 15-25 weight percent of polyol subcomponent (i-a), about 56-66 weight percent of polyol subcomponent (i-b), and about 14-24 weight percent of polyol subcomponent (ii);
about 20 weight percent of polyol subcomponent (i-a), about 61 weight percent of polyol subcomponent (i-b), and about 19 weight percent of polyol subcomponent (ii);
about 5-15 weight percent of polyol subcomponent (i-a), about 80-90 weight percent of polyol subcomponent (i-b), and about 0.1-10 weight percent of polyol subcomponent (ii);
about 10 weight percent of polyol subcomponent (i-a), about 85 weight percent of polyol subcomponent (i-b), and about 5 weight percent of polyol subcomponent (ii);
about 65-75 weight percent of polyol subcomponent (i-a), about 5-15 weight percent of polyol subcomponent (i-b), and about 15-25 weight percent of polyol subcomponent (ii);
about 70 weight percent of polyol subcomponent (i-a), about 10 weight percent of polyol subcomponent (i-b), and about 20 weight percent of polyol subcomponent (ii);
about 50-60 weight percent of polyol subcomponent (i-a), about 35-45 weight percent of polyol subcomponent (i-b), and about 0.1-10 weight percent of polyol subcomponent (ii);
about 55 weight percent of polyol subcomponent (i-a), about 40 weight percent of polyol subcomponent (i-b), and about 5 weight percent of polyol subcomponent (ii);
about 8-18 weight percent of polyol subcomponent (i-a), about 28-38 weight percent of polyol subcomponent (i-b), and about 48-58 weight percent of polyol subcomponent (ii);
about 13 weight percent of polyol subcomponent (i-a), about 33 weight percent of polyol subcomponent (i-b), and about 53 weight percent of polyol subcomponent (ii);
about 10-40 weight percent of polyol subcomponent (i-a), about 10-70 weight percent of polyol subcomponent (i-b), and about 10-70 weight percent of polyol subcomponent (ii);
about 28-38 weight percent of polyol subcomponent (i-a), about 28-38 weight percent of polyol subcomponent (i-b), and about 28-38 weight percent of polyol subcomponent (ii);
about 33 weight percent of polyol subcomponent (i-a), about 34 weight percent of polyol subcomponent (i-b), and about 33 weight percent of polyol subcomponent (ii);
about 12-22 weight percent of polyol subcomponent (i-a), about 12-22 weight percent of polyol subcomponent (i-b), and about 61-71 weight percent of polyol subcomponent (ii);
about 17 weight percent of polyol subcomponent (i-a), about 17 weight percent of polyol subcomponent (i-b), and about 66 weight percent of polyol subcomponent (ii);
about 12-22 weight percent of polyol subcomponent (i-a), about 61-71 weight percent of polyol subcomponent (i-b), and about 12-22 weight percent of polyol subcomponent (ii); or
about 17 weight percent of polyol subcomponent (i-a), about 66 weight percent of polyol subcomponent (i-b), and about 17 weight percent of polyol subcomponent (ii).

15. (canceled)

16. An isocyanate-terminated prepolymer derived from a composition according to claim 1.

17. A polyurethane composition comprising the reaction product of a composition according to claim 1 and an isocyanate.

18. The polyurethane composition according to claim 17, wherein the polyurethane composition is a waterborne polyurethane dispersion (PUD) composition, a 1-component polyurethane composition, a 2-component polyurethane composition, or a solvent borne polyurethane composition.

19. The polyurethane compositions according to claim 17, wherein the polyurethane composition is a coating, adhesive, or elastomer composition.

20. The polyurethane composition according to claim 17, wherein the polyurethane composition is characterized in that a performance property is improved compared to a reference polyurethane composition.

21. (canceled)

22. The polyurethane composition according to claim 20, wherein the improved performance property is tensile strength measure according to ASTM D412, tensile elongation measured according to ASTM D412, modulus at 100% measured according to ASTM D412, modulus at 200% measured according to ASTM D412, modulus at 300% measured according to ASTM D412, lap shear strength measured according to ASTM D1002, or peel strength measured according to ASTM D1876.

23. The polyurethane composition according to claim 20, wherein the reference polyurethane composition is a corresponding polyurethane composition lacking polyol subcomponent (i), a corresponding polyurethane composition lacking polyol subcomponent (ii), a corresponding polyurethane composition composed solely of a polycarbonate polyol, a corresponding polyurethane composition composed solely of a polyether polyol, or a corresponding polyurethane composition composed solely of a polyester polyol.

24. The polyurethane composition according to claim 20, wherein the polyurethane composition is characterized in that:
the tensile strength measured according to ASTM D412 is at least 10, 20, 30, 40, 50, 60, 70, 80, 90, 100, 125, 150, 200, 250, or 300% greater as compared to a reference polyurethane composition; or
the tensile elongation measured according to ASTM D412 is at least 10, 20, 30, 40, 50, 60, 70, 80, 90, 100, 125, 150, 200, 250, or 300% greater as compared to a reference polyurethane composition, or
wherein the polyurethane composition is characterized in that it is about the same density compared to a reference polyurethane composition.

25-26. (canceled)
